(19) United States
(12) Patent Application Publication
(10) Pub. No.: US 2008/0225108 A1
(43) Pub. Date: Sep. 18, 2008

(54) Line Head and an Image Forming Apparatus Using the Line Head

(75) Inventors: Ryuta KOIZUMI, Shiojiri-shi (JP); Yujiro NOMURA, Shiojiri-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/044,809

(22) Filed: Mar. 7, 2008

(30) Foreign Application Priority Data
Mar. 12, 2007 (JP) 2007-061854
Oct. 2, 2007 (JP) 2007-258915

(51) Int. Cl. B41J 15/14

(52) U.S. Cl. 347/244; 347/241

(57) ABSTRACT

A line head, includes: a plurality of light emitting elements that are grouped into light emitting element groups, and an array that includes a plurality of imaging optical systems provided with respect to each light emitting element group which focus light beams emitted from the light emitting element groups toward a latent image-forming surface being conveyed in a second direction normal to or substantially normal to a first direction, wherein the plurality of imaging optical systems face positions on the latent image-forming surface mutually different in the second direction, and the respective imaging optical systems are constructed in accordance with differences in facing positions on the latent image-forming surface in the second direction.

### CROSS REFERENCE TO RELATED APPLICATION

The disclosure of Japanese Patent Applications No. 2007-061854 filed on Mar. 12, 2007 and No. 2007-258915 filed on Oct. 2, 2007 including specification, drawings and claims is incorporated herein by reference in its entirety.

### BACKGROUND

1. Technical Field

The invention relates to a technology for forming an image by exposing a latent image carrier surface using a line head.

2. Related Art

There is known a technology for forming an electrostatic latent image by exposing a photosensitive member surface with light beams while conveying the photosensitive member surface in a sub scanning direction. Specifically, according to such a technology, a two-dimensional electrostatic latent image is formed on the photosensitive member surface by exposing the photosensitive member surface with light beams arrayed in a main scanning direction while conveying the photosensitive member surface in the sub scanning direction. JP-A-2-4545 discloses a line head for focusing light beams emitted from light emitting elements toward a photosensitive member surface and a technology for exposing the photosensitive member surface using the line head. More specifically, in such a line head, a plurality of light emitting element groups each including a plurality of light emitting elements are arranged in a longitudinal direction corresponding to the main scanning direction. A plurality of lenses are arranged in a one-to-one correspondence with these plurality of light emitting element groups. Each of the plurality of lenses focuses light beams emitted from the light emitting elements of the corresponding light emitting element group toward the photosensitive member surface. The photosensitive member surface is exposed with the light beams focused in this way.

### SUMMARY

According to the technology disclosed in JP-A-2-4546, the plurality of lenses are aligned straight in the longitudinal direction to form a lens row in conformity with the alignment of the plurality of light emitting element groups in the longitudinal direction. Although only one lens row is formed according to the technology disclosed in the above literature, a plurality of lens rows aligned in a direction normal to the longitudinal direction can be arranged to face a surface of a latent image carrier (photosensitive member) for the reason of improving the resolution of a latent image formed on the latent image carrier surface and other reasons. However, since the respective lens rows face positions mutually different in the sub scanning direction in such a construction, there have been cases where images formed by the lens rows differ and no satisfactory exposure can be realized.

Specifically, in a line head using a plurality of lens rows, these plurality of lens rows are arranged to face the latent image carrier surface while being arranged in a width direction corresponding to the sub scanning direction, which is a conveying direction of the latent image carrier surface. At this time, the plurality of lens rows face positions of the latent image carrier surface mutually different in the sub scanning direction. Thus, the focus positions of the light beams focused by the lenses belonging to the different lens rows mutually differ in the sub scanning direction. On the other hand, if the latent image carrier surface has a curvature in a section along the sub scanning direction, there have been cases where distances between the focus positions and the latent image carrier surface differ among the plurality of lens rows due to such a curvature. Because of these distance differences, the latent image formed on the latent image carrier surface differs depending on the lens rows, resulting in a possibility of an exposure failure of being unable to perform a satisfactory exposure.

Further, in the line head using the plurality of lens rows, line latent images extending in the main scanning direction can be formed by successively forming latent images by the lens rows from the one facing an upstream side in the sub scanning direction. However, there are cases where the latent image formed by one lens row changes with time during a period between the formation of the latent image by the one lens row and that by the next lens row. If the latent images change with time, there have been cases where latent images formed on the latent image carrier surface differ depending on the lens rows and no satisfactory exposure can be performed.

An advantage of some aspects of the invention is to provide a technology for suppressing an occurrence of the above-described exposure failure resulting from the fact that a plurality of lens rows face positions mutually different in the sub scanning direction.

According to a first aspect of the invention, there is provided a line head, comprising: a plurality of light emitting elements that are grouped into light emitting element groups, and an array that includes a plurality of imaging optical systems provided with respect to each light emitting element group which focus light beams emitted from the light emitting element groups toward a latent image-forming surface being conveyed in a second direction normal to or substantially normal to a first direction, wherein the plurality of imaging optical systems face positions on the latent image-forming surface mutually different in the second direction, and the respective imaging optical systems are constructed in accordance with differences in facing positions on the latent image-forming surface in the second direction.

According to a second aspect of the invention, there is provided an image forming apparatus, comprising: a latent image carrier whose surface is conveyed in a second direction normal to or substantially normal to a first direction; a line head that exposes the latent image carrier surface to form a latent image; and a developer that develops the latent image, wherein the line head includes: a plurality of light emitting elements grouped into light emitting element groups; and an array that includes a plurality of imaging optical systems provided with respect to each light emitting element group which focus light beams emitted from the light emitting element groups toward the latent image carrier surface, wherein the plurality of imaging optical systems face positions on the latent image carrier surface mutually different in the second direction, and wherein the respective imaging optical systems are constructed in accordance with differences in the facing positions on the latent image carrier surface in the second direction.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a diagram showing an embodiment of an image forming apparatus according to the invention.

FIG. 2 is a diagram showing the electrical construction of the image forming apparatus of FIG. 1.

FIG. 3 is a perspective view schematically showing one embodiment of a line head according to the invention.

FIG. 4 is a sectional view along a width direction showing the embodiment of the line head according to the invention.

FIG. 5 is a schematic partial perspective view of the lens array.

FIG. 6 is a sectional view of the lens array in the longitudinal direction LGD.

FIG. 7 is a diagram showing the arrangement of the light emitting element groups in the line head.

FIG. 8 is a diagram showing the arrangement of the light emitting elements in each light emitting element group.

FIG. 9 is a diagram showing a focusing state of the lens in a section including the longitudinal direction and the optical axis.

FIG. 10 is a diagram showing a focusing state of the lens in a section including the width direction and the optical axis.

FIGS. 11 and 12 are diagrams showing terminology used in this specification.

FIGS. 13A and 13B are diagrams showing the lens position and the like.

FIG. 14 is a diagram showing a spot forming operation by the above-described line head.

FIGS. 15 and 16 are sectional views along the sub scanning direction showing the relationship of arrangement of the line head and the photosensitive drum in the case where the arrangement of the line head is not proper.

FIG. 17 shows the lens data of the lens LS used in the simulation of the comparative example 1.

FIG. 18 shows aspherical surface coefficients of the aspherical surfaces S4, S5.

FIG. 19 shows the specification of an optical system used in the simulation of the comparative example 1.

FIG. 20 shows the result of the simulation conducted on the above conditions.

FIGS. 21 and 22 are sectional views along the sub scanning direction showing the relationship of arrangement of the line head and the photosensitive drum in the working example 1.

FIG. 23 shows the result of the simulation in the working example 1 conducted on the above conditions.

FIGS. 24 and 25 are sectional views along the sub scanning direction corresponding to the case where the line head is not properly arranged.

FIG. 26 shows the result of the simulation conducted on the above conditions.

FIGS. 27 and 28 are sectional views along the sub scanning direction showing the relationship of arrangement of the line head and the photosensitive drum in the working example 2.

FIG. 29 shows the result of the simulation of the working example 2 conducted on the above conditions.

FIG. 30 is a sectional view along the sub scanning direction showing the relationship of arrangement of a lens array and a photosensitive drum according to a working example 3 of the invention.

FIG. 31 shows the lens data of the lens LS2.

FIG. 32 shows the aspherical surface coefficient of the lens LS2.

FIG. 33 shows the lens data of the lenses LS1, LS3.

FIG. 34 shows the aspherical surface coefficients of the lenses LS1, LS3.

FIG. 35 shows the specification of an optical system used in a simulation of the working example 3.

FIG. 36 shows a simulation result in the case where the lenses LS1 to LS3 are formed based on the data given by above FIG. 31 to FIG. 35.

FIG. 37 is a graph showing a relationship between the lens diameter and the lens efficiency.

FIG. 38 is a sectional view along the sub scanning direction showing the relationship of arrangement of a lens array and a photosensitive drum according to the working example 4 of the invention.

FIG. 39 shows the lens data of the lens LS2.

FIG. 40 shows the aspherical surface coefficient of the lens LS2.

FIG. 41 shows the lens data of the lenses LS1, LS3.

FIG. 42 shows the aspherical surface coefficients of the lenses LS1, LS3.

FIG. 43 shows the specification of an optical system used in a simulation of the working example 4.

FIG. 44 shows a simulation result in the case where the lenses LS1 to LS3 are formed based on the data given by above FIG. 39 to FIG. 43.

FIG. 45 is a sectional view along the sub scanning direction showing the relationship of arrangement of a lens array and a photosensitive drum according to a working example 5 of the invention.

FIG. 46 shows the lens data of the lenses LS2, LS3.

FIG. 47 shows the aspherical surface coefficients of the lenses LS2, LS3.

FIG. 48 shows the lens data of the lenses LS1, LS4.

FIG. 49 shows the aspherical surface coefficients of the lenses LS1, LS4.

FIG. 50 shows the specification of an optical system used in a simulation of the working example 5.

FIG. 51 shows a simulation result in the case where the lenses LS1 to LS4 are formed based on the data given by above FIG. 46 to FIG. 50.

FIG. 52 is a sectional view along the sub scanning direction showing the relationship of arrangement of a lens array and a photosensitive drum according to the working example 6 of the invention.

FIG. 53 shows the lens data of the lenses LS2, LS3.

FIG. 54 shows the aspherical surface coefficients of the lenses LS2, LS3.

FIG. 55 shows the lens data of the lenses LS1, LS4.

FIG. 56 shows the aspherical surface coefficients of the lenses LS1, LS4.

FIG. 57 shows the specification of an optical system used in a simulation of the working example 6.

FIG. 58 shows a simulation result in the case where the lenses LS1 to LS4 are formed based on the data given by above FIG. 53 to FIG. 57.

FIG. 59 is a chart showing the arrangement of light emitting elements and the formation positions of spots in a working example 7.

FIG. 60 is a sectional view along the sub scanning direction showing the relationship of arrangement of a lens array and a photosensitive drum according to a working example 7 of the invention.

FIG. 61 shows the lens data of the lens LS2.

FIG. 62 shows the aspherical surface coefficient of the lens LS2.

FIG. 63 shows the lens data of the lenses LS1, LS3.

FIG. 64 shows the aspherical surface coefficients of the lenses LS1, LS3.

FIG. 65 shows a simulation result in the case where the lenses LS1 to LS3 are formed based on the data given by above FIG. 61 to FIG. 64.

FIG. 66 is a group of tables showing the arrangement of the light emitting elements and the formation positions of the spots in the working example 7.

FIG. 67 is a sectional view along the sub scanning direction showing the relationship of arrangement of a lens array and a photosensitive drum according to the working example 8 of the invention.

FIG. 68 shows the lens data of the lens LS2.

FIG. 69 shows the aspherical surface coefficient of the lens LS2.

FIG. 70 shows the lens data of the lenses LS1, LS3.

FIG. 71 shows the aspherical surface coefficients of the lenses LS1, LS3.

FIG. 72 shows a simulation result in the case where the lenses LS1 to LS3 are formed based on the data given by above FIG. 68 to FIG. 71.

FIG. 73 is a group of tables showing the arrangement of the light emitting elements and the formation positions of the spots in the working example 8.

FIG. 74 is a sectional view along the sub scanning direction showing the relationship of arrangement of a lens array and a photosensitive drum according to the working example 9 of the invention.

FIG. 75 shows the lens data of the lens LS2.

FIG. 76 shows the aspherical surface coefficient of the lens LS2.

FIG. 77 shows the lens data of the lenses LS1, LS3.

FIG. 78 shows the aspherical surface coefficients of the lenses LS1. LS3.

FIG. 79 shows a simulation result in the case where the lenses LS1 to LS3 are formed based on the data given by above FIG. 75 to FIG. 78.

FIG. 80 is a group of tables showing the arrangement of the light emitting elements and the formation positions of the spots in the working example 9.

FIG. 81 is a sectional view along the sub scanning direction showing the relationship of arrangement of a lens array and a photosensitive drum according to the working example 10 of the invention.

FIG. 82 shows the lens data of the lens LS2.

FIG. 83 shows the aspherical surface coefficient of the lens LS2.

FIG. 84 shows the lens data of the lenses LS1, LS3.

FIG. 85 shows the aspherical surface coefficients of the lenses LS1, LS3.

FIG. 86 shows a simulation result in the case where the lenses LS1 to LS3 are formed based on the data given by above FIG. 82 to FIG. 85.

FIG. 87 is a group of tables showing the arrangement of the light emitting elements and the formation positions of the spots in the working example 10.

FIG. 88 is a sectional view along the sub scanning direction showing the relationship of arrangement of a lens array and a photosensitive drum according to the working example 11 of the invention.

FIG. 89 shows the lens data of the lenses LS2, LS3.

FIG. 90 shows the aspherical surface coefficients of the lenses LS2, LS3.

FIG. 91 shows the lens data of the lenses LS1, LS4.

FIG. 92 shows the aspherical surface coefficients of the lenses LS1, LS4.

FIG. 93 shows a simulation result in the case where the lenses LS1 to LS4 are formed based on the data given by above FIG. 89 to FIG. 92.

FIG. 94 is a group of tables showing the arrangement of the light emitting elements and the formation positions of the spots in the working example 11.

FIG. 95 is a sectional view along the sub scanning direction showing the relationship of arrangement of a lens array and a photosensitive drum according to the working example 12 of the invention.

FIG. 96 shows the lens data of the lenses LS2, LS3.

FIG. 97 shows the aspherical surface coefficients of the lenses LS2, LS3.

FIG. 98 shows the lens data of the lenses LS1, LS4.

FIG. 99 shows the aspherical surface coefficients of the lenses LS1, LS4.

FIG. 100 shows a simulation result in the case where the lenses LS1 to LS4 are formed based on the data given by above FIG. 96 to FIG. 99.

FIG. 101 is a group of tables showing the arrangement of the light emitting elements and the formation positions of the spots in the working example 12.

FIG. 102 is a sectional view along the sub scanning direction showing the relationship of arrangement of a lens array and a photosensitive drum according to the working example 13 of the invention.

FIG. 103 shows the lens data of the lenses LS2, LS3.

FIG. 104 shows the aspherical surface coefficients of the lenses LS2, LS3.

FIG. 105 shows the lens data of the lenses LS1, LS4.

FIG. 106 shows the aspherical surface coefficients of the lenses LS1, LS4.

FIG. 107 shows a simulation result in the case where the lenses LS1 to LS4 are formed based on the data given by above FIG. 103 to FIG. 106.

FIG. 108 is a group of tables showing the arrangement of the light emitting elements and the formation positions of the spots in the working example 13.

FIG. 109 is a sectional view along the sub scanning direction showing the relationship of arrangement of a lens array and a photosensitive drum according to the working example 14 of the invention.

FIG. 110 shows the lens data of the lenses LS2, LS3.

FIG. 111 shows the aspherical surface coefficients of the lenses LS2, LS3.

FIG. 112 shows the lens data of the lenses LS1, LS4.

FIG. 113 shows the aspherical surface coefficients of the lenses LS1, LS4.

FIG. 114 shows a simulation result in the case where the lenses LS1 to LS4 are formed based on the data given by above FIG. 110 to FIG. 113.

FIG. 115 is a group of tables showing the arrangement of the light emitting elements and the formation positions of the spots in the working example 14.

FIG. 116 is a graph showing a change with time of spots, in which a horizontal axis represents positions on the photosensitive drum surface and a vertical axis represents surface potentials of the photosensitive drum surface.

FIG. 117 is a graph showing the spot diameters of the spots formed by the respective lens rows at the developing position.

FIG. 118 shows the lens data of the lenses LS used in a simulation of the working example 15.

FIG. 119 shows the aspherical surface coefficients of aspherical surfaces S4, S5 of the lens LS1 of the lens row LSR1.

FIG. 120 shows the aspherical surface coefficients of aspherical surfaces S4, S5 of the lens LS2 of the lens row LSR2.

FIG. 121 shows the aspherical surface coefficients of aspherical surfaces S4, S5 of the lens LS3 of the lens row LSR3.

FIG. 122 shows the specification of an optical system used in the simulation of the working example 15.

FIG. 123 shows a simulation result in the case where the lenses LS1 to LS3 are formed based on the data given by above FIG. 118 to FIG. 122.

FIGS. 124A and 124B are graphs showing the example of the method for calculating the focus position.

FIG. 125 is a sectional view along the sub scanning direction showing an effect in the case where an image side of a lens is constructed to be telecentric.

FIG. 126 is a sectional view along the sub scanning direction showing an image forming apparatus including the line head according to the invention.

### DESCRIPTION OF EXEMPLARY EMBODIMENTS

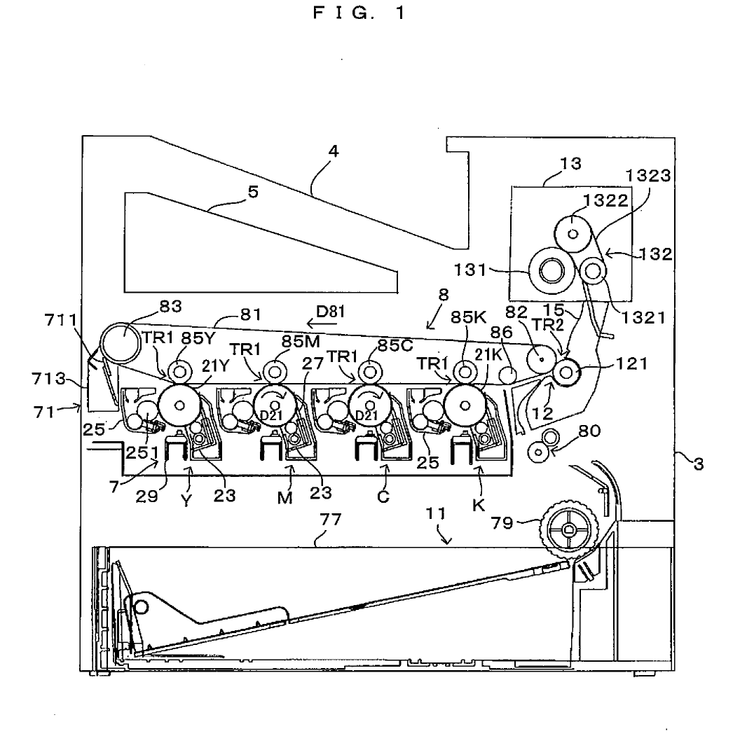

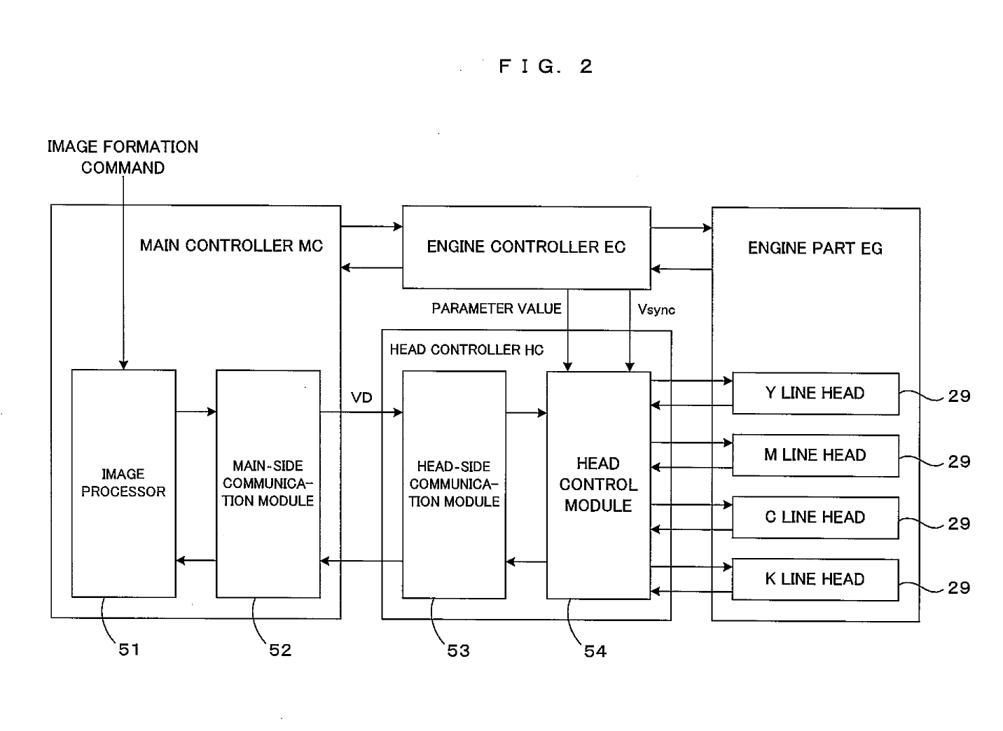

FIG. 1 is a diagram showing an embodiment of an image forming apparatus according to the invention, and FIG. 2 is a diagram showing the electrical construction of the image forming apparatus of FIG. 1. This apparatus is an image forming apparatus that can selectively execute a color mode for forming a color image by superimposing four color toners of black (K), cyan (C), magenta (M) and yellow (Y) and a monochromatic mode for forming a monochromatic image using only black (K) toner. FIG. 1 is a diagram corresponding to the execution of the color mode. In this image forming apparatus, when an image formation command is given from an external apparatus such as a host computer to a main controller MC having a CPU and memories, the main controller MC feeds a control signal and the like to an engine controller EC and feeds video data VD corresponding to the image formation command to a head controller HC. This head controller HC controls line heads 29 of the respective colors based on the video data VD from the main controller MC, a vertical synchronization signal Vsync from the engine controller EC and parameter values from the engine controller EC. In this way, an engine part EG performs a specified image forming operation to form an image corresponding to the image formation command on a sheet such as a copy sheet, transfer sheet, form sheet or transparent sheet for OHP.

An electrical component box 5 having a power supply circuit board, the main controller MC, the engine controller EC and the head controller HC built therein is disposed in a housing main body 3 of the image forming apparatus according to this embodiment. An image forming unit 7, a transfer belt unit 8 and a sheet feeding unit 11 are also arranged in the housing main body 3. A secondary transfer unit 12, a fixing unit 13, and a sheet guiding member 15 are arranged at the right side in the housing main body 3 in FIG. 1. It should be noted that the sheet feeding unit 11 is detachably mountable into the housing main body 3. The sheet feeding unit 11 and the transfer belt unit 8 are so constructed as to be detachable for repair or exchange respectively.

The image forming unit 7 includes four image forming stations Y (for yellow), M (for magenta), C (for cyan) and K (for black) which form a plurality of images having different colors. Each of the image forming stations Y, M, C and K includes a cylindrical photosensitive drum 21 having a surface of a specified length in a main scanning direction MD. It is to be noted that a shape of a curved surface of a cylindrical form is defined as a “curvature shape”, and “a surface has a curvature” means that the shape of the surface is a curvature shape in this specification. Further, when it is called that “a curvature center of a curvature shape”, the curvature center means a point on the central axis of the cylindrical form. Each of the image forming stations Y, M, C and K forms a toner image of the corresponding color on the surface of the photosensitive drum 21. The photosensitive drum is arranged so that the axial direction thereof is substantially parallel to the main scanning direction MD. Each photosensitive drum 21 is connected to its own driving motor and is driven to rotate at a specified speed in a direction of arrow D21 in FIG. 1, whereby the surface of the photosensitive drum 21 is transported in a sub scanning direction SD which is orthogonal or substantially orthogonal to the main scanning direction MD. Further, a charger 23, the line head 29, a developer 25 and a photosensitive drum cleaner 27 are arranged in a rotating direction around each photosensitive drum 21. A charging operation, a latent image forming operation and a toner developing operation are performed by these functional sections. Accordingly, a color image is formed by superimposing toner images formed by all the image forming stations Y, M, C and K on a transfer belt 81 of the transfer belt unit 8 at the time of executing the color mode, and a monochromatic image is formed using only a toner image formed by the image forming station K at the time of executing the monochromatic mode. Meanwhile, since the respective image forming stations of the image forming unit 7 are identically constructed, reference characters are given to only some of the image forming stations while being not given to the other image forming stations in order to facilitate the diagrammatic representation in FIG. 1.

The charger 23 includes a charging roller having the surface thereof made of an elastic rubber. This charging roller is constructed to be rotated by being held in contact with the surface of the photosensitive drum 21 at a charging position. As the photosensitive drum 21 rotates, the charging roller is rotated at the same circumferential speed in a direction driven by the photosensitive drum 21. This charging roller is connected to a charging bias generator (not shown) and charges the surface of the photosensitive drum 21 at the charging position where the charger 23 and the photosensitive drum 21 are in contact upon receiving the supply of a charging bias from the charging bias generator.

The line head 29 is arranged relative to the photosensitive drum 21 so that the longitudinal direction thereof corresponds to the main scanning direction MD and the width direction thereof corresponds to the sub scanning direction SD. Hence, the longitudinal direction of the line head 29 is substantially parallel to the main scanning direction MD. The line head includes a plurality of light emitting elements arrayed in the longitudinal direction and is positioned separated from the photosensitive drum 21. Light beams are emitted from these light emitting elements to irradiate (in other words, expose) the surface of the photosensitive drum 21 charged by the charger 23, thereby forming a latent image on this surface (exposing step). In this embodiment, the head controller HC is provided to control the line heads 29 of the respective colors, and controls the respective line heads 29 based on the video data VD from the main controller MC and a signal from the engine controller EC. Specifically, in this embodiment, image data included in an image formation command is inputted to an image processor 51 of the main controller MC. Then, video data VD of the respective colors are generated by applying various image processings to the image data, and the video data VD are fed to the head controller HC via a main-side communication module 52. In the head controller HC, the video data VD are fed to a head control module 54 via a head-side communication module 53. Signals representing parameter values relating to the formation of a latent image and the vertical synchronization signal Vsync are fed to this head control module 54 from the engine controller EC as described above. Based on these signals, the video data VD and the like, the head controller HC generates signals for controlling the driving of the elements of the line heads 29 of the respective colors and outputs them to the respective line heads 29. In this way, the operations of the light emitting elements in the respective line heads 29 are suitably controlled to form latent images corresponding to the image formation command.

In this embodiment, the photosensitive drum 21, the charger 23, the developer 25 and the photosensitive drum cleaner 27 of each of the image forming stations Y, M, C and K are unitized as a photosensitive cartridge. Further, each photosensitive cartridge includes a nonvolatile memory for storing information on the photosensitive cartridge. Wireless communication is performed between the engine controller EC and the respective photosensitive cartridges. By doing so, the information on the respective photosensitive cartridges is transmitted to the engine controller EC and information in the respective memories can be updated and stored.

The developer 25 includes a developing roller 251 carrying toner on the surface thereof. By a development bias applied to the developing roller 251 from a development bias generator (not shown) electrically connected to the developing roller 251, charged toner is transferred from the developing roller 251 to the photosensitive drum 21 to develop the latent image formed by the line head 29 at a development position where the developing roller 251 and the photosensitive drum 21 are in contact.

The toner image developed at the development position in this way is primarily transferred to the transfer belt 81 at a primary transfer position TR1 to be described later where the transfer belt 81 and each photosensitive drum 21 are in contact after being transported in the rotating direction D21 of the photosensitive drum 21.

Further, in this embodiment, the photosensitive drum cleaner 27 is disposed in contact with the surface of the photosensitive drum 21 downstream of the primary transfer position TR1 and upstream of the charger 23 with respect to the rotating direction D21 of the photosensitive drum 21. This photosensitive drum cleaner 27 removes the toner remaining on the surface of the photosensitive drum 21 to clean after the primary transfer by being held in contact with the surface of the photosensitive drum.

The transfer belt unit 8 includes a driving roller 82, a driven roller (blade facing roller) 83 arranged to the left of the driving roller 82 in FIG. 1, and the transfer belt 81 mounted on these rollers and driven to turn in a direction of arrow D81 in FIG. 1 (conveying direction). The transfer belt unit 8 also includes four primary transfer rollers 85Y, 85M, 85C and 85K arranged to face in a one-to-one relationship with the photosensitive drums 21 of the respective image forming stations Y, M, C and K inside the transfer belt 81 when the photosensitive cartridges are mounted. These primary transfer rollers 85Y, 85M, 85C and 85K are respectively electrically connected to a primary transfer bias generator not shown. As described in detail later, at the time of executing the color mode, all the primary transfer rollers 85Y, 85M, 85C and 85K are positioned on the sides of the image forming stations Y, M, C and K as shown in FIG. 1, whereby the transfer belt 81 is pressed into contact with the photosensitive drums 21 of the image forming stations Y, M, C and K to form the primary transfer positions TR1 between the respective photosensitive drums 21 and the transfer belt 81. By applying primary transfer biases from the primary transfer bias generator to the primary transfer rollers 85Y, 85M, 85C and 85K at suitable timings, the toner images formed on the surfaces of the respective photosensitive drums 21 are transferred to the surface of the transfer belt 81 at the corresponding primary transfer positions TR1 to form a color image.

On the other hand, out of the four primary transfer rollers 85Y 85M, 85C and 85K, the color primary transfer rollers 85Y, 85M, 85C are separated from the facing image forming stations Y, M and C and only the monochromatic primary transfer roller 85K is brought into contact with the image forming station K at the time of executing the monochromatic mode, whereby only the monochromatic image forming station K is brought into contact with the transfer belt 81. As a result, the primary transfer position TR1 is formed only between the monochromatic primary transfer roller 85K and the image forming station K. By applying a primary transfer bias at a suitable timing from the primary transfer bias generator to the monochromatic primary transfer roller 85K, the toner image formed on the surface of the photosensitive drum 21 is transferred to the surface of the transfer belt 81 at the primary transfer position TR1 to form a monochromatic image.

The transfer belt unit 8 further includes a downstream guide roller 86 disposed downstream of the monochromatic primary transfer roller 85K and upstream of the driving roller 82. This downstream guide roller 86 is so disposed as to come into contact with the transfer belt 81 on an internal common tangent to the primary transfer roller 85K and the photosensitive drum 21 at the primary transfer position TR1 formed by the contact of the monochromatic primary transfer roller 85K with the photosensitive drum 21 of the image forming station K.

The driving roller 82 drives to rotate the transfer belt 81 in the direction of the arrow D81 and doubles as a backup roller for a secondary transfer roller 121. A rubber layer having a thickness of about 3 mm and a volume resistivity of 1000 kΩ·2 cm or lower is formed on the circumferential surface of the driving roller 82 and is grounded via a metal shaft, thereby serving as an electrical conductive path for a secondary transfer bias to be supplied from an unillustrated secondary transfer bias generator via the secondary transfer roller 121. By providing the driving roller 82 with the rubber layer having high friction and shock absorption, an impact caused upon the entrance of a sheet into a contact part (secondary transfer position TR2) of the driving roller 82 and the secondary transfer roller 121 is unlikely to be transmitted to the transfer belt 81 and image deterioration can be prevented.

The sheet feeding unit 11 includes a sheet feeding section which has a sheet cassette 77 capable of holding a stack of sheets, and a pickup roller 79 which feeds the sheets one by one from the sheet cassette 77. The sheet fed from the sheet feeding section by the pickup roller 79 is fed to the secondary transfer position TR2 along the sheet guiding member 15 after having a sheet feed timing adjusted by a pair of registration rollers 80.

The secondary transfer roller 121 is provided freely to abut on and move away from the transfer belt 81, and is driven to abut on and move away from the transfer belt 81 by a secondary transfer roller driving mechanism (not shown). The fixing unit 13 includes a heating roller 131 which is freely rotatable and has a heating element such as a halogen heater built therein, and a pressing section 132 which presses this heating roller 131. The sheet having an image secondarily transferred to the front side thereof is guided by the sheet guiding member 15 to a nip portion formed between the heating roller 131 and a pressure belt 1323 of the pressing section 132, and the image is thermally fixed at a specified temperature in this nip portion. The pressing section 132 includes two rollers 1321 and 1322 and the pressure belt 1323 mounted on these rollers. Out of the surface of the pressure belt 1323, a part stretched by the two rollers 1321 and 1322 is pressed against the circumferential surface of the heating roller 131, thereby forming a sufficiently wide nip portion between the heating roller 131 and the pressure belt 1323. The sheet having been subjected to the image fixing operation in this way is transported to the discharge tray 4 provided on the upper surface of the housing main body 3.

Further, a cleaner 71 is disposed facing the blade facing roller 83 in this apparatus. The cleaner 71 includes a cleaner blade 711 and a waste toner box 713. The cleaner blade 711 removes foreign matters such as toner remaining on the transfer belt after the secondary transfer and paper powder by holding the leading end thereof in contact with the blade facing roller 83 via the transfer belt 81. Foreign matters thus removed are collected into the waste toner box 713. Further, the cleaner blade 711 and the waste toner box 713 are constructed integral to the blade facing roller 83. Accordingly, if the blade facing roller 83 moves as described next, the cleaner blade 711 and the waste toner box 713 move together with the blade facing roller 83.

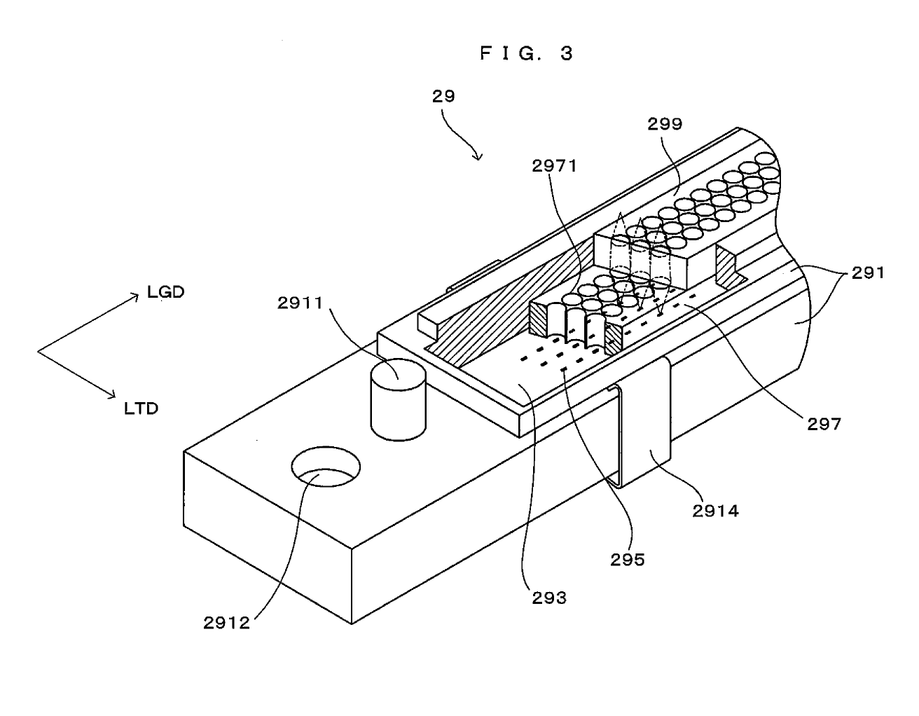

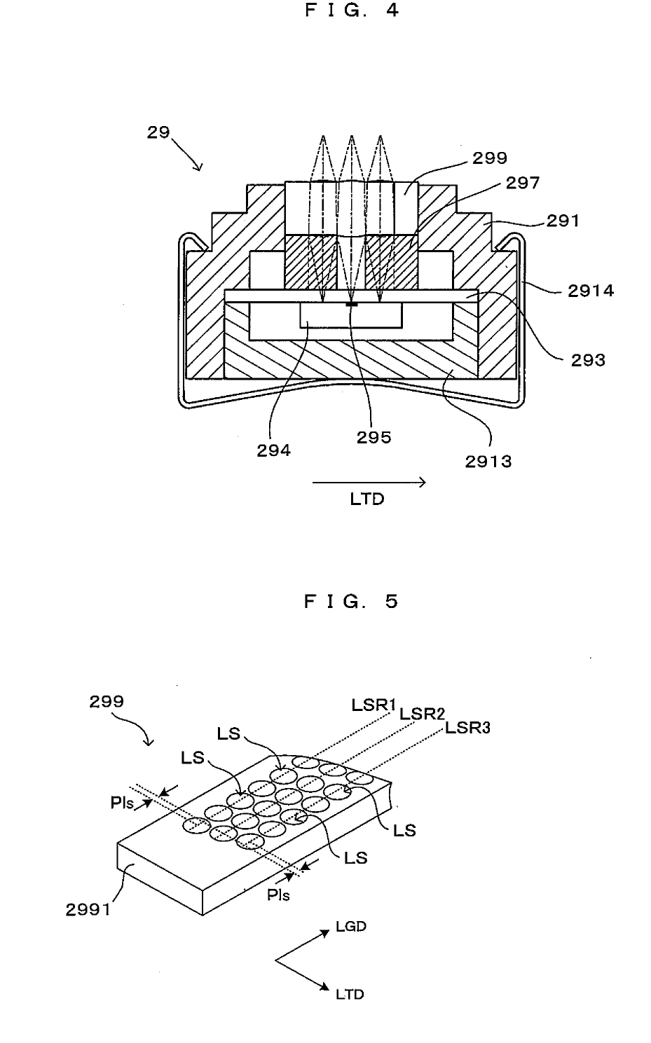

FIG. 3 is a perspective view schematically showing one embodiment of a line head according to the invention, and FIG. 4 is a sectional view along a width direction showing the embodiment of the line head according to the invention. As described above, the line head 29 is arranged to face the photosensitive drum 21 such that the longitudinal direction LGD corresponds to the main scanning direction MD and the width direction LTD corresponds to the sub scanning direction SD. The longitudinal direction LGD and the width direction LTD are substantially normal to each other. The line head 29 of this embodiment includes a case 291, and a positioning pin 2911 and a screw insertion hole 2912 are provided at each of the opposite ends of such a case 291 in the longitudinal direction LGD. The line head 29 is positioned relative to the photosensitive drum 21 by fitting such positioning pins 2911 into positioning holes (not shown) perforated in a photosensitive drum cover (not shown) covering the photosensitive drum 21 and positioned relative to the photosensitive drum 21. Further, the line head 29 is positioned and fixed relative to the photosensitive drum 21 by screwing fixing screws into screw holes (not shown) of the photosensitive drum cover via the screw insertion holes 2912 to be fixed.

The case 291 carries a lens array 299 at a position facing the surface of the photosensitive drum 21, and includes a light shielding member 297 and a head substrate 293 inside, the light shielding member 297 being closer to the lens array 299 than the head substrate 293. Further, a plurality of light emitting element groups 295 are provided on an under surface of the head substrate 293 (surface opposite to the lens array 299 out of two surfaces of the head substrate 293). Specifically, the plurality of light emitting element groups 295 are two-dimensionally arranged on the under surface of the head substrate 293 while being spaced by specified distances in the longitudinal direction LGD and the width direction LTD. Here, each light emitting element group 295 is formed by two-dimensionally arraying a plurality of light emitting elements. This is described in detail later. In this embodiment, bottom emission-type EL (Electro-Luminescence) devices are used as the light emitting elements. In other words, the organic EL devices are arranged as light emitting elements on the under surface of the head substrate 293 in this embodiment. Thus, all the light emitting elements 2951 are arranged on the same plane (under surface of the head substrate 293). When the respective light emitting elements are driven by a drive circuit formed on the head substrate 293, light beams are emitted from the light emitting elements in directions toward the photosensitive drum 21. At this time, all the light emitting elements 2951 emit light beams having the same wavelength. These light beams propagate toward the light shielding member 297 via the head substrate 293.

The light shielding member 297 is perforated with a plurality of light guide holes 2971 in a one-to-one correspondence with the plurality of light emitting element groups 295. Such light guide holes 2971 are substantially cylindrical holes each penetrating the light shielding member 297 and having a center axis parallel to a normal to the head substrate 293. Thus, all the lights emitted from the light emitting elements belonging to one light emitting element group 295 propagate toward the lens array 299 via the same light guide hole 2971, and the interference of the light beams emitted from different light emitting element groups 295 is prevented by the light shielding member 297. The light beams having passed through the light guide holes 2971 perforated in the light shielding member 297 are focused as spots on the surface of the photosensitive drum 21 by the lens array 299. The specific structure of the lens array 299 and focused states of the light beams by the lens array 299 are described in detail later.

As shown in FIG. 4, an underside lid 2913 is pressed against the case 291 via the head substrate 293 by retainers 2914. Specifically, the retainers 2914 have elastic forces to press the underside lid 2913 toward the case 291, and seal the inside of the case 291 light-tight (that is, so that light does not leak from the inside of the case 291 and so that light does not intrude into the case 291 from the outside) by pressing the underside lid by means of the elastic force. It should be noted that a plurality of the retainers 2914 are provided at a plurality of positions in the longitudinal direction of the case 291. The light emitting element groups 295 are covered with a sealing member 294.

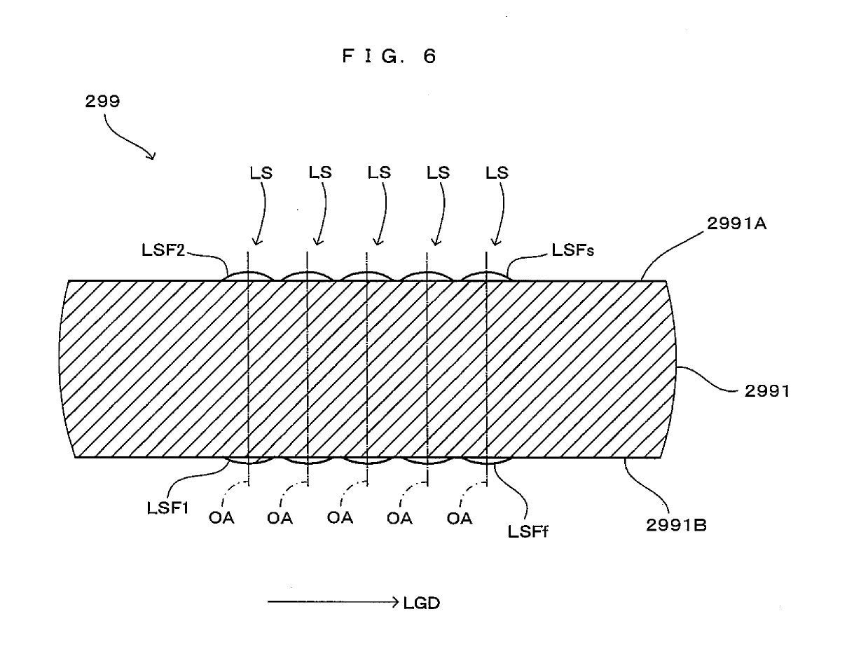

FIG. 5 is a schematic partial perspective view of the lens array, and FIG. 6 is a sectional view of the lens array in the longitudinal direction LGD. The lens array 299 includes a lens substrate 2991. First surfaces LSFf of lenses LS are formed on an under surface 2991B of the lens substrate 2991, and second surfaces LSFs of the lenses LS are formed on a top surface 2991A of the lens substrate 2991. The first and second surfaces LSFF, LSFs facing each other and the lens substrate 2991 held between these two surfaces function as one lens LS. The first and second surfaces LSFF, LSFs of the lenses LS can be made of resin for instance.

The lens array 299 is arranged such that optical axes OA of the plurality of lenses LS are substantially parallel to each other. The lens array 299 is also arranged such that the optical axes OA of the lenses LS are substantially normal to the under surface (surface where the light emitting elements 2951 are arranged) of the head substrate 293. At this time, these plurality of lenses LS are arranged in a one-to-one correspondence with the plurality of light emitting element groups 295. Specifically, the plurality of lenses LS are two-dimensionally arranged while being spaced apart at specified pitches in the longitudinal direction LGD and the width direction LTD in conformity with the arrangement of the light emitting element groups 295. More specifically, a plurality of lens rows LSR, in each of which a plurality of lenses LS are aligned in the longitudinal direction LGD, are arranged in the width direction LTD. In this embodiment, three lens rows LSR1, LSR2 and LSR3 are arranged in the width direction LTD. The three lens rows LSR1 to LSR3 are displaced from each other by a specified lens pitch Pls in the longitudinal direction.

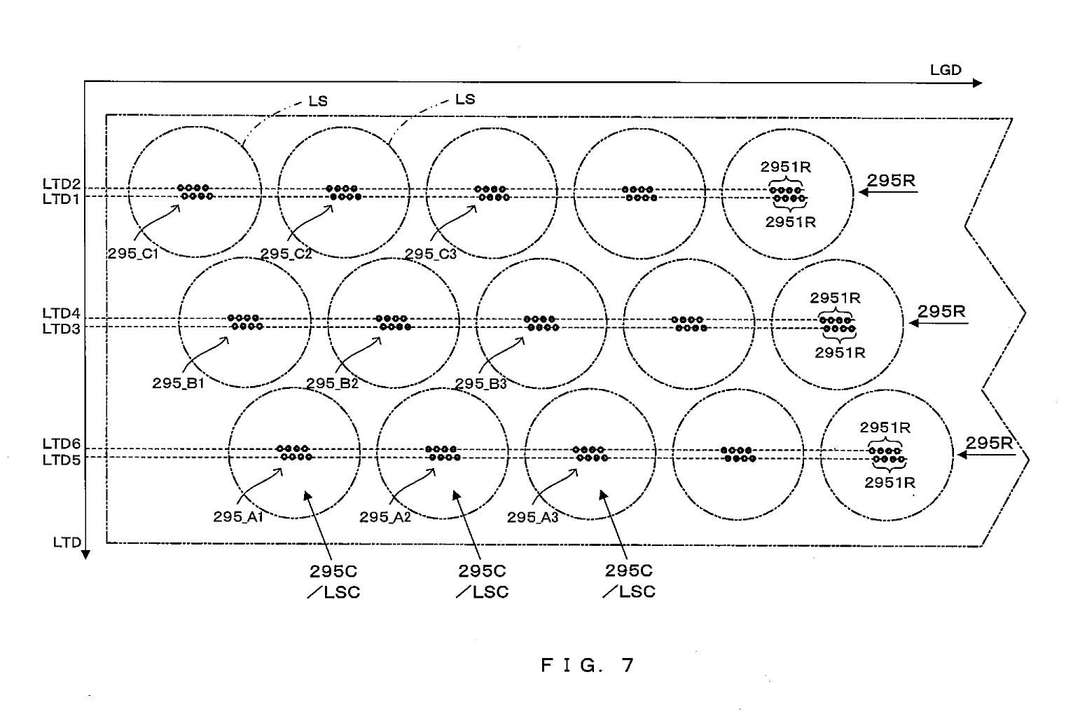

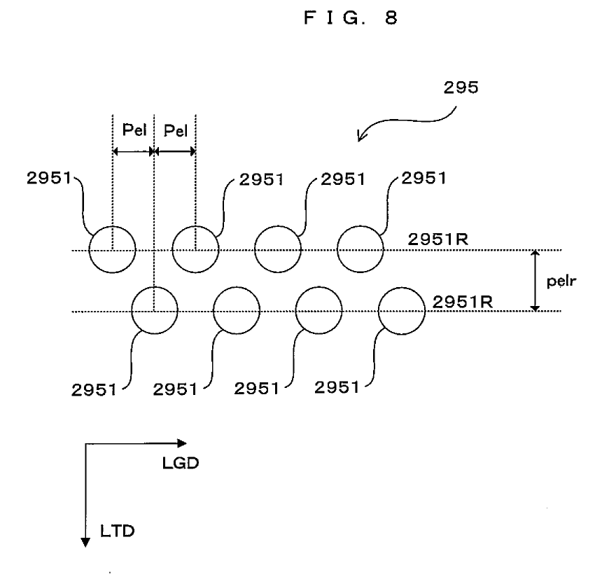

FIG. 7 is a diagram showing the arrangement of the light emitting element groups in the line head, and FIG. 8 is a diagram showing the arrangement of the light emitting elements in each light emitting element group. In this embodiment, the plurality of light emitting elements 2951 are grouped into the respective light emitting element groups 295, and eight light emitting elements 2951 are aligned at specified element pitches Pel in the longitudinal direction LGD in each light emitting element group 295. In each light emitting element group 295, two light emitting element rows 2951R each formed by aligning four light emitting elements 2951 at specified pitches (twice the element pitch Pel) in the longitudinal direction LGD are arranged while being spaced apart by an element row pitch Pelr in the width direction LTD. The plurality of light emitting element groups 295 are arranged as follows.

Specifically, the plurality of light emitting element groups 295 are arranged such that three light emitting element group rows 295R each formed by aligning a specified number of light emitting element groups 295 in the longitudinal direction LGD are arranged in the width direction LTD. All the light emitting element groups 295 are arranged at mutually different longitudinal-direction positions. Further, the plurality of light emitting element groups 295 are arranged such that the light emitting element groups adjacent in the longitudinal direction (light emitting element groups 295_C1 and 295_B1 for example) differ in their width-direction positions. In this way, a light emitting element group column 295C is formed by arranging a plurality of (three in FIG. 7) light emitting element groups 295 while displacing them from each other in the width direction LTD. A plurality of light emitting element group columns 295C are arranged in the longitudinal direction LGD. In this specification, it is defined that the position of each light emitting element is the geometric center of gravity thereof and that the position of the light emitting element group 295 is the geometric center of gravity of the positions of all the light emitting elements belonging to the same light emitting element group 295. The longitudinal-direction position and the width-direction position mean a longitudinal-direction component and a width-direction component of a particular position, respectively.

The light guide holes 2971 are perforated in the light shielding member 297 and the lenses LS are arranged in conformity with the arrangement of the above light emitting element groups 295. In other words, a lens column LSC is formed by arranging a plurality of (three in FIG. 7) lenses LS while displacing them from each other in the width direction LTD. A plurality of lens columns LSC are arranged in the longitudinal direction LGD. In this embodiment, the center of gravity positions of the light emitting element groups 295, the center axes of the light guide holes 2971 and the optical axes OA of the lenses LS substantially coincide. Light beams emitted from the light emitting elements 2951 of the light emitting element groups 295 are incident on the lens array 299 via the corresponding light guide holes 2971 and focused as spots on the surface of the photosensitive drum 21 by the lens array 299.

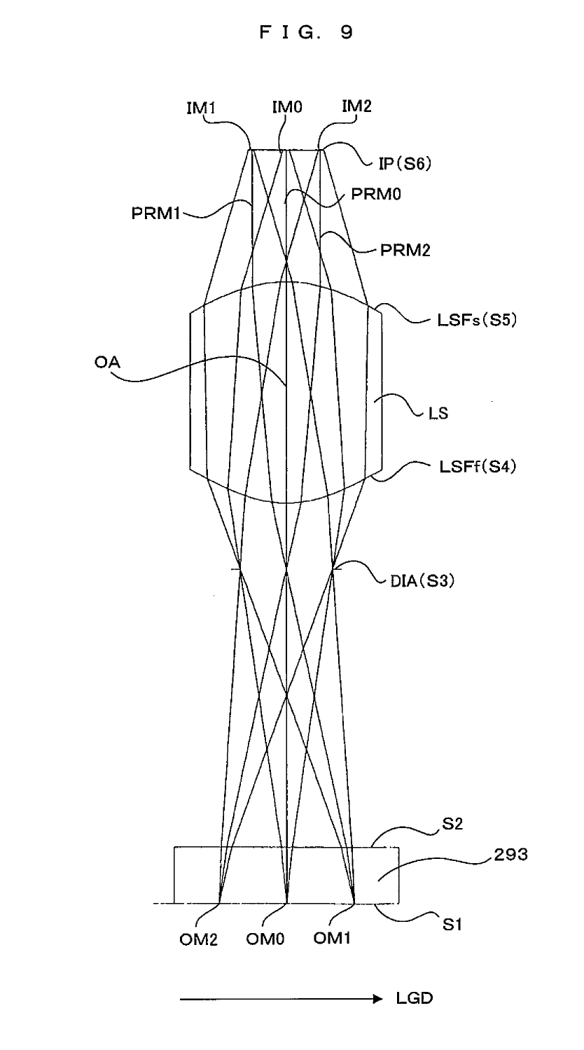

FIG. 9 is a diagram showing a focusing state of the lens in a section including the longitudinal direction and the optical axis. FIG. 9 shows trajectories of light beams from virtual object points OM0, OM1 and OM2 located on the under surface of the head substrate 293 in order to represent the focusing state of the lens LS. Here, the virtual object point OM0 is located on the optical axis OA, and the virtual object points OM1 and OM2 are located at positions symmetric with respect to the optical axis OA. As shown by such trajectories, the light beams emitted from the virtual object points emerge from the top surface of the head substrate 293 after being incident on the under surface of the head substrate 293. The light beams emerging from the top surface of the head substrate 293 reach an image plane IP (surface of the photosensitive drum 21) via the lens LS. Here, the head substrate 293 and the lens LS respectively have specified refractive indices.

As shown in FIG. 9, the light beam emitted from the virtual object point OM0 is focused on an intersection IM0 of the image plane IP and the optical axis OA. The light beams emitted from the virtual object points OM1, OA are focused on positions IM, IM2 of the image plane. Specifically, the light beam emitted from the virtual object point OM1 is focused on the position IM1 at an opposite side with respect to the optical axis OA in the longitudinal direction LGD, and the light beam emitted from the virtual object point OM2 is focused on the position IM2 at an opposite side with respect to the optical axis OA in the longitudinal direction LGD. Thus, the lens LS in this embodiment is a so-called inverting optical system having an inverting property. As shown in FIG. 9, a distance between the positions IM1 and IM0 where the light beams are focused is shorter than a distance between the virtual object points OM1 and OM0. In other words, the absolute value of the magnification of an optical system comprised of the head substrate 293 and the lens LS in this embodiment is below 1. Further, an aperture diaphragm DIA is arranged at a front focus between the head substrate 293 and the first surface LSFf of the lens LS (that is, in an object space). As a result, chief rays PRMO to PRM2 of the light beams are all parallel to the optical axis OA in an image space. In other words, an image side of the lens LS is telecentrically constructed.

FIG. 10 is a diagram showing a focusing state of the lens in a section including the width direction and the optical axis. FIG. 10 shows trajectories of light beams from virtual object points OS0, OS1 and OS2 located on the under surface of the head substrate 293 in order to represent the focusing state of the lens LS. Here, the virtual object point OS0 is located on the optical axis OA, and the virtual object points OS1 and OS2 are located at positions symmetric with respect to the optical axis OA. As shown by such trajectories, the light beams emitted from the virtual object points emerge from the top surface of the head substrate 293 after being incident on the under surface of the head substrate 293. The light beams emerging from the top surface of the head substrate 293 reach the image plane IP (surface of the photosensitive drum 21) via the lens LS. As described above, the head substrate 293 and the lens LS respectively have specified refractive indices.

As shown in FIG. 10, the light beam emitted from the virtual object point OS0 is focused on an intersection IS0 of the image plane IP and the optical axis OA. The light beams emitted from the virtual object points OS1, OS2 are focused on positions IS1, IS2 of the image plane. Specifically, the light beam emitted from the virtual object point OS1 is focused on the position IS1 at an opposite side with respect to the optical axis OA in the width direction LTD, and the light beam emitted from the virtual object point OS2 is focused on the position IS2 at an opposite side with respect to the optical axis OA in the width direction LTD. Thus, the lens LS in this embodiment is a so-called inverting optical system having an inverting property. As shown in FIG. 10, a distance between the positions IS1 and IS0 where the light beams are focused is shorter than a distance between the virtual object points OS1 and OS0. In other words, the absolute value of the magnification of the optical system comprised of the head substrate 293 and the lens LS in this embodiment is below 1. Further, the aperture diaphragm DIA is arranged at the front focus between the head substrate 293 and the first surface LSf of the lens LS (that is, in the object space). As a result, chief rays PRS0 to PRS2 of the light beams are all parallel to the optical axis OA in the image space. In other words, the image side of the lens LS is telecentrically constructed.

FIGS. 11 and 12 are diagrams showing terminology used in this specification. Here, terminology used in this specification is organized with reference to FIGS. 11 and 12. In this specification, as described above, a conveying direction of the surface (image plane IP) of the photosensitive drum 21 is defined to be the sub scanning direction SD and a direction substantially normal to the sub scanning direction SD is defined to be the main scanning direction MD. Further, a line head 29 is arranged relative to the surface (image plane IP) of the photosensitive drum 21 such that its longitudinal direction LGD corresponds to the main scanning direction MD and its width direction LTD corresponds to the sub scanning direction SD.

Collections of a plurality of (eight in FIGS. 11 and 12) light emitting elements 2951 arranged on the head substrate 293 in one-to-one correspondence with the plurality of lenses LS of the lens array 299 are defined to be light emitting element groups 295. In other words, in the head substrate 293, the light emitting element groups 295 each including the plurality of light emitting elements 2951 are arranged in conformity with the respective lenses LS. Further, collections of a plurality of spots SP formed on the image plane IP by focusing light beams from the light emitting element groups 295 toward the image plane IP by the lenses LS corresponding to the light emitting element groups 295 are defined to be spot groups SG. In other words, a plurality of spot groups SG can be formed in one-to-one correspondence with the plurality of light emitting element groups 295. In each spot group SG, the most upstream spot in the main scanning direction MD and the sub scanning direction SD is particularly defined to be a first spot. The light emitting element 2951 corresponding to the first spot is particularly defined to be a first light emitting element.

FIGS. 11 and 12 show a case where the spots SP are formed with the image plane kept stationary in order to facilitate the understanding of the correspondence relationship of the light emitting element groups 295, the lenses LS and the spot groups SG. Accordingly, the formation positions of the spots SP in the spot groups SG are substantially similar to the arranged positions of the light emitting elements 2951 in the light emitting element groups 295. However, as described later, an actual spot forming operation is performed while the image plane IP (surface of the photosensitive drum 21) is conveyed in the sub scanning direction SD. As a result, the spots SP formed by the plurality of light emitting elements 2951 of the head substrate 293 are formed on a straight line substantially parallel to the main scanning direction MD.

Further, spot group rows SGR and spot group columns SGC are defined as shown in the column “On Image Plane” of FIG. 12. Specifically, a plurality of spot groups SG aligned in the main scanning direction MD is defined to be the spot group row SGR. A plurality of spot group rows SGR are arranged at specified spot group row pitches Psgr in the sub scanning direction SD. Further, a plurality of (three in FIG. 12) spot groups SG arranged at the spot group row pitches Psgr in the sub scanning direction SD and at spot group pitches Psg in the main scanning direction MD are defined to be the spot group column SGC. It should be noted that the spot group row pitch Psgr is a distance in the sub scanning direction SD between the geometric centers of gravity of the two spot group rows SGR side by side with the same pitch and that the spot group pitch Psg is a distance in the main scanning direction MD between the geometric centers of gravity of the two spot groups SG side by side with the same pitch.

Lens rows LSR and lens columns LSC are defined as shown in the column of “CLens Array” of FIG. 12. Specifically, a plurality of lenses LS aligned in the longitudinal direction LGD is defined to be the lens row LSR. A plurality of lens rows LSR are arranged at specified lens row pitches Plsr in the width direction LTD. Further, a plurality of (three in FIG. 12) lenses LS arranged at the lens row pitches Plsr in the width direction LTD and at lens pitches Pls in the longitudinal direction LGD are defined to be the lens column LSC. It should be noted that the lens row pitch Plsr is a distance in the width direction LTD between the geometric centers of gravity of the two lens rows LSR side by side with the same pitch and that the lens pitch Pls is a distance in the longitudinal direction LGD between the geometric centers of gravity of the two lenses LS side by side with the same pitch.

Light emitting element group rows 295R and light emitting element group columns 295C are defined as in the column “Head Substrate” of FIG. 12. Specifically, a plurality of light emitting element groups 295 aligned in the longitudinal direction LGD is defined to be the light emitting element group row 295R. A plurality of light emitting element group rows 295R are arranged at specified light emitting element group row pitches Pegr in the width direction LTD. Further, a plurality of (three in FIG. 12) light emitting element groups 295 arranged at the light emitting element group row pitches Pegr in the width direction LTD and at light emitting element group pitches Peg in the longitudinal direction LGD are defined to be the light emitting element group column 295C. It should be noted that the light emitting element group row pitch Pegr is a distance in the width direction LTD between the geometric centers of gravity of the two light emitting element group rows 295R side by side with the same pitch and that the light emitting element group pitch Peg is a distance in the longitudinal direction LGD between the geometric centers of gravity of the two light emitting element groups 295 side by side with the same pitch.

Light emitting element rows 2951R and light emitting element columns 2951C are defined as in the column “Light emitting element group” of FIG. 12. Specifically, in each light emitting element group 295, a plurality of light emitting elements 2951 aligned in the longitudinal direction LGD is defined to be the light emitting element row 2951R. A plurality of light emitting element rows 2951R are arranged at specified light emitting element row pitches Pelr in the width direction LTD. Further, a plurality of (two in FIG. 12) light emitting elements 2951 arranged at the light emitting element row pitches Pelr in the width direction LTD and at light emitting element pitches Pel in the longitudinal direction LGD are defined to be the light emitting element column 2951C. It should be noted that the light emitting element row pitch Pelr is a distance in the width direction LTD between the geometric centers of gravity of the two light emitting element rows 2951R side by side with the same pitch and that the light emitting element pitch Pel is a distance in the longitudinal direction LGD between the geometric centers of gravity of the two light emitting elements 2951 side by side with the same pitch.

Spot rows SPR and spot columns SPC are defined as shown in the column “Spot Group” of FIG. 12. Specifically, in each spot group SG, a plurality of spots SG aligned in the longitudinal direction LGD is defined to be the spot row SPR. A plurality of spot rows SPR are arranged at specified spot row pitches Pspr in the width direction LTD. Further, a plurality of (two in FIG. 12) spots arranged at the spot row pitches Pspr in the width direction LTD and at spot pitches Psp in the longitudinal direction LGD are defined to be the spot column SPC. It should be noted that the spot row pitch Pspr is a distance in the sub scanning direction SD between the geometric centers of gravity of the two spot rows SPR side by side with the same pitch and that the spot pitch Psp is a distance in the main scanning direction MD between the geometric centers of gravity of the two spots SP side by side with the same pitch.

Here, the configurations, the number and the positions of the lenses LS used in this specification are defined. First of all, the “lens configuration” is a concept including the shape, the thickness, the material and the number of the lens LS. The lens positions, the lens thickness and the lens shape of the lenses LS are as follows.

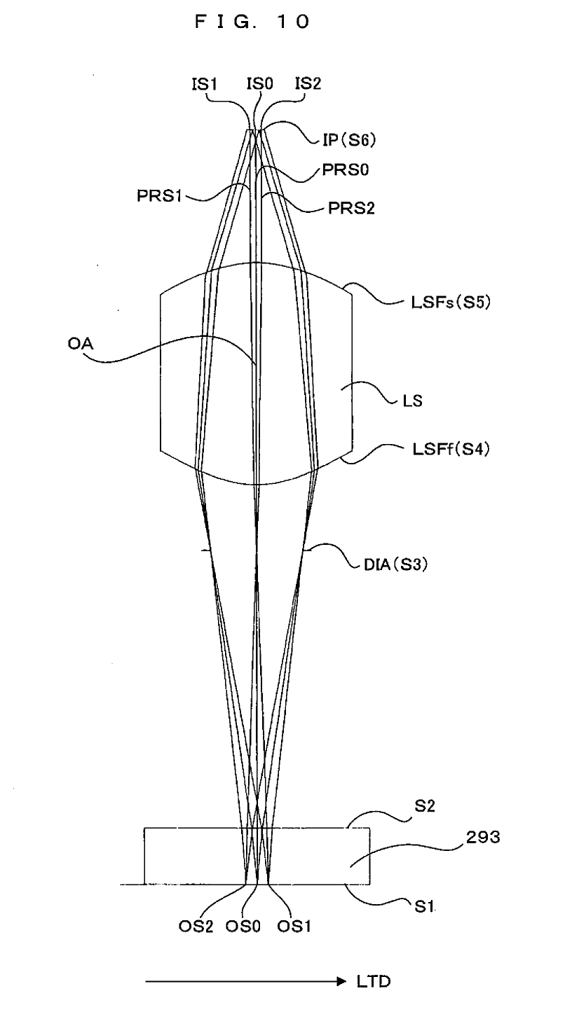

FIGS. 13A and 13B are diagrams showing the lens position and the like. FIG. 13A corresponds to a case where the light emitting element group 295, the head substrate 293 and the lens LS are seen in a direction normal to the optical axis OA of the lens LS, and FIG. 13B corresponds to a case where the lens LS is seen in a direction of the optical axis OA of the lens LS. The lens position of the lens LS is the position of an apex VTf of the first surface LSFf of the lens LS in the case where an intersection of an arrangement plane of the light emitting element group 295 corresponding to the lens LS (under surface of the head substrate 293 in this embodiment) and the optical axis OA is assumed to be an origin. Here, the apex VTf is an intersection of the first surface LSf of the lens LS and the optical axis OA. The lens thickness THK of the lens LS is an inter-surface distance between the first surface LSf and the second surface LSFs of the lens LS. Specifically, as shown in FIG. 13A, the lens thickness THK is a distance between the apex VTf of the first surface LSFf of the lens LS and the apex VTs of the second surface LSFs of the lens LS. The apex VTs is an intersection of the second surface LSFs of the lens LS and the optical axis OA. The lens shape of the lens LS is defined by the shapes of the first and second surfaces LSFf, LSFs of the lens LS. Thus, lenses having at least either the first surface LSFf or the second surface LSFs differing in shape have different lens shapes. In this specification, an image-plane facing distance ld is defined as follows. Specifically, the image-plane facing distance ld is a distance in the optical axis direction of this lens (that is, in the direction of the optical axis OA) between the apex VTs of the second surface LSFs of the lens LS, that is, of the lens surface LSFs facing toward the photosensitive drum (lens surface facing toward the latent image carrier) and the surface of the photosensitive drum 21 (latent image carrier surface) the lens LS is facing. In this specification, a lens diameter Dout is a diameter of the second surface LSFs of the lens LS (lens surface facing toward the photosensitive drum). The number of the lenses LS is the number of the lenses provided corresponding to one light emitting element group 295 and is one in FIGS. 13A and 13B.

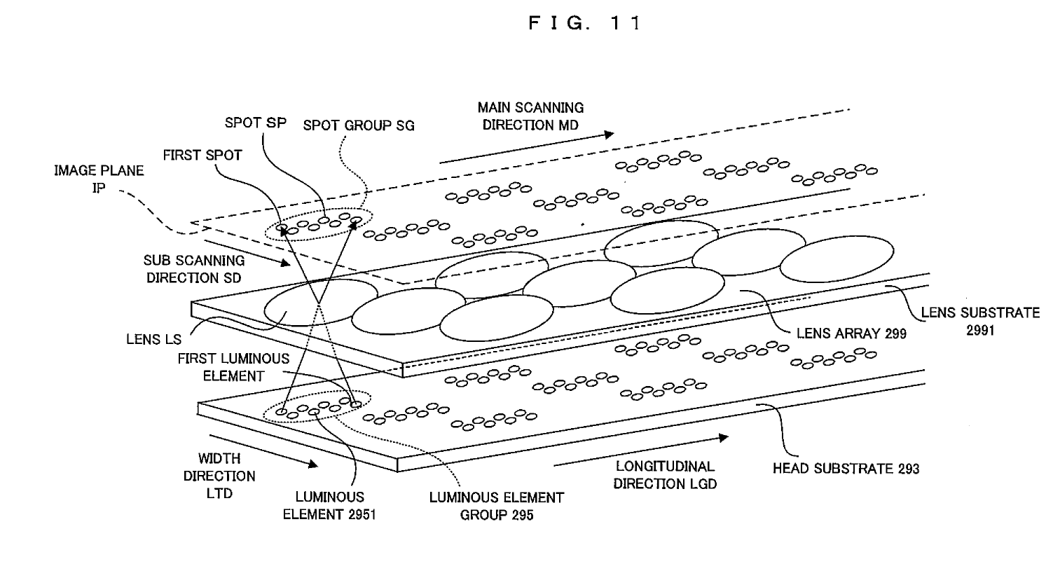

FIG. 14 is a diagram showing a spot forming operation by the above-described line head. The spot forming operation by the line head of this embodiment is described below with reference to FIGS. 2, 7 and 14. In order to facilitate the understanding of the invention, there is described a case where a plurality of spots are aligned on a straight line extending in the main scanning direction MD. In this embodiment, the plurality of spots are formed on the straight line extending in the main scanning direction MD by causing a plurality of light emitting elements to emit lights at specified timings by means of the head control module 54 while the surface of the photosensitive drum 21 (latent image carrier) is conveyed in the sub scanning direction SD.

Specifically, in the line head of this embodiment, six light emitting element rows 2951R are arranged in the width direction LTD corresponding to width-direction positions LTD1 to LTD6 (FIG. 7). Thus, in this embodiment, the light emitting element rows 2951R located at the same width-direction position are driven to emit lights substantially at the same timing, and those located at different width-direction positions are caused to emit lights at mutually different timings. More specifically, the light emitting element rows 2951R are driven to emit lights in an order of the width-direction positions LTD1 to LTD6. By driving the light emitting element rows 2951R to emit lights in the above order while the surface of the photosensitive drum 21 is conveyed in the sub scanning direction SD corresponding to the width direction LTD, the plurality of spots are formed while being aligned on the straight line extending in the main scanning direction MD of this surface.

Such an operation is described with reference to FIGS. 7 and 14. First of all, the light emitting elements 2951 of the light emitting element rows 2951R at the width-direction position LTD1 belonging to the most upstream light emitting element groups 295_C1, 295_C2, 295_C3, . . . in the width direction LTD corresponding to the sub scanning direction SD are driven to emit lights. A plurality of light beams emitted by such a light emitting operation are focused on the photosensitive drum surface in an inverted manner by the lenses LS having the above-mentioned inverting property. In other words, spots are formed at hatched positions of the “first operation” of FIG. 14. In FIG. 14, white circles represent spots that are not formed yet, but planned to be formed later. In FIG. 14, spots labeled by reference numerals 295_C1, 295_B1, 295_A1 and 295_C2 are those to be formed by the light emitting element groups 295 corresponding to the respective attached reference numerals.

Subsequently, the light emitting elements 2951 of the light emitting element rows 2951R at the width-direction position LTD2 belonging to the same light emitting element groups 295_C1, 295_C2, 295_C3, . . . are driven to emit lights. A plurality of light beams emitted by such a light emitting operation are focused on the photosensitive drum surface in an inverted manner by the lenses LS having the above-mentioned inverting property. In other words, spots are formed at hatched positions of the “second operation” of FIG. 14. Here, whereas the surface of the photosensitive drum 21 is conveyed in the sub scanning direction SD, the light emitting element rows 2951R are successively driven to emit lights from the downstream ones in the width direction LTD corresponding to the sub scanning direction SD (that is, in the order of the width-direction positions LTD1, LTD2). This is to deal with the inverting property of the lenses LS.

Subsequently, the light emitting elements 2951 of the light emitting element rows 2951R at the width-direction position LTD3 belonging to the second most upstream light emitting element groups 295_B1, 295_B2, 295_B3, . . . in the width direction LTD are driven to emit lights. A plurality of light beams emitted by such a light emitting operation are focused on the photosensitive drum surface in an inverted manner by the lenses LS having the above-mentioned inverting property. In other words, spots are formed at hatched positions of the “third operation” of FIG. 14.

Subsequently, the light emitting elements 2951 of the light emitting element rows 2951R at the width-direction position LTD4 belonging to the same light emitting element groups 295_B1, 295_B2, 295_B3, . . . are driven to emit lights. A plurality of light beams emitted by such a light emitting operation are focused on the photosensitive drum surface in an inverted manner by the lenses LS having the above-mentioned inverting property. In other words, spots are formed at hatched positions of the “fourth operation” of FIG. 14.

Subsequently, the light emitting elements 2951 of the light emitting element rows 2951R at the width-direction position LTD5 belonging to the most downstream light emitting element groups 295_A1, 295_A2, 295_A3, . . . in the width direction LTD are driven to emit lights. A plurality of light beams emitted by such a light emitting operation are focused on the photosensitive drum surface in an inverted manner by the lenses LS having the above-mentioned inverting property. In other words, spots are formed at hatched positions of the “fifth operation” of FIG. 14.

Finally, the light emitting elements 2951 of the light emitting element rows 2951R at the width-direction position LTD6 belonging to the same light emitting element groups 295_A1, 295_A2, 295_A3, . . . are driven to emit lights. A plurality of light beams emitted by such a light emitting operation are focused on the photosensitive drum surface in an inverted manner by the lenses LS having the above-mentioned inverting property. In other words, spots are formed at hatched positions of the “sixth operation” of FIG. 14. By performing the first to sixth light emitting operations in this way, a plurality of spots are formed while being aligned on the straight line extending in the main scanning direction MD.

As described above, in this embodiment, the plurality of light emitting elements 2951 are arranged at mutually different positions in the longitudinal direction LGD in each light emitting element group and two light emitting elements for emitting lights to form adjacent spots are arranged at mutually different positions in the width direction LTD. The spots SP are formed while being aligned in the main scanning direction MD by focusing the light beams emitted from the light emitting elements 2951 driven at timings in conformity with the movement of the photosensitive drum 21 in the sub scanning direction SD at mutual different positions of the photosensitive drum surface in the main scanning direction MD.

As described above, in the line head 29 of this embodiment, three lens rows LSR1 to LSR3 are arranged in the width direction LTD. The line head 29 is arranged relative to the photosensitive drum 21 such that the longitudinal direction LGD thereof corresponds to the main scanning direction MD and the width direction LTD thereof corresponds to the sub scanning direction SD. On the other hand, the surface of the photosensitive drum 21 has a curvature shape. Accordingly, as described in detail later, the lens rows LSR1 to LSR3 face positions of the photosensitive drum surface having a curvature shape mutually different in the sub scanning direction SD. Thus, unless the relationship of arrangement of the line head 29 and the photosensitive drum 21 is proper, there has been a problem of being unable to satisfactorily expose the photosensitive drum surface by the line head 29, i.e. an occurrence of an exposure failure. The content of such an exposure failure is described below. Following the description of the exposure failure, this embodiment is described in detail as to how to suppress an occurrence of this exposure failure.

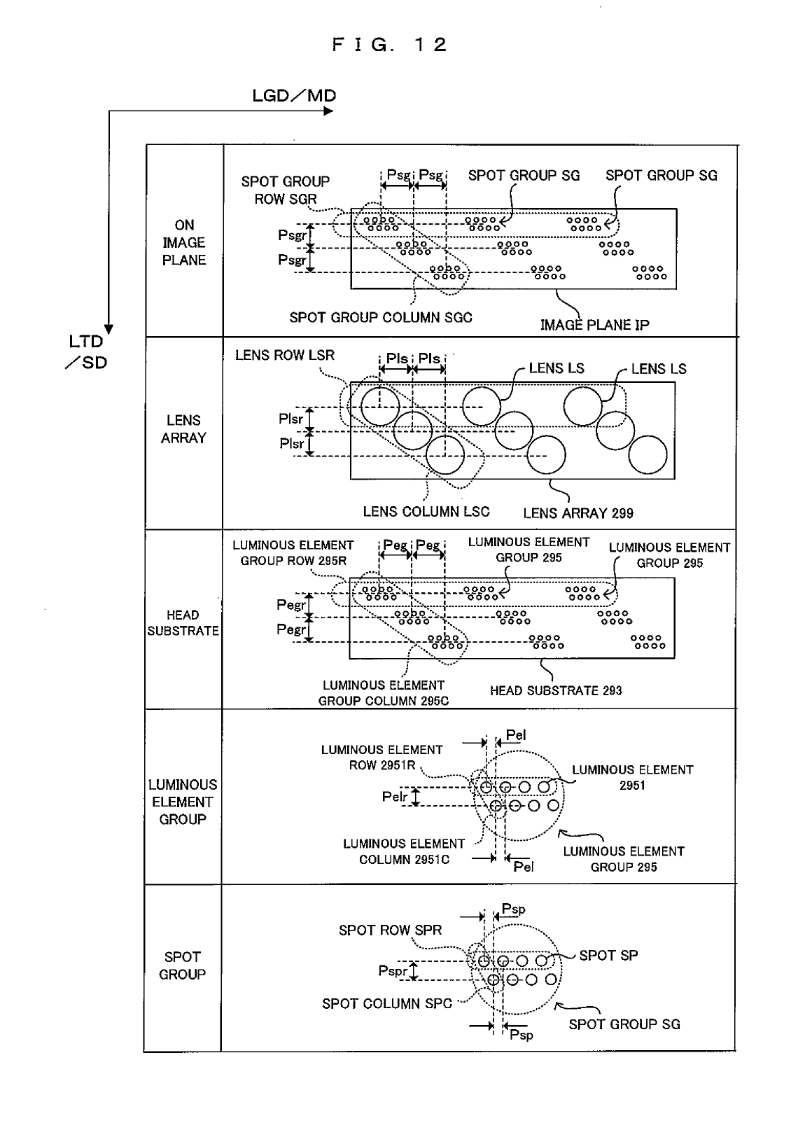

FIGS. 15 and 16 are sectional views along the sub scanning direction showing the relationship of arrangement of the line head and the photosensitive drum in the case where the arrangement of the line head is not proper. An upper side of FIG. 15 enlargedly shows a rectangular part enclosed by broken line in a lower side of FIG. 15. With reference to FIGS. 15 and 16, the cause of the exposure failure is described.

First of all, the construction of the line head 29 is described. In the line head 29, three lens rows LSR1 to LSR3 are arranged at mutually different arrangement positions AP1 to AP3 in the width direction LTD. More specifically, the three lens rows LSR1 to LSR3 are arranged at lens row pitches Plsr in the width direction LTD and substantially symmetrical with respect to a symmetry axis SA in the width direction LTD. The symmetry axis SA is substantially normal to the width direction LTD. A plurality of lenses LS of the lens array 299 have the same lens configuration and lens position. Accordingly, apices VTs1 to VTs3 of second surfaces LSFs1 to LSFs3 (that is, lens surfaces LSFs1 to LSFs3 facing toward the photosensitive drum) of the lenses LS1 to LS3 are located substantially in the same plane SPL_vts. The lenses LS are arranged such that optical axes OA1 to OA3 are parallel to each other. In FIG. 16, the optical axis OA of the lens LS2 coincides with the symmetry axis SA.

The lens rows LSR1 to LSR3 are all arranged to face the surface of the photosensitive drum 21. At this time, the respective lens rows LSR1 to LSR3 face facing positions FCP1 to FCP3 of the photosensitive drum surface (latent image carrier surface) mutually different in the sub scanning direction SD. Accordingly, the lens LS1 belonging to the lens row LSR1 focuses a light beam LB1 emitted from a light emitting element group 295, which the lens LS1 is facing, toward the facing position FCP1. As a result, the light beam LB1 is focused on a focus position FP1. The lens LS2 belonging to the lens row LSR2 focuses a light beam LB2 emitted from a light emitting element group 295, which the lens LS2 is facing, toward the facing position FCP2. As a result, the light beam LB2 is focused on a focus position FP2. The lens LS3 belonging to the lens row LSR3 focuses a light beam LB3 emitted from a light emitting element group 295, which the lens LS3 is facing, toward the facing position FCP3. As a result, the light beam LB3 is focused on a focus position FP3.

In this way, the focus positions FP of the light beams focused by the lenses LS belonging to the different lens rows LSR mutually differ in the sub scanning direction SD. Here, the focus position FP is the position and its vicinity where the light beam LB having passed through the lens LS forms an image with a minimum spot diameter. As described above, the lenses LS1 to LS3 have the same lens configuration and lens position. Therefore, the focus positions FP1 to FP3 are located in the same plane SPL_fp.

The surface of the photosensitive drum 21 facing the lens array 299 has a curvature in the section along the sub scanning direction and is a convex surface toward the lens array 299. Accordingly, the image-plane facing distances ld1 to ld3 between the lenses LS and the photosensitive drum surface differ among the three lens rows LSR1 to LSR3. Since the relationship of arrangement of the line head 29 and the photosensitive drum 21 is not proper in FIGS. 15 and 16, a difference Ald_max of the image-plane facing distance ld can be known to be large. Here, the difference Δld_max is a difference between the maximum value and the minimum value of the image-plane facing distances ld of the respective lenses LS.

More specifically, in FIGS. 15 and 16, the line head 29 is arranged relative to the photosensitive drum 21 such that the image-plane facing distance ld1 is shorter than the other image-plane facing distances ld2, ld3 out of the image-plane facing distances ld1 to ld3 of the lenses LS1 to LS3. In other words, the line head 29 is so arranged as to minimize the image-plane facing distance ld1 of the lens LS1 belonging to the end lens row LSR1. Here, the end lens rows are the lens rows LSR1, LSR3 located at ends in the width direction LTD out of the three lens rows LSR1 to LSR3.

In the case of arranging the line head 29 relative to the photosensitive drum surface in this way, the difference Δld_max among the image-plane facing distances ld1 to ld3 increases. Specifically, in the case of arranging the line head 29 to minimize the image-plane facing distance ld1 of the lens LS1 belonging to the end lens row LSR1, the image-plane facing distance ld monotonically increases in the width direction LTD (toward the lens rows LSR2, LSR3) from the end lens row LSR1 (monotonically increases in the order of the image-plane facing distances ld1 to ld3 in the example shown in FIGS. 15 and 16). In other words, a change of the image-plane facing distance ld in the width direction LTD is a monotonic increase. Accordingly, the difference between the image-plane facing distances ld1 and ld3 corresponding to the respective end lens rows LSR1, LSR3 increases, with the result that the difference Δld_max of the image-plane facing distance ld among the three lens rows LSR1 to LSR3 increases.

Such differences in the image-plane facing distance ld cause differences in the distances between the focus positions FP1 to FP3 of the light beams and the photosensitive drum surface (image-photosensitive member distances fd1 to fd3). Here, the image-photosensitive member distance fd is a distance between the focus position FP and the photosensitive drum surface in the direction of the optical axis OA of the lens LS corresponding to the focus position FP. Specifically, the image-photosensitive member distances fd1 to fd3 are distances between the focus positions FP1 to FP3 and the photosensitive drum surface in the directions of the optical axes OA of the lenses LS1 to LS3 corresponding to the respective focus positions FP1 to FP3. In other words, as shown in the upper side of FIG. 15, the image-photosensitive member distances fd1 to fd3 monotonically increase in the width direction LTD. As a result, a difference between the minimum value fd1 and the maximum value fd3 of the image-photosensitive member distances fd increases. If the differences in the image-photosensitive member distances fd increase, images formed on the photosensitive drum surface largely differ among the three lens rows LSR1 to LSR3, thereby leading to a possibility of a problem of being unable to perform a satisfactory exposure, that is, an occurrence of an exposure failure.

Next, the above-described exposure failure is described using a more specific comparative example 1 in order to facilitate the understanding of the invention. In other words, the specific content of the exposure failure is described through a simulation result on the relationship of arrangement of the photosensitive drum 21 and the line head 29 as shown in FIGS. 15 and 16.

### Comparative Example 1

In a simulation in the comparative example 1, the relationship of arrangement of the photosensitive drum 21 and the line head is as shown in FIGS. 15 and 16. Specifically, the line head 29 is arranged such that, out of the image-plane facing distances ld1 to ld3 of the respective lenses LS1 to LS3, the image-plane facing distance ld1 (that is, the image-plane facing distance ld1 of the lens LS1 belonging to the end lens row LSR1) is shorter than the other image-plane facing distances ld2, ld3. In this simulation, the lens row pitch Plsr and the light emitting element group row pitch Pegr were both set to 1.65 mm. The simulation was conducted in the respective cases where the diameter of the photosensitive drum 21 was 25 mm, 40 mm and 80 mm.

FIG. 17 shows the lens data of the lens LS used in the simulation of the comparative example 1. Surface numbers S1 to S6 are described with reference to FIGS. 9 and 10. The surface number S1 corresponds to an object surface, that is, the under surface of the head substrate 293 where the light emitting elements 2951 are arranged. The surface number S2 corresponds to the top surface of the head substrate 293. The surface number S3 corresponds to a plane where the aperture diaphragm DIA is arranged (aperture plane). As described above, the aperture diaphragm DIA is arranged at the front focus of the lens LS to realize an image side telecentric system. The surface number S4 corresponds to the first surface LSFf of the lens LS. The surface number S5 corresponds to the second surface LSFs of the lens LS. The surface number S6 corresponds to the image plane IP, that is, the surface of the photosensitive drum (latent image carrier). Here, the sum of the surface intervals from the surface number S1 to the surface number S3 gives the lens position and the surface interval of the surface number S4 gives the lens thickness. A plurality of lens data are suitably shown below, and surfaces corresponding to the surface numbers are the same in any of those lens data.

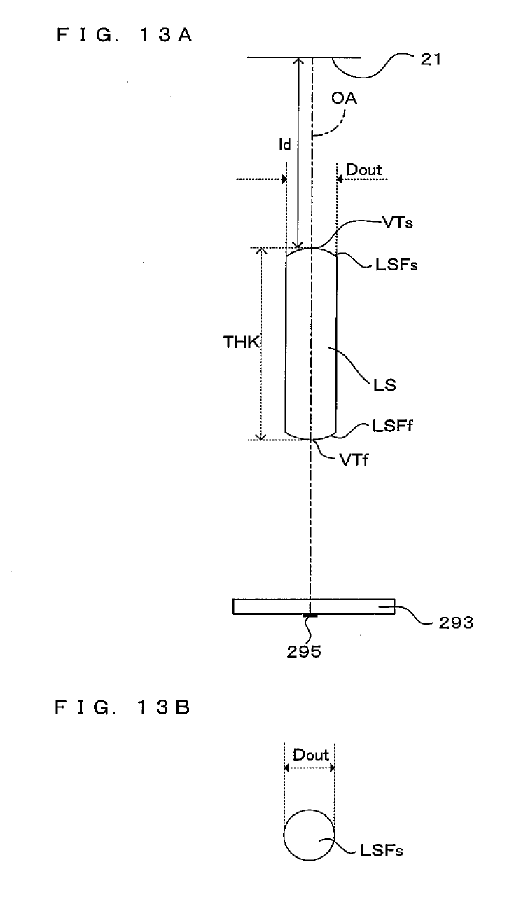

FIG. 18 shows aspherical surface coefficients of the aspherical surfaces S4, S5. Equation (1) gives a shape of the aspherical surface. In other words, the shapes of the aspherical surfaces S4, S5 (that is, the lens shape of the lens LS) are determined by FIG. 18 and the equation (1).

Z=(CURV)h²/[1+{1−(1+K)(CURV)²h²}^{1/2}]+(A)h⁴ (1)

where Z represents a sagitta of a plane parallel to axis z, CURV represents a curvature at the apex of the surface, K represents a conic coefficient, A represents a deforming coefficient of fourth order. And, h²=x²+y², where x represents a coordinate of x axis (main scanning direction) and y represents a coordinate of y axis (sub scanning direction).

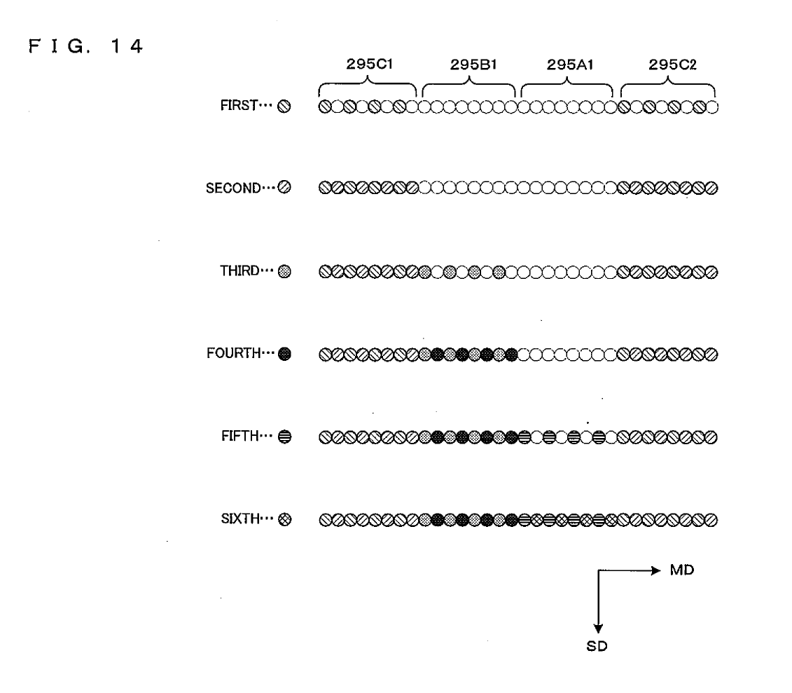

FIG. 19 shows the specification of an optical system used in the simulation of the comparative example 1. Here, wavelength is that of light beams emitted from the light emitting elements. The lens diameter is the diameter of an emergence surface, that is, the second surface LSFs of the lens LS. A light source diameter is the diameter of the light emitting elements 2951. An object height of 0.6 mm in this specification means that the simulation was conducted on the condition that the light beam is emitted from a virtual light emitting element located at an object height of 0.6 mm. At this time, an image height is −0.3 mm since magnification is −0.5.

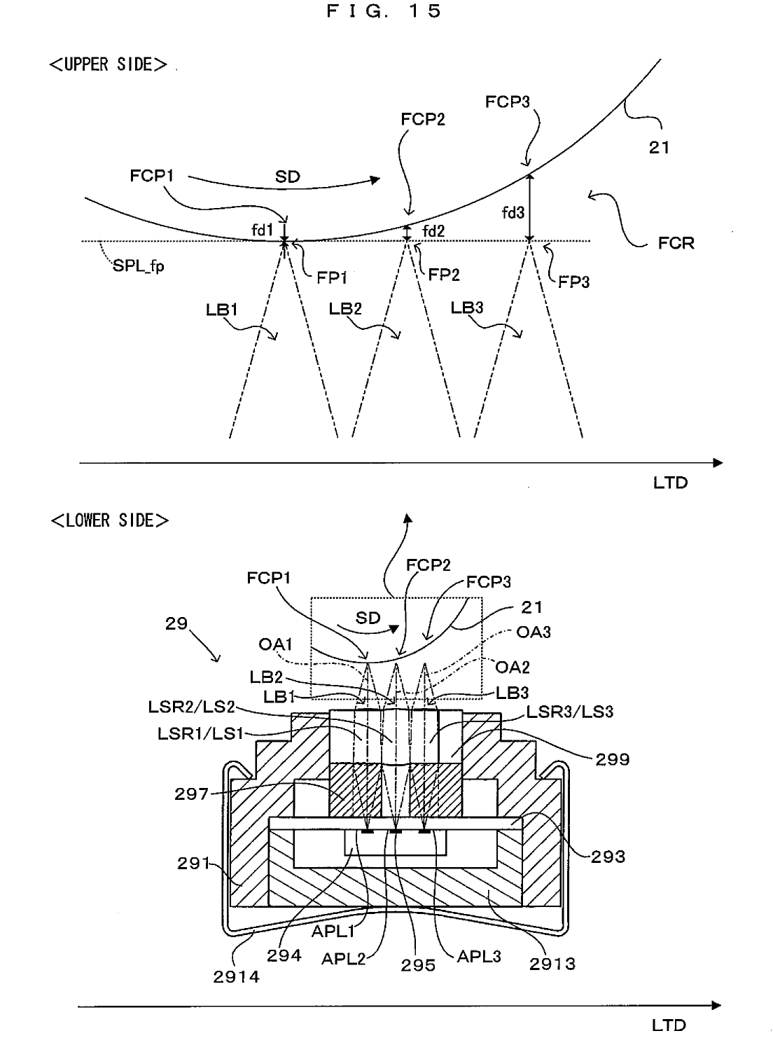

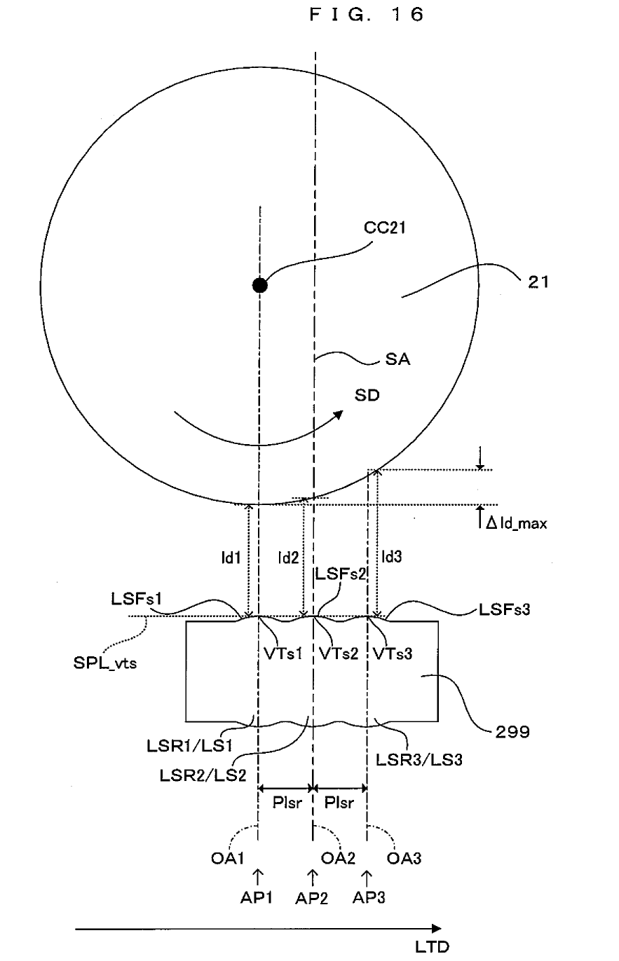

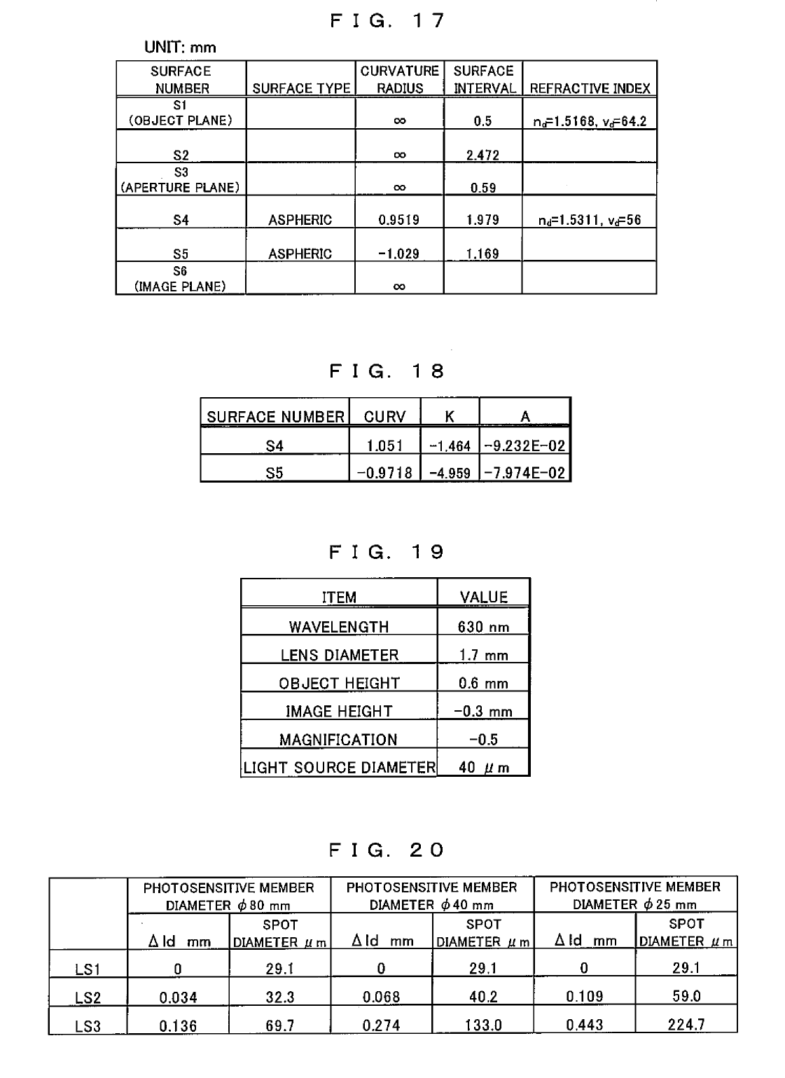

FIG. 20 shows the result of the simulation conducted on the above conditions. Values Δld shown in FIG. 20 are values obtained by subtracting the minimum image-plane facing distance ld1 from the respective image-plane facing distances ld1 to ld3 corresponding to the lenses LS1 to LS3. Accordingly, the maximum value of the values Δld is the difference Δld_max among the above-described image-plane facing distances ld1 to ld3. The simulation result is described below for the respective cases where the diameter of the photosensitive drum 21 is 25 mm, 40 mm and 80 mm.

First of all, the case where the photosensitive drum diameter is 25 mm is described. As shown in a column “photosensitive member diameter φ 25 mm” of FIG. 20, the difference Δld_max among the image-plane facing distances ld1 to ld3 is 0.443 mm in the case where the diameter of the photosensitive drum 21 is 25 mm. Such a large difference Δld_max in the image-plane facing distances results from the line head 29 arranged at the improper position as described above. As shown by spot diameters in the same column, the diameters of the spots formed on the surface of the photosensitive drum 21 differ among the lenses LS1 to LS3 due to the differences among the image-plane facing distances ld1 to ld3. Specifically, the minimum value of the diameters of the spots formed by the lens LS1 is 29.1 μm, whereas the maximum value of the diameters of the spots formed by the lens LS3 is 224.7 μm. In other words, in this comparative example, the maximum difference in the spot diameters is 195.6 μm (=224.7 μm-29.1 μm). As described above, in the comparative example 1, an exposure failure that the diameters of the spots to be formed differ up to 195.6 μm among the lens rows LSR1 to LSR3 occurs in the case where the diameter of the photosensitive drum 21 is 25 mm.

Next, the case where the photosensitive drum diameter is 40 mm is described. As shown in a column “photosensitive member diameter φ 40 mm” of FIG. 20, the difference Δld_max among the image-plane facing distances ld1 to ld3 is 0.274 mm in the case where the diameter of the photosensitive drum 21 is 40 mm. Such a large difference Δld_max in the image-plane facing distances results from the line head 29 arranged at the improper position as described above. As shown by spot diameters in the same column, the diameters of the spots formed on the surface of the photosensitive drum 21 differ among the lenses LS1 to LS3 due to the differences among the image-plane facing distances ld1 to ld3. Specifically, the minimum value of the diameters of the spots formed by the lens LS1 is 29.1 μm, whereas the maximum value of the diameters of the spots formed by the lens LS3 is 133.0 μm. In other words, in this comparative example, the maximum difference in the spot diameters is 103.9 μm (=133.0 μm-29.1 μm). As described above, in the comparative example 1, an exposure failure that the diameters of the spots to be formed differ up to 103.9 μm among the lens rows LSR1 to LSR3 occurs in the case where the diameter of the photosensitive drum 21 is 40 mm.

Finally, the case where the photosensitive drum diameter is 80 mm is described. As shown in a column “photosensitive member diameter φ 80 mm” of FIG. 20, the difference Δld_max among the image-plane facing distances ld1 to ld3 is 0.136 mm in the case where the diameter of the photosensitive drum 21 is 80 mm. Such a large difference Δld_max in the image-plane facing distances results from the line head 29 arranged at the improper position as described above. As shown by spot diameters in the same column, the diameters of the spots formed on the surface of the photosensitive drum 21 differ among the lenses LS1 to LS3 due to the differences among the image-plane facing distances ld1 to ld3. Specifically, the minimum value of the diameters of the spots formed by the lens LS1 is 29.1 μm, whereas the maximum value of the diameters of the spots formed by the lens LS3 is 69.7 μm. In other words, in this comparative example, the maximum difference in the spot diameters is 40.6 μm (=69.7 μm-29.1 μm). As described above, in the comparative example 1, an exposure failure that the diameters of the spots to be formed differ up to 40.6 μm among the lens rows LSR1 to LSR3 occurs in the case where the diameter of the photosensitive drum 21 is 80 mm.

As described using the comparative example 1, the image-plane facing distances ld1 to ld3 differ because the arranged position of the line head 29 is improper, with the result that the exposure failure of causing differences in the spot diameters of the spots formed on the surface of the photosensitive drum 21 is induced. The embodiment of the invention for suppressing an occurrence of such an exposure failure is described by way of the following working example 1.

### Working Example 1

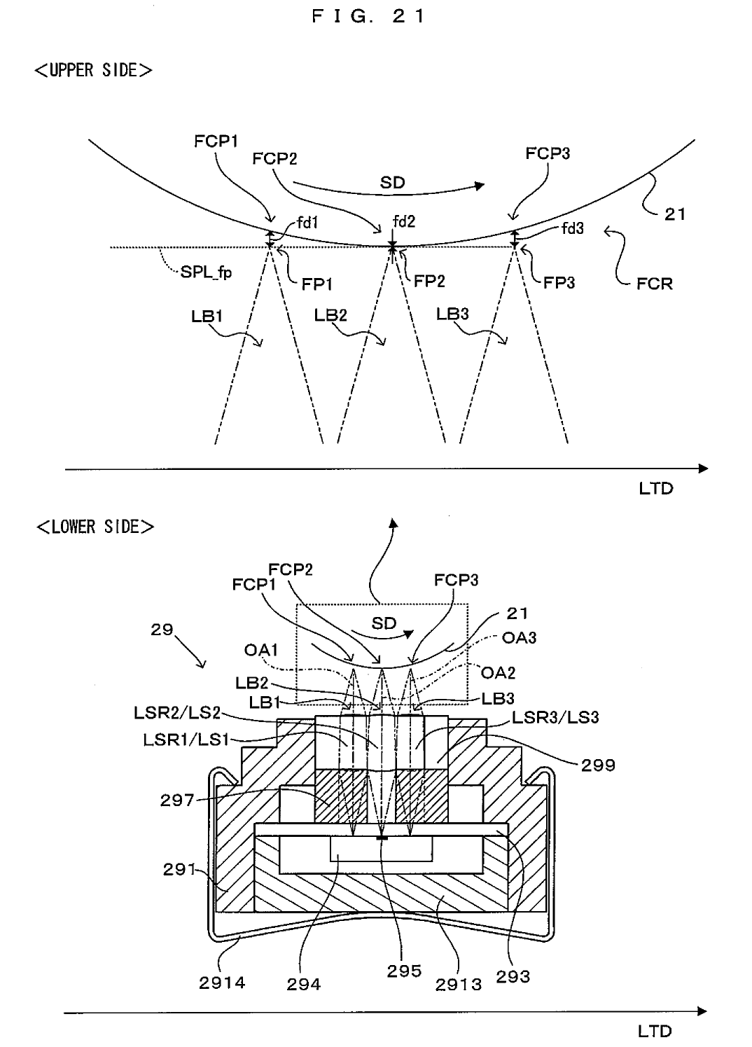

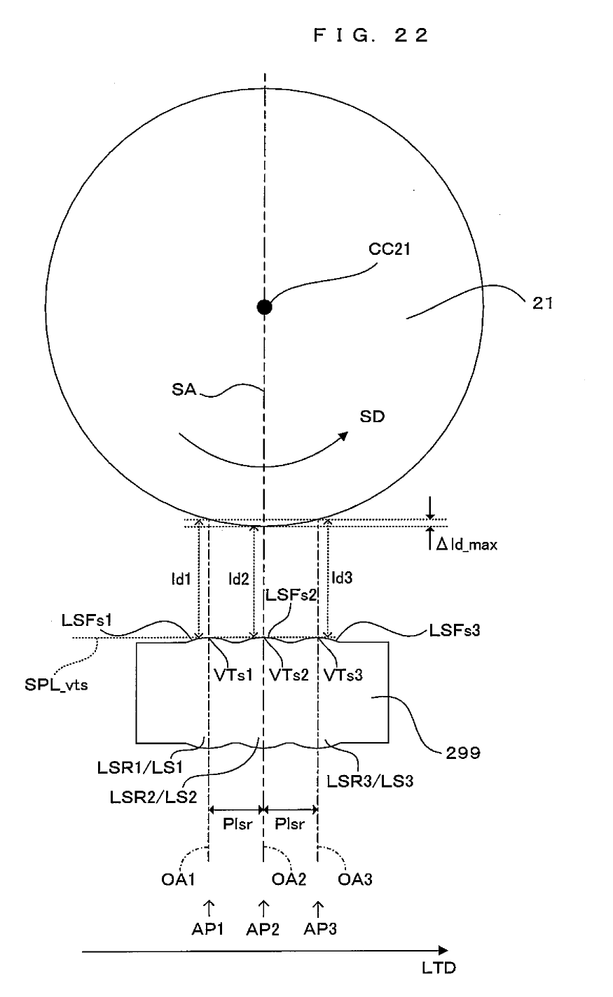

FIGS. 21 and 22 are sectional views along the sub scanning direction showing the relationship of arrangement of the line head and the photosensitive drum in the working example 1. An upper side of FIG. 21 enlargedly shows a rectangular part enclosed by broken line in a lower side of FIG. 21. In other words, both FIGS. 21 and 22 show a case where the relationship of arrangement of the line head and the photosensitive drum is seen in the longitudinal direction LGD.

In the line head 29, three lens rows LSR1 to LSR3 are arranged at mutually different arrangement positions AP1 to AP3 in the width direction LTD. More specifically, the three lens rows LSR1 to LSR3 are arranged at lens row pitches Plsr in the width direction LTD and substantially symmetrically arranged with respect to a symmetry axis SA in the width direction LTD. The symmetry axis SA is substantially normal to the width direction LTD. A plurality of lenses LS of the lens array 299 have the same lens configuration and lens position. Accordingly, apices VTs1 to VTs3 of second surfaces LSFs1 to LSFs3 (that is, lens surfaces LSFs1 to LSFs3 facing toward the photosensitive drum) of the lenses LS1 to LS3 are located substantially in the same plane SPL_vts. The lenses LS1 to LS3 are arranged such that optical axes OA1 to OA3 thereof are parallel to each other. In the working example 1, the optical axis OA2 of the lens LS2 coincides with the symmetry axis SA. The lens array 299 is arranged such that the symmetry axis SA passes a curvature center CC21 of the shape of the surface of the photosensitive drum 21. Therefore, the symmetry axis SA passes the rotation axis of the photosensitive drum 21.

The lens rows LSR1 to LSR3 are all arranged to face the surface of the photosensitive drum 21. At this time, the respective lens rows LSR1 to LSR3 face facing positions FCP1 to FCP3 of the photosensitive drum surface (latent image carrier surface) mutually different in the sub scanning direction SD. Accordingly, the lens LS1 belonging to the lens row LSR1 focuses a light beam LB1 emitted from a light emitting element group 295, which the lens LS1 is facing, toward the facing position FCP1. As a result, the light beam LB1 is focused on a focus position FP1. The lens LS2 belonging to the lens row LSR2 focuses a light beam LB2 emitted from a light emitting element group 295, which the lens LS2 is facing, toward the facing position FCP2. As a result, the light beam LB2 is focused on a focus position FP2. The lens LS3 belonging to the lens row LSR3 focuses a light beam LB3 emitted from a light emitting element group 295, which the lens LS3 is facing, toward the facing position FCP3. As a result, the light beam LB3 is focused on a focus position FP3.

In this way, the focus positions FP of the light beams focused by the lenses LS belonging to the different lens rows LSR mutually differ in the sub scanning direction SD. As described above, the lenses LS1 to LS3 have the same lens configuration and lens position. Therefore, the focus positions FP1 to FP3 are located in the same plane SPL_fp. The surface of the photosensitive drum 21 facing the lens array 299 is a convex surface having a curvature in the section along the sub scanning direction and projecting toward the lens array 299. Accordingly, if the relationship of arrangement of the line head 29 and the photosensitive drum surface is improper, there have been cases where the image-plane facing distances ld1 to ld3 largely differ to cause the above-described exposure failure.

In order to cope with such a problem, the line head 29 is arranged as follows in the working example 1 of this embodiment. Specifically, the line head 29 is arranged relative to the photosensitive drum surface such that the image-plane facing distance ld2 of the lens LS2 belonging to the lens row LSR2 other than the end lens rows LSR1, LSR3 located at the ends with respect to the width direction LTD out of the three lens rows is shorter than the image-plane facing distances ld1, ld3 of the lenses LS1, LS3 belonging to the end lens rows LSR1, LSR3. In other words, the line head 29 is so arranged as to satisfy the following relationships, that is, ld2<ld1 and ld2<ld3.

Therefore, the difference Δld_max in the image-plane facing distances ld among the three lens rows LSR1 to LSR3 can be suppressed, with the result that a satisfactory exposure can be realized by suppressing an occurrence of the above exposure failure.

Specifically, in the case of arranging the line head 29 as above, an occurrence of such a situation that the image-plane facing distance ld monotonically increases along the width direction LTD from the end lens row LSR1 as shown in the comparative example 1 can be suppressed. More specifically, in FIGS. 21 and 22, the image-plane facing distance ld of the lens LS1 belonging to the end lens row LSR1 is the distance ld1. The image-plane facing distance ld decreases along the width direction LTD from the end lens row LSR1, and the image-plane facing distance ld of the lens LS2 belonging to the lens row LSR2 becomes the distance ld2. The image-plane facing distance ld increases along the width direction LTD, and the image-plane facing distance ld of the lens LS3 belonging to the end lens row LSR3 becomes the distance ld3. At this time, the difference Δld_max in the image-plane facing distances ld is a difference between the image-plane facing distance ld1 (or image-plane facing distance ld3) corresponding to the end lens row LSR1 (or the end lens row LSR3) and the image-plane facing distance ld2 corresponding to the lens row LSR2. As shown in FIGS. 21 and 22, the difference Δld_max in the image-plane facing distances ld is smaller in the working example 1 than in the comparative example 1.

Thus, in the case of arranging the line head 29 as shown in FIGS. 21 and 22, the image-plane facing distance ld along the width direction LTD first decreases and then increases. Accordingly, as compared to the case where the change of the image-plane facing distance ld along the width direction LTD is a monotonic increase, the difference Δld_max in the image-plane facing distances id can be suppressed. As a result, a satisfactory exposure can be realized by suppressing an occurrence of the above exposure failure.

Particularly, in this embodiment, the lens rows LSR1 to LSR3 are arranged at the lens row pitches Plsr in the width direction LTD and are substantially symmetrically arranged in the width direction LTD with respect to the symmetry axis SA substantially normal to the width direction LTD in the section along the sub scanning direction. Further, the line head 29 is arranged such that the image-plane facing distance ld2 of the lens LS2 corresponding to the lens row LSR2 (middle lens row) closest to the symmetry axis SA is shorter than the image-plane facing distances ld1, ld3 of the lenses LS1, LS3 belonging to the lens rows LSR1, LSR3 other than the middle lens row LSR2. Therefore, the difference Δld_max in the image-plane facing distances ld can be more effectively suppressed.

Specifically, the difference Δld_max is a difference between the maximum value and the minimum value of the image-plane facing distances ld. Here, the maximum value of the image-plane facing distances ld is the image-plane facing distance ld of the lens LS belonging to either one of the end lens rows LSR1, LSR3 located at the opposite ends in the width direction LTD. In other words, the maximum value of the image-plane facing distances ld is the larger one of the image-plane facing distances ld1 and ld3. Accordingly, in order to suppress the difference Δld_max, it is preferable to shorten both of the image-plane facing distances ld1, ld3 of the lenses LS belonging to the end lens rows LSR1, LSR3 as much as possible. On the other hand, the image-plane facing distances Ld1, ld3 corresponding to the respective end lens rows LSR1, LSR3 have such a relationship that, if one becomes shorter, the other becomes longer. In other words, even if an attempt is made to shorten both of the image-plane facing distances ld1, ld3, for example, by adjusting the position of the line head 29 in the width direction LTD (that is, by moving the line head 29 in the width direction LTD), when one becomes shorter, the other becomes longer. Under such a relationship, these image-plane facing distances ld1, ld3 are preferably substantially equal upon suppressing the difference Δld_max.

Accordingly, in the image forming apparatus of this embodiment, the lens rows LSR1 to LSR3 are substantially symmetrically arranged in the width direction LTD with respect to the symmetry axis SA and the line head 29 is arranged such that the image-plane facing distance ld2 of the lens LS2 corresponding to the lens row LSR2 (middle lens row) closest to the symmetry axis SA is shorter than the image-plane facing distances ld1, ld3 of the lenses LS1, LS3 belonging to the lens rows LSR1, LSR3 other than the middle lens row LSR2. This is because the image-plane facing distances ld1, ld3 corresponding to the end lens rows LSR1, LSR3 can be made substantially equal by the above construction. As a result, in the image forming apparatus of this embodiment, a satisfactory exposure can be realized by suppressing the difference Δld_max in the image-plane facing distances ld.

Upon arranging the line head 29 relative to a latent image carrier whose surface shape has a curvature center CC21 like the photosensitive drum 21, the line head is preferably arranged as follows. Specifically, in the working example 1, the line head 29 is arranged such that the symmetry axis SA passes the curvature center CC21 (that is, rotation axis of the photosensitive drum 21) of the surface shape of the photosensitive drum 21. Accordingly, the image-plane facing distances ld1, ld3 corresponding to the end lens rows LSR1, LSR3 become equal to each other. As a result, a better exposure can be advantageously realized by more effectively suppressing the difference Δld_max in the image-plane facing distances ld. In order to facilitate the understanding of the invention, the result of a simulation conducted on the condition that the line head 29 is arranged as shown in FIGS. 21 and 22 is described below.

In the simulation of the working example 1, the lens rows LSR1 to LSR3 are arranged at specified lens row pitches Plsr in the width direction LTD. The line head 29 is arranged such that the image-plane facing distance ld2 corresponding to the middle lens row LSR2 is shorter than the image-plane facing distances ld1, ld3 corresponding to the other lens rows LSR1, LSR3. The symmetry axis SA of the lens rows LSR1 to LSR3 passes the curvature center CC21 of the surface shape of the photosensitive drum. Further, in this simulation, the lens row pitch Plsr and the light emitting element group row pitch Pegr were both set to 1.65 mm. The simulation was conducted in the respective cases where the diameter of the photosensitive drum 21 was 25 mm, 40 mm and 80 mm. It should be noted that the conditions on the lens configurations and the lens positions of the lenses LS are the same in the working example 1 and the comparative example 1. In other words, the lens data, the aspherical surface coefficients and the specification of the optical system are the same in the working example 1 and the comparative example 1.

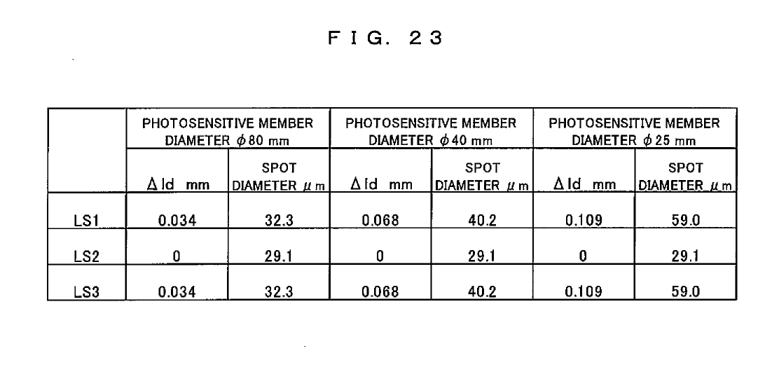

FIG. 23 shows the result of the simulation in the working example 1 conducted on the above conditions. The simulation result is described below for the respective cases where the diameter of the photosensitive drum 21 is 25 mm, 40 mm and 80 mm.

First of all, the case where the photosensitive drum diameter is 25 mm is described. As shown in a column “photosensitive member diameter φ 25 mm” of FIG. 23, the difference Δld_max among the image-plane facing distances ld1 to ld3 is 0.109 mm in the case where the diameter of the photosensitive drum 21 is 25 mm. An improvement as compared to 0.443 mm in the comparative example 1 can be understood. As shown by spot diameters in the same column, the minimum value of the diameters of the spots formed by the lenses LS1 to LS3 is 29.1 μm (diameter of the spots formed by the lens LS2), whereas the maximum value thereof is 59.0 Mm (diameters of the spots formed by the lenses LS1, LS3). In other words, in the working example 1, the maximum difference in the spot diameters is 29.9 μm (=59.0 μm-29.1 μm) and is remarkably improved as compared to the difference of 165.7 μm in the spot diameters in the comparative example 1.

Next, the case where the photosensitive drum diameter is 40 mm is described. As shown in a column “photosensitive member diameter φ 40 mm” of FIG. 23, the difference Δld_max among the image-plane facing distances ld1 to ld3 is 0.068 mm in the case where the diameter of the photosensitive drum 21 is 40 mm. An improvement as compared to 0.274 mm in the comparative example 1 can be understood. As shown by spot diameters in the same column, the minimum value of the diameters of the spots formed by the lenses LS1 to LS3 is 29.1 μm (diameter of the spots formed by the lens LS2), whereas the maximum value thereof is 40.2 μm (diameters of the spots formed by the lenses LS1, LS3). In other words, in the working example 1, the maximum difference in the spot diameters is 11.1 μm (=40.2 μm-29.1 μm) and is remarkably improved as compared to the difference of 103.9 μm in the spot diameters in the comparative example 1.

Next, the case where the photosensitive drum diameter is 80 mm is described. As shown in a column “photosensitive member diameter φ 80 mm” of FIG. 23, the difference Δld_max among the image-plane facing distances ld1 to ld3 is 0.034 mm in the case where the diameter of the photosensitive drum 21 is 80 mm. An improvement as compared to 0.136 mm in the comparative example 1 can be understood. As shown by spot diameters in the same column, the minimum value of the diameters of the spots formed by the lenses LS1 to LS3 is 29.1 μm (diameter of the spots formed by the lens LS2), whereas the maximum value thereof is 32.3 μm (diameters of the spots formed by the lenses LS1, LS3). In other words, in the working example 1, the maximum difference in the spot diameters is 3.2 μm (=32.3 μm-29.1 μm) and is remarkably improved as compared to the difference of 40.6 μm in the spot diameters in the comparative example 1.

In this way, the difference Δld_max among the image-plane facing distances ld1 to ld3 is suppressed in the working example 1 by arranging the line head 29 as shown in FIGS. 21 and 22. By suppressing the difference Δld_max in the image-plane facing distances in this way, differences in the diameters of the spots formed on the surface of the photosensitive drum 21 are suppressed as compared to the comparative example 1. In other words, a better exposure is realized in the working example 1 than in the comparative example 1.

In the above comparative example 1 and working example 1, the invention is described using the line head 29 in which the three lens rows LSR are arranged in the width direction LTD. However, the number of the lens rows is not limited to this and may be four or more. Accordingly, a case using a line head 29 with four lens rows is described. In the following description, an occurrence of the above-described exposure failure in the case where there are four lens rows (comparative example 2) is described with reference to a simulation result. Following the description of such a comparative example 2, a specific example of the invention is described (working example 2) with reference to a simulation result.

### Comparative Example 2

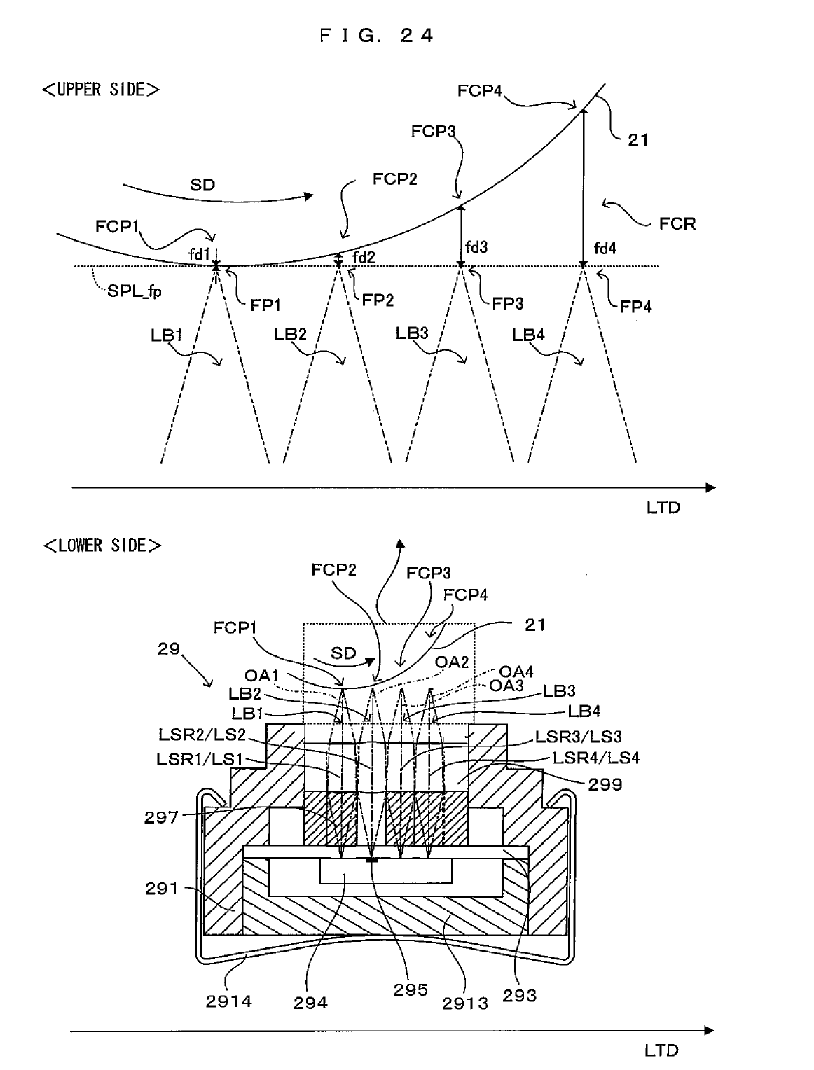

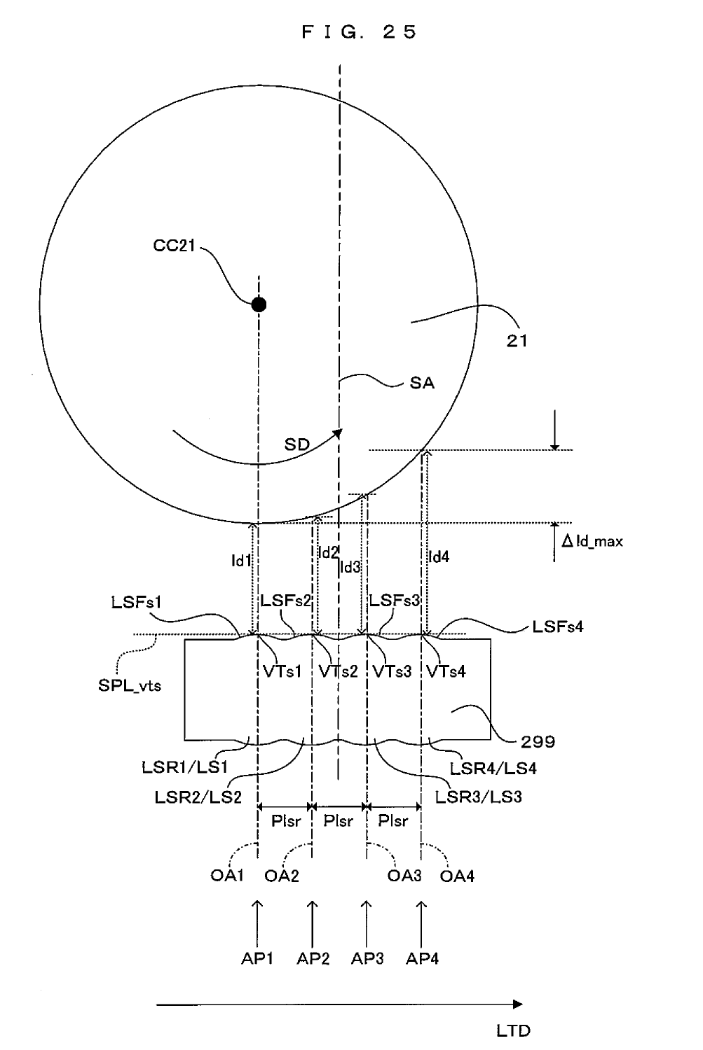

FIGS. 24 and 25 are sectional views along the sub scanning direction corresponding to the case where the line head is not properly arranged. An upper side of FIG. 24 enlargedly shows a rectangular part enclosed by broken line in a lower side of FIG. 24. With reference to FIGS. 24 and 25, the cause of the exposure failure is described.

In the line head 29, four lens rows LSR1 to LSR4 are arranged at mutually different arrangement positions AP1 to AP4 in the width direction LTD. More specifically, the four lens rows LSR1 to LSR4 are arranged at lens row pitches Plsr in the width direction LTD and substantially symmetrically arranged with respect to a symmetry axis SA in the width direction LTD. The symmetry axis SA is substantially normal to the width direction LTD. Apices VTs1 to VTs4 of second surfaces LSFs1 to LSFs4 (that is, lens surfaces LSFs1 to LSFs4 facing toward the photosensitive drum) of lenses LS1 to LS4 are located substantially in the same plane SPL_vts. Further, a plurality of lenses LS of the lens array 299 have the same lens configuration and lens position. The lens rows LSR1 to LSR4 are arranged such that optical axes OA1 to OA4 of the lenses LS1 to LS4 belonging thereto are parallel to each other.

The line head 29 is arranged relative to the photosensitive drum 21 as follows. Specifically, the line head 29 is arranged such that an image-plane facing distance ld1 is shorter than other image-plane facing distances ld2 to ld4 out of the image-plane facing distances ld1 to ld4 of the respective lenses LS1 to LS4. In other words, the line head 29 is so arranged as to minimize the image-plane facing distance ld1 of the lens LS1 belonging to the end lens row LSR1. Here, the end lens rows are the lens rows LSR1, LSR4 located at ends in the width direction LTD out of the four lens rows LSR1 to LSR4. It should be noted that the symmetry axis SA does not pass the curvature center CC21 of the surface shape of the photosensitive drum.

In the case of arranging the line head 29 to minimize the image-plane facing distance ld1 of the lens LS1 belonging to the end lens row LSR1 in this way, the image-plane facing distance ld monotonically increases along the width direction LTD (toward the lens rows LSR2 to the LSR4) from the end lens row LSR1. Accordingly, a difference between the image-plane facing distances ld1 and ld4 corresponding to the respective end lens rows LSR1, LSR4 increases. Thus, a difference Ald_max in the image-plane facing distances id among the four lens rows LSR1 to LSR4 increases. Such differences in the image-plane facing distances ld cause differences in image-photosensitive member distances fd1 to fd4. In other words, as shown in the upper side of FIG. 24, the difference between the minimum value fd1 and the maximum value fd4 of the image-photosensitive member distances increases. If differences in such image-photosensitive member distances fd increase, images formed on the photosensitive drum surface largely differ among the four lens rows LSR1 to LSR4, thereby leading to a possibility of a problem of being unable to perform a satisfactory exposure, that is, an occurrence of an exposure failure. In order to facilitate the understanding of the invention, the above-described exposure failure is described by way of a more specific simulation result. In other words, the specific content of the exposure failure is described through the simulation result on the relationship of arrangement of the photosensitive drum 21 and the line head 29 as shown in FIGS. 24 and 25.

In the simulation in the comparative example 2, the relationship of arrangement of the photosensitive drum 21 and the line head is as shown in FIGS. 24 and 25. Specifically, the line head 29 is arranged such that, out of the image-plane facing distances ld1 to ld4 of the respective lenses LS1 to LS4, the image-plane facing distance ld1 (that is, the image-plane facing distance ld1 of the lens LS1 belonging to the end lens row LSR1) is shorter than the other image-plane facing distances ld2 to ld4. In this simulation, the lens row pitch Plsr and the light emitting element group row pitch Pegr were both set to 1.65 mm. The simulation was conducted in the respective cases where the diameter of the photosensitive drum 21 was 25 mm, 40 mm and 80 mm. The lens data, the aspherical surface coefficients and the specification of an optical system in the simulation of the comparative example 2 are the same as in the comparative example 1. In other words, the simulation of the comparative example 2 was conducted based on the data of FIG. 17 to FIG. 19 and the equation (1).

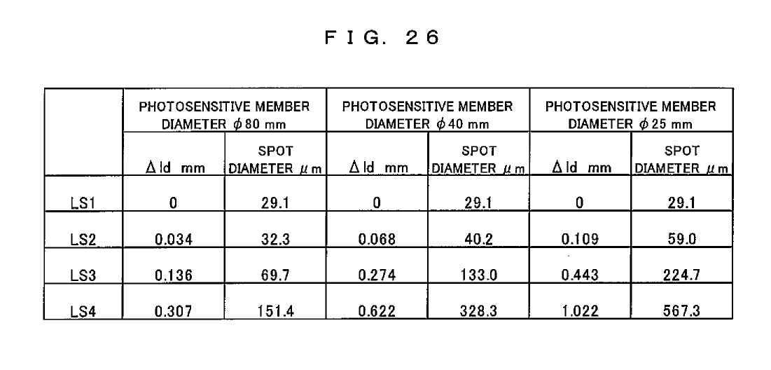

FIG. 26 shows the result of the simulation conducted on the above conditions. Values Δld shown in FIG. 26 are values obtained by subtracting the minimum image-plane facing distance ld1 from the respective image-plane facing distances ld1 to ld4 corresponding to the lenses LS1 to LS4. Accordingly, the maximum value of the values Δld is the difference Δld_max among the above-described image-plane facing distances ld1 to ld4. The simulation result is described below for the respective cases where the diameter of the photosensitive drum 21 is 25 mm, 40 mm and 80 mm.

First of all, the case where the photosensitive drum diameter is 25 mm is described. As shown in a column “photosensitive member diameter φ 25 mm” of FIG. 26, the difference Δld_max among the image-plane facing distances ld1 to ld4 is 1.022 mm in the case where the diameter of the photosensitive drum 21 is 25 mm. Such a large difference Δld_max in the image-plane facing distances results from the line head 29 arranged at the improper position as described above. As shown by spot diameters in the same column, the diameters of the spots formed on the surface of the photosensitive drum 21 differ among the lenses LS1 to LS4 due to the differences among the image-plane facing distances ld1 to ld4. Specifically, the minimum value of the diameters of the spots formed by the lens LS1 is 29.1 μm, whereas the maximum value of the diameters of the spots formed by the lens LS4 is 567.3 μm. In other words, in this comparative example, the maximum difference in the spot diameters is 538.2 μm (=567.3 μm-29.1 μm). As described above, in the comparative example 2, an exposure failure that the diameters of the spots to be formed differ up to 538.2 μm among the lens rows LSR1 to LSR4 occurs in the case where the diameter of the photosensitive drum 21 is 25 mm.

Next, the case where the photosensitive drum diameter is 40 mm is described. As shown in a column “photosensitive member diameter φ 40 mm” of FIG. 26, the difference Δld_max among the image-plane facing distances ld1 to ld4 is 0.622 mm in the case where the diameter of the photosensitive drum 21 is 40 mm. Such a large difference Δld_max in the image-plane facing distances results from the line head 29 arranged at the improper position as described above. As shown by spot diameters in the same column, the diameters of the spots formed on the surface of the photosensitive drum 21 differ among the lenses LS1 to LS4 due to the differences among the image-plane facing distances ld1 to ld4. Specifically, the minimum value of the diameters of the spots formed by the lens LS1 is 29.1 μm, whereas the maximum value of the diameters of the spots formed by the lens LS4 is 328.3 μm. In other words, in this comparative example, the maximum difference in the spot diameters is 299.2 μm (−328.3 μm-29.1 μm). As described above, in the comparative example 2, an exposure failure that the diameters of the spots to be formed differ up to 299.2 μm among the lens rows LSR1 to LSR4 occurs in the case where the diameter of the photosensitive drum 21 is 40 mm.

Finally, the case where the photosensitive drum diameter is 80 mm is described. As shown in a column “photosensitive member diameter φ 80 mm” of FIG. 26, the difference Δld_max among the image-plane facing distances ld1 to ld4 is 0.307 mm in the case where the diameter of the photosensitive drum 21 is 80 mm. Such a large difference Δld_max in the image-plane facing distances results from the line head 29 arranged at the improper position as described above. As shown by spot diameters in the same column, the diameters of the spots formed on the surface of the photosensitive drum 21 differ among the lenses LS1 to LS4 due to the differences among the image-plane facing distances ld1 to ld4. Specifically, the minimum value of the diameters of the spots formed by the lens LS1 is 29.1 μm, whereas the maximum value of the diameters of the spots formed by the lens LS4 is 151.4 μm. In other words, in this comparative example, the maximum difference in the spot diameters is 122.3 μm (=151.4 μm-29.1 μm). As described above, in the comparative example 2, an exposure failure that the diameters of the spots to be formed differ up to 122.3 μm among the lens rows LSR1 to LSR4 occurs in the case where the diameter of the photosensitive drum 21 is 80 mm.

As described using the comparative example 2, the image-plane facing distances ld1 to ld4 differ because the arranged position of the line head 29 is improper, with the result that the exposure failure of causing differences in the spot diameters of the spots formed on the surface of the photosensitive drum 21 is induced. However, an occurrence of such an exposure failure can be suppressed by properly arranging the line head 29 and the photosensitive drum 21 relative to each other. Accordingly, the suppression of the occurrence of the exposure failure in a working example 2 in the case where the relationship of arrangement of the photosensitive drum 21 and the line head 29 is proper is described with reference to the simulation result.

### Working Example 2

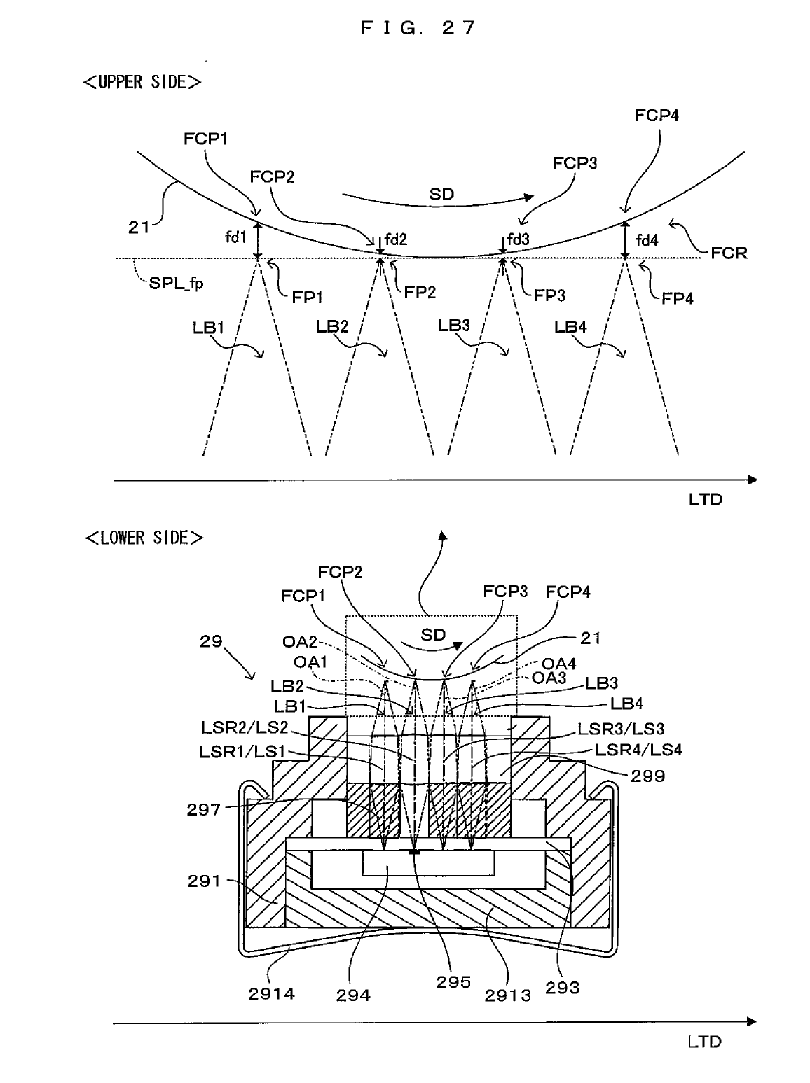

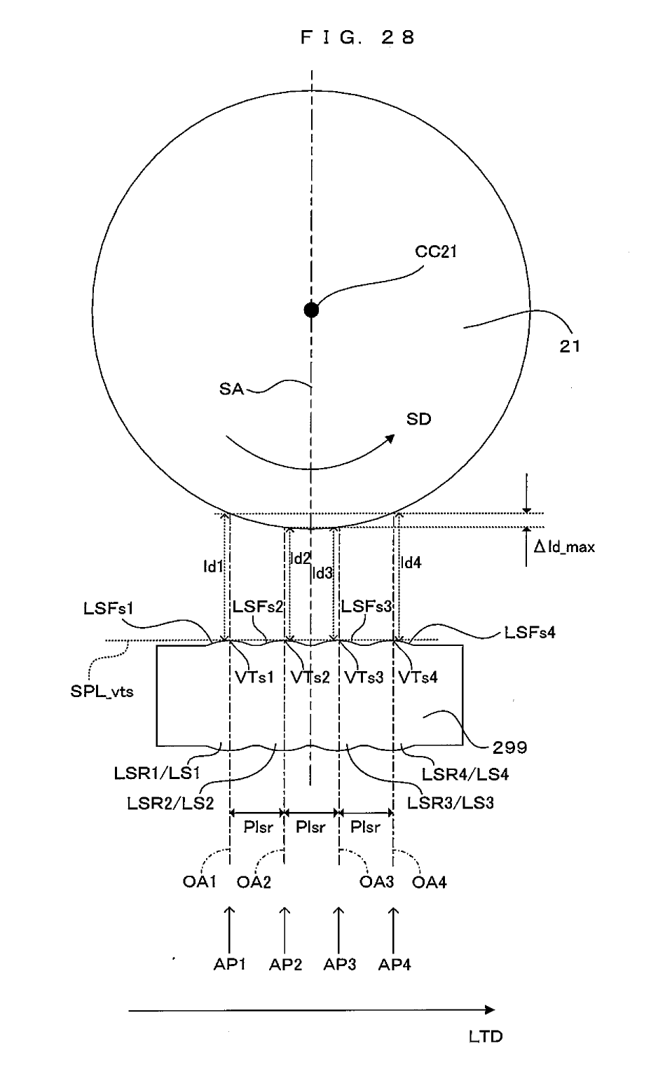

FIGS. 27 and 28 are sectional views along the sub scanning direction showing the relationship of arrangement of the line head and the photosensitive drum in the working example 2. An upper side of FIG. 27 enlargedly shows a rectangular part enclosed by broken line in a lower side of FIG. 27. In other words, both FIGS. 27 and 28 show a case where the relationship of arrangement of the line head and the photosensitive drum is seen in the longitudinal direction LGD.

In the line head 29, four lens rows LSR1 to LSR4 are arranged at mutually different arrangement positions AP1 to AP4 in the width direction LTD. More specifically, the four lens rows LSR1 to LSR4 are arranged at lens row pitches Plsr in the width direction LTD and substantially symmetrically arranged with respect to a symmetry axis SA in the width direction LTD. The symmetry axis SA is substantially normal to the width direction LTD. Apices VTs1 to VTs4 of second surfaces LSFs1 to LSFs4 (that is, lens surfaces LSFs1 to LSFs4 facing toward the photosensitive drum) of lenses LS1 to LS4 are located substantially in the same plane SPL_vts. Further, a plurality of lenses LS of the lens array 299 have the same lens configuration and lens position. The lens rows LSR1 to LSR4 are arranged such that optical axes OA1 to OA4 of the lenses LS1 to LS4 belonging thereto are parallel to each other. Further, the lens array 299 is arranged such that the symmetry axis SA passes the curvature center CC21 of the surface shape of the photosensitive drum 21. Therefore, the symmetry axis SA passes the rotation axis of the photosensitive drum 21.

The lens rows LSR1 to LSR4 are all arranged to face the surface of the photosensitive drum 21. At this time, the respective lens rows LSR1 to LSR4 face facing positions FCP1 to FCP4 of the photosensitive drum surface (latent image carrier surface) mutually different in the sub scanning direction SD. Accordingly, the lens LS1 belonging to the lens row LSR1 focuses a light beam LB1 emitted from a light emitting element group 295, which the lens LS1 is facing, toward the facing position FCP1. As a result, the light beam LB1 is focused on a focus position FP1. The lens LS2 belonging to the lens row LSR2 focuses a light beam LB2 emitted from a light emitting element group 295, which the lens LS2 is facing, toward the facing position FCP2. As a result, the light beam LB2 is focused on a focus position FP2. The lens LS3 belonging to the lens row LSR3 focuses a light beam LB3 emitted from a light emitting element group 295, which the lens LS3 is facing, toward the facing position FCP3. As a result, the light beam LB3 is focused on a focus position FP3. The lens LS4 belonging to the lens row LSR4 focuses a light beam LB4 emitted from a light emitting element group 295, which the lens LS4 is facing, toward the facing position FCP4. As a result, the light beam LB4 is focused on a focus position FP4.

In this way, the focus positions FP of the light beams focused by the lenses LS belonging to the different lens rows LSR mutually differ in the sub scanning direction SD. Here, the focus position PP is the position where the light beam LB having passed through the lens LS forms an image with a minimum spot diameter and its vicinity. As described above, the lenses LS1 to LS4 have the same lens configuration and lens position. Therefore, the focus positions FP1 to FP4 are located in the same plane SPL_fp.

The surface of the photosensitive drum 21 facing the lens array 299 is a convex surface having a curvature in the section along the sub scanning direction and projecting toward the lens array 299. Accordingly, the image-plane facing distances ld1 to ld4 between the lenses LS and the photosensitive drum surface differ among the four lens rows LSR1 to LSR4. Unless the relationship of arrangement of the line head 29 and the photosensitive drum surface is proper, there have been cases where an exposure failure as shown in the comparative example 2 occurs due to large differences in the image-plane facing distances ld1 to ld4.

In order to cope with such a problem, the line head 29 is arranged as follows in this working example. Specifically, the line head 29 is arranged relative to the photosensitive drum surface such that the image-plane facing distances ld2, ld3 of the lenses LS2, LS3 belonging to the lens rows LSR2, LSR3 other than the end lens rows LSR1, LSR4 located at the ends in the width direction LTD out of the four lens rows are shorter than the image-plane facing distances ld1, ld4 of the lenses LS1, LS4 belonging to the end lens rows LSR1, LSR4. In other words, the line head 29 is so arranged as to satisfy the following relationships:

ld2<ld1,

ld2<ld4,

ld3<ld1, and

ld3<ld4.

Therefore, the difference Δld_max in the image-plane facing distances ld among the four lens rows LSR1 to LSR4 can be suppressed, with the result that a satisfactory exposure can be realized by suppressing an occurrence of the above exposure failure.

Specifically, in the case of arranging the line head 29 as shown in FIGS. 27 and 28, an occurrence of such a situation that the image-plane facing distance ld monotonically increases along the width direction LTD from the end lens row LSR1 as shown in FIGS. 24 and 25 can be suppressed. More specifically, in FIGS. 27 and 28, the image-plane facing distance ld of the lens LS1 belonging to the end lens row LSR1 is the distance ld1. The image-plane facing distance ld decreases along the width direction LTD from the end lens row LSR1, and the image-plane facing distances ld of the lenses LS2, LS3 belonging to the lens rows LSU2, LSR3 become the distances ld2, ld3. The image-plane facing distance ld then increases along the width direction LTD, and the image-plane facing distance ld of the lens LS4 belonging to the end lens row LS43 becomes the distance ld4. At this time, the difference Δld_max in the image-plane facing distances ld is a difference between the image-plane facing distance ld1 (or image-plane facing distance ld4) corresponding to the end lens row LSR1 (or the end lens row LSR4) and the image-plane facing distance ld2 (or image-plane facing distance ld3) corresponding to the lens row LSR2 (or the end lens row LSR3). As a result, the difference Δld_max in the image-plane facing distances ld shown in FIGS. 27 and 28 is smaller than the one shown in FIGS. 24 and 25.

Thus, in the case of arranging the line head 29 as shown in FIGS. 27 and 28, the image-plane facing distance ld first decreases and then increases along the width direction LTD. Accordingly, as compared to the case where the change of the image-plane facing distance ld along the width direction LTD is a monotonic increase, the difference Δld_max in the image-plane facing distances ld can be suppressed. As a result, a satisfactory exposure can be realized by suppressing an occurrence of the above exposure failure.

Particularly, in this working example, the lens rows LSR1 to LSR4 are arranged at the lens row pitches Plsr in the width direction LTD and are substantially symmetrically arranged in the width direction LTD with respect to the symmetry axis SA substantially normal to the width direction LTD in the section along the sub scanning direction. Further, the line head 29 is arranged such that the image-plane facing distances ld2, ld3 of the lenses LS2, LS3 belonging to the lens rows LSR2, LSR3 (middle lens rows) closest to the symmetry axis SA is shorter than the image-plane facing distances ld1, ld4 of the lenses LS1, LS4 belonging to the lens rows LSR1, LSR4 other than the middle lens rows LSR2, LSR3. Therefore, the difference Δld_max in the image-plane facing distances ld can be more effectively suppressed.

Specifically, the difference Δld_max is a difference between the maximum value and the minimum value of the image-plane facing distances ld, and the maximum value of the image-plane facing distances ld is the image-plane facing distance ld of the lens LS belonging to either one of the end lens rows LSR1, LSR4 located at the opposite ends in the width direction LTD. In other words, the maximum value of the image-plane facing distances ld is the larger one of the image-plane facing distances ld1 and ld4. Accordingly, in order to suppress the difference Δld_max, it is preferable to shorten both of the image-plane facing distances ld1, ld4 of the lenses LS belonging to the end lens rows LSR1, LSR4 as much as possible. On the other hand, the relationship of the image-plane facing distances ld1, ld4 corresponding to the respective end lens rows LSR1, LSR4 is such that, when one becomes shorter, the other becomes longer. In other words, even if an attempt is made to shorten the both image-plane facing distances ld1, ld4, for example, by adjusting the position of the line head 29 in the width direction LTD (that is, moving the line head 29 in the width direction LTD), when one becomes shorter, the other becomes longer. Under such a relationship, these image-plane facing distances ld1, ld4 are preferably substantially equal upon suppressing the difference Δld_max.

Accordingly, in the image forming apparatus of this embodiment, the line head 29 is arranged such that the lens rows LSR1 to LSR4 are symmetrically arranged with respect to the symmetry axis SA and the image-plane facing distances ld2, ld3 of the lenses LS2, LS3 belonging to the middle lens rows LSR2, LSR3 closest to the symmetry axis SA are smaller than those of the lens rows LSR1, LSR4 other than the middle lens rows LSR2, LSR3. This is because the image-plane facing distances ld1, ld4 corresponding to the end lens rows LSR1, LSR4 can be made substantially equal by the above construction. As a result, in the image forming apparatus of this embodiment, a satisfactory exposure can be realized by suppressing the difference Δld_max in the image-plane facing distances ld.

Upon arranging the line head 29 relative to a latent image carrier whose surface shape has the curvature center CC21 like the photosensitive drum 21, the line head is preferably arranged as follows. Specifically, in the working example 2, the line head 29 is arranged such that the symmetry axis SA passes the curvature center CC21 (that is, rotation axis of the photosensitive drum 21) of the surface shape of the photosensitive drum 21. Accordingly, the image-plane facing distances ld1, ld4 corresponding to the end lens rows LSR1, LSR4 become equal to each other. As a result, a better exposure can be advantageously realized by more effectively suppressing the difference Δld_max in the image-plane facing distances ld. In order to facilitate the understanding of the invention, the result of a simulation conducted on the condition that the line head 29 is arranged as shown in FIGS. 27 and 28 is described below.

In the simulation of the working example 2, the relationship of arrangement of the photosensitive drum 21 and the line head is as shown in FIGS. 27 and 28. Specifically, the lens rows LSR1 to LSR4 are arranged at specified lens row pitches Plsr in the width direction LTD. The line head 29 is arranged such that the image-plane facing distances 1d2, ld3 corresponding to the middle lens rows LSR2, LSR3 are shorter than the image-plane facing distances ld1, ld4 corresponding to the other lens rows LSR1, LSR4. The symmetry axis SA of the lens rows LSR1 to LSR4 passes the curvature center CC21 of the surface shape of the photosensitive drum. Further, in this simulation, the lens row pitch Plsr and the light emitting element group row pitch Pegr were both set to 1.65 mm. The simulation was conducted in the respective cases where the diameter of the photosensitive drum 21 was 25 mm, 40 mm and 80 mm. It should be noted that the conditions on the lens configurations and lens positions of the lenses LS are the same in the working example 2 and the comparative example 2. In other words, the lens data, the aspherical surface coefficients and the specification of the optical system are the same in the working example 2 and the comparative example 2.

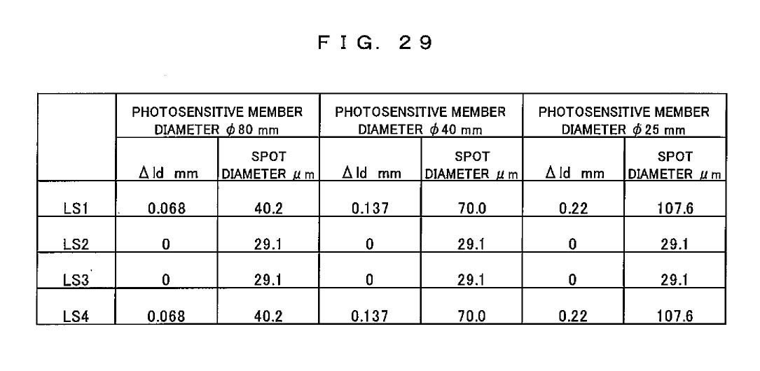

FIG. 29 shows the result of the simulation of the working example 2 conducted on the above conditions. The simulation result is described below for the respective cases where the diameter of the photosensitive drum 21 is 25 mm, 40 mm and 80 mm.

First of all, the case where the photosensitive drum diameter is 25 mm is described. As shown in a column “photosensitive member diameter φ 25 mm” of FIG. 29, the difference Δld_max among the image-plane facing distances ld1 to ld4 is 0.22 mm in the case where the diameter of the photosensitive drum 21 is 25 mm. An improvement as compared to 1.022 mm in the comparative example 2 can be understood. As shown by spot diameters in the same column, the minimum value of the diameters of the spots formed by the lenses LS1 to LS4 is 29.1 μm (diameter of the spots formed by the lenses LS2, LS3), whereas the maximum value thereof is 107.6 μm (diameters of the spots formed by the lenses LS1, LS4). In other words, in the working example 2, the maximum difference in the spot diameters is 78.5 μm (=107.6 μm-29.1 μm) and is remarkably improved as compared to the difference of 538.2 μm in the spot diameters in the comparative example 2.

Next, the case where the photosensitive drum diameter is 40 mm is described. As shown in a column “photosensitive member diameter φ40 mm” of FIG. 29, the difference Δld_max among the image-plane facing distances ld1 to ld4 is 0.137 mm in the case where the diameter of the photosensitive drum 21 is 40 mm. An improvement as compared to 0.622 mm in the comparative example 2 can be understood. As shown by spot diameters in the same column, the minimum value of the diameters of the spots formed by the lenses LS1 to LS4 is 29.1 μm (diameter of the spots formed by the lenses LS2, LS3), whereas the maximum value thereof is 70.0 μm (diameters of the spots formed by the lenses LS1, LS4). In other words, in the working example 2, the maximum difference in the spot diameters is 40.9 μm (=70.0 μm-29.1 μm) and is remarkably improved as compared to the difference of 299.2 μm in the spot diameters in the comparative example 2.

Next, the case where the photosensitive drum diameter is 80 mm is described. As shown in a column “photosensitive member diameter φ 80 mm” of FIG. 29, the difference Δld_max among the image-plane facing distances ld1 to ld4 is 0.068 mm in the case where the diameter of the photosensitive drum 21 is 80 mm. An improvement as compared to 0.307 mm in the comparative example 2 can be understood. As shown by spot diameters in the same column, the minimum value of the diameters of the spots formed by the lenses LS1 to LS4 is 29.1 μm (diameter of the spots formed by the lenses LS2, LS3), whereas the maximum value thereof is 40.2 μm (diameters of the spots formed by the lenses LS1, LS4). In other words, in the working example 2, the maximum difference in the spot diameters is 11.1 μm (=40.2 μm-29.1 μm) and is remarkably improved as compared to the difference of 122.3 μm in the spot diameters in the comparative example 2.

In this way, the difference Δld_max among the image-plane facing distances ld1 to ld4 is suppressed in the working example 2 by arranging the line head 29 as shown in FIGS. 27 and 28. By suppressing the difference Δld_max in the image-plane facing distances in this way, differences in the diameters of the spots formed on the surface of the photosensitive drum 21 are suppressed as compared to the comparative example 2. In other words, a better exposure is realized in the working example 2 than in the comparative example 2.

As shown in FIGS. 15, 21, 24 and 27, the focus positions FP of the light beams emerging from the respective lenses are located in the same plane SPL_fp. On the other hand, the photosensitive drum 21 exposed with these light beams has a curvature. Accordingly, the image-photosensitive member distances fd between the focus positions FP and the photosensitive member surface differ depending on the light beams. This is specifically described below using the case of the working example 1.

In the working example 1, the lens positions and the lens configurations of all the lenses LS of the lens array 299 are the same. As a result, the focus positions FP1 to FP3 of the light beams LB1 to LB3 are located in the same plane SPL_fp substantially parallel to the sub scanning direction SD (width direction LTD) in the section along the sub scanning direction. On the other hand, as shown in FIG. 21, out of the surface of the photosensitive drum 21 (latent image carrier), a surface area FCR facing the lens array 299 has a curvature in the section along the sub scanning direction. Accordingly, if distances between the focus positions FP1 to FP3 and the surface of the photosensitive drum 21 are assumed to be image-photosensitive member distances fd1 to fd3, the image-photosensitive member distances fd1 to fd3 differ. In other words, the image-photosensitive member distances between the focus positions FP and the photosensitive member surface differ among the plurality of lens rows LSR1 to LSR3.

Specifically, even if the line head 29 is properly arranged as in the above working examples 1 and 2, there still remain slight differences in the image-photosensitive member distances fd. As a result, there remain differences in the diameters of the spots formed on the surface of the photosensitive drum 21 as shown in the simulation results of FIG. 23 and FIG. 29. Accordingly, the invention for realizing a satisfactory exposure by suppressing the differences in the image-photosensitive member distances fd by adjusting the focus positions FP in accordance with the curvature shape of the photosensitive drum surface is described below.

### Working Example 3

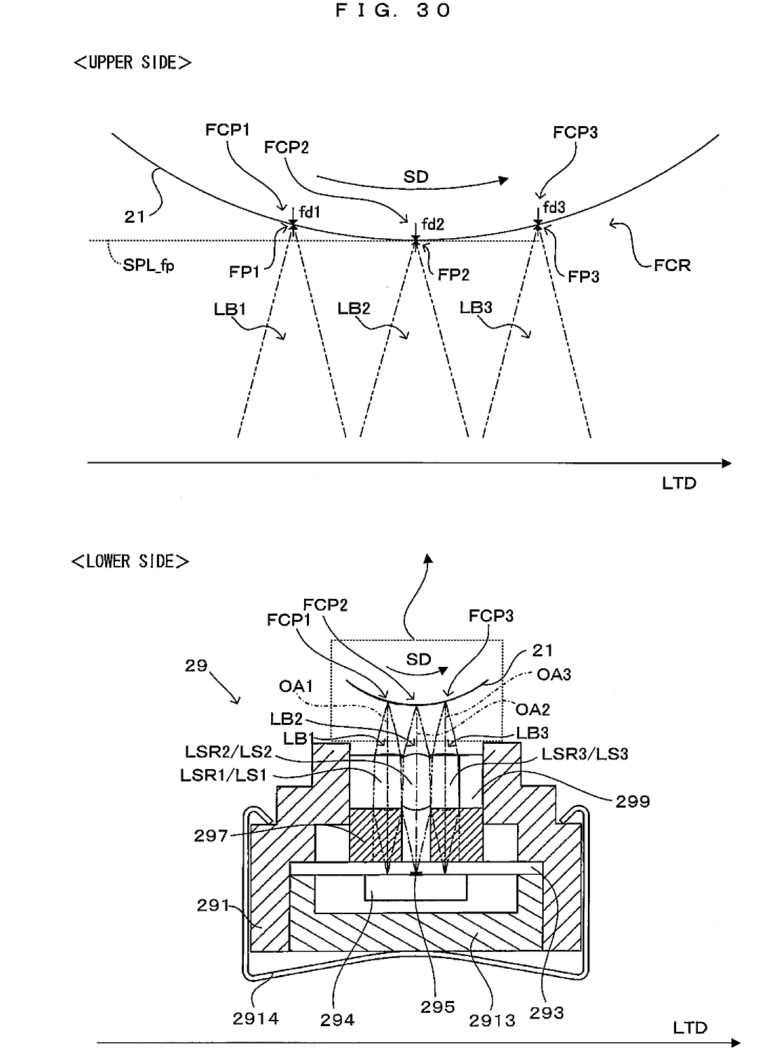

FIG. 30 is a sectional view along the sub scanning direction showing the relationship of arrangement of a lens array and a photosensitive drum according to a working example 3 of the invention. An upper side of FIG. 30 enlargedly shows a rectangular part enclosed by broken line in a lower side of FIG. 30. Lenses LS1 to LS3 in the lower side of FIG. 30 are lenses belonging to mutually different lens rows LSR1 to LSR3.

In the working example 3, the relationship of arrangement of the lens array 299 and the photosensitive drum 21 is the same as in the working example 1. Specifically, as described with reference to FIG. 22, three lens rows LSR1 to LSR3 are arranged at lens row pitches Plsr in the width direction LTD and are substantially symmetrically arranged in the width direction LTD with respect to a symmetry axis SA. Further, the lens rows LSR1 to LSR3 are arranged such that optical axes OA1 to OA3 of the lenses LS1 to LS3 belonging to the lens rows LSR1 to LSR3 are parallel to each other. The lens array 299 is arranged such that the symmetry axis SA passes a curvature center CC21 of the photosensitive drum 21 (that is, rotation axis of the photosensitive drum 21).

The lens rows LSR1 to LSR3 are all arranged to face the surface of the photosensitive drum 21. At this time, the respective lens rows LSR1 to LSR3 face facing positions FCP1 to FCP3 of the photosensitive drum surface (latent image carrier surface) mutually different in the sub scanning direction SD. Accordingly, the lens LS1 belonging to the lens row LSR1 focuses a light beam LB1 emitted from a light emitting element group 295, which the lens LS1 is facing, toward the facing position FCP1. The lens LS2 belonging to the lens row LSR2 focuses a light beam LB2 emitted from a light emitting element group 295, which the lens LS2 is facing, toward the facing position FCP2. The lens LS3 belonging to the lens row LSR3 focuses a light beam LB3 emitted from a light emitting element group 295, which the lens LS3 is facing, toward the facing position FCP3. In other words, the focus positions of the light beams focused by the lenses LS belonging to the different lens rows LSR mutually differ in the sub scanning direction SD.

Accordingly, if the lens configurations and the lens positions of all the lenses LS are the same as in the working example 1, spot diameter differences to such as an extent as shown in the working example 1 occur. On the contrary, in the working example 3 of the invention, the focus positions FP1 to FP3 of the light beams by the lenses LS1 to LS3 are set at positions in conformity with the curvature shape of the surface of the photosensitive drum 21 (FIG. 30). The lens shapes of the lenses LS1 to LS3 are constructed to conform the focus positions FP1 to FP3 to the curvature shape in this way. This construction is specifically as follows.

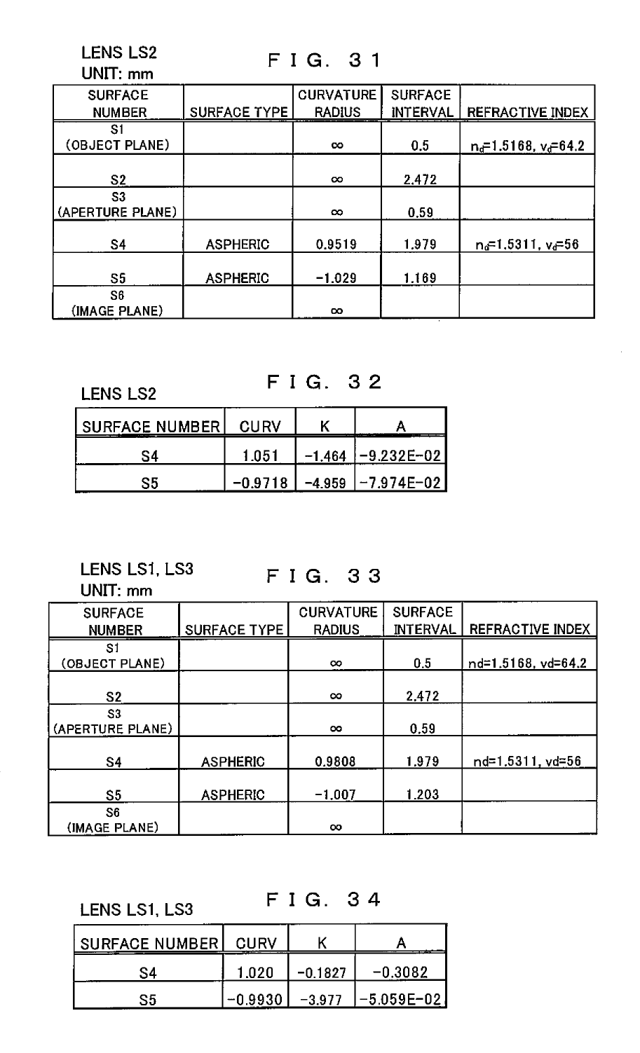

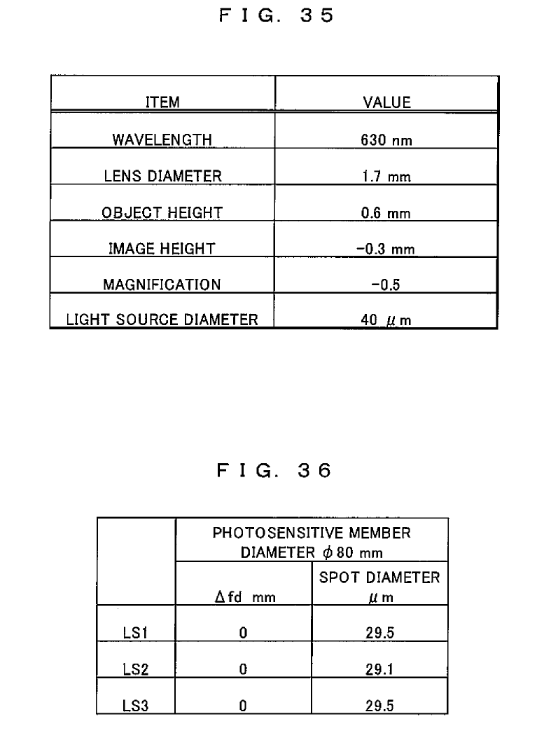

FIG. 31 shows the lens data of the lens LS2, and FIG. 32 shows the aspherical surface coefficient of the lens LS2. On the other hand, FIG. 33 shows the lens data of the lenses LS1, LS3, and FIG. 34 shows the aspherical surface coefficients of the lenses LS1, LS3. As can be understood from these data, the aspherical surface coefficients differ between the lens LS2 and lenses LS1, LS3 in the working example 3. All of the lenses LS1 to LS3 have the same lens thickness and lens position. FIG. 35 shows the specification of an optical system used in a simulation of the working example 3. Thus, the lenses LS1 and LS3 are the same in the working example 3 of the invention. On the other hand, the lenses LS1, LS3 differ from the lens LS2.

FIG. 36 shows a simulation result in the case where the lenses LS1 to LS3 are formed based on the data given by above FIG. 31 to FIG. 35. In this simulation, a lens row pitch Plsr, a light emitting element group row pitch Pegr, a photosensitive drum diameter and other conditions are the same as in the working example 1. Differences Δfd shown in FIG. 36 are differences between image-photosensitive member distances fd1 to fd3 corresponding to the lenses LS1 to LS3 and the image-photosensitive member distance fd2. In other words, the differences Δfd among the image-photosensitive member distances fd1 to fd3 are calculated based on the image-photosensitive member distance fd2. As shown in FIG. 36, the differences Δfd are 0 in the working example 3. In other words, the image-photosensitive member distances fd1 to fd3 are equal to each other. This is because the focus positions FP1 to FP3 of the light beams by the lenses LS1 to LS3 are adjusted to the positions in conformity with the curvature shape of the photosensitive drum 21 (substantially on the surface of the photosensitive drum 21 as shown in FIG. 30 in the working example 3) as shown in FIG. 30. As shown in a column “Spot Diameter” of FIG. 36, it can be understood that differences in the diameters of spots formed on the surface of the photosensitive drum 21 are suppressed by suppressing the differences of the image-photosensitive member distances fd1 to fd3. Specifically, the diameter of the spots formed by the lens LS2 is 29.1 μm, whereas the diameter of the spots formed by the lenses LS1, LS3 is 29.5 μm. Accordingly, a spot diameter difference in the working example 3 is 0.4 μm (29.5 μm-29.1 μm) and an improvement as compared to the spot diameter difference of 3.2 μm in the working example 1 can be understood. In other words, the differences in the diameters of the spots formed by a plurality of lens rows LSR1 to LSR3 are further suppressed in the working example 3 as compared to the working example 1.

In this way, in the working example 3, the lens shapes (lens configurations) of the lenses LS1 to LS3 belonging to the mutually different lens rows LSR are constructed such that the focus positions FP1 to FP3 of the light beams by the plurality of respective lenses LS1 to LS3 conform to the curvature shape of the surface of the photosensitive drum 21 (latent image carrier surface). Accordingly, an occurrence of such a problem that the distances between the focus positions and the latent image carrier surface (image-photosensitive member distances) differ depending on the lens rows LSR as described above can be suppressed. As a result, a satisfactory exposure can be advantageously realized by suppressing the differences in the spot diameters as shown in FIG. 36.

However, there are cases of inducing an exposure failure that the efficiencies of the lenses (lens efficiencies) differ among the respective lenses LS by adjusting the lens configurations of the respective lenses LS so as to conform the focus positions FP to the curvature shape of the photosensitive drum surface (latent image carrier surface) as described above. Here, the lens efficiency is given by the following equation:

(Lens Efficiency)=(Transmission Efficiency of Lens)/(Effective F-Number)²/4.

The transmission efficiency of the lens is a ratio of the light quantity of an emergent light from the second surface LSFs of the lens LS (emergent light quantity LQout) to the light quantity of an incident light on the first surface LSFf of the lens LS (incident light quantity LQin). In other words, the transmission efficiency of the lens is given by LQout/LQin. The effective F-number Fe is given by the following equation, using a magnification LM, a diameter Dout of the second surface LSFs of the lens LS and a focal length fls of the lens LS:

Fe=(1+LM)fls/Dout.

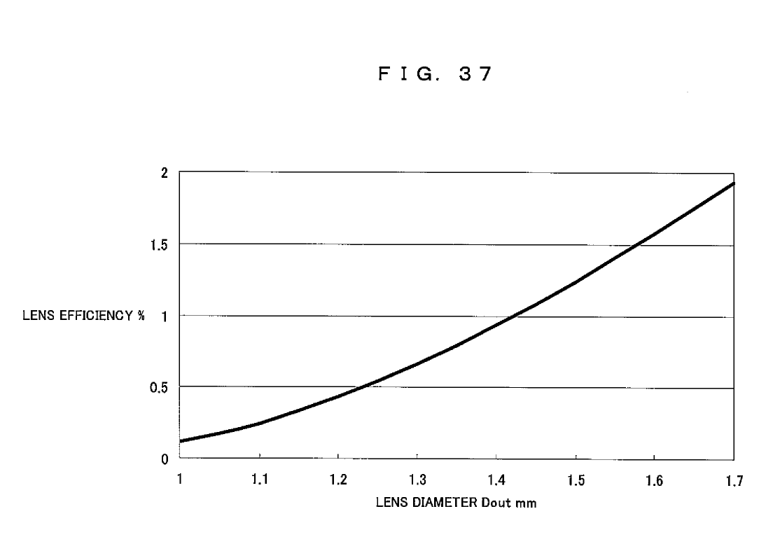

FIG. 37 is a graph showing a relationship between the lens diameter and the lens efficiency. In FIG. 37, the lens efficiency was calculated assuming the transmission efficiency of the lens LS to be 0.9. As shown in FIG. 37, the lens efficiency monotonically increases in relation to the lens diameter Dout. Accordingly, if the lens diameter Dout varies, the lens efficiency also varies. As a result, the following problem occurs in some cases. In other words, as the lens configurations of the respective lenses LS are constructed to adjust as above, the lens diameters Dout of the lens surfaces LSFs of the respective lenses LS facing toward the photosensitive drum 21 (facing toward the latent image carrier) differ depending on the lenses LS, with the result that there have been cases where the lens efficiency differs depending on the lenses LS. Therefore, there has been a possibility that the light quantities of the light beams LB relating to the image formation on the photosensitive drum surface differ depending on the lenses LS to cause an exposure failure of being unable to perform a satisfactory exposure.

On the other hand, in the working example 3, the lens diameters Dout of the lens surfaces LSFs of the plurality of lenses LS facing toward the photosensitive drum are equal to each other. Specifically, the lens diameter is 1.7 mm in all the lenses LS (FIG. 35). Accordingly, the lens efficiencies of the respective lenses LS are substantially constant even if the lens configurations thereof are constructed to adjust as above. Thus, the above working example 3 is preferable because an occurrence of such an exposure failure that the light quantity of the light beam LB relating to the image formation differs depending on the lens LS and no satisfactory exposure can be performed can be suppressed.

In the working example 3, the focus positions FP1 to FP3 are adjusted to those in conformity with the curvature shape of the surface of the photosensitive drum 21 by constructing to adjust as above only the lens shapes. However, the lens thickness (lens configuration) and the lens position may be constructed to adjust as above in addition to the lens shape (lens configuration), for example, as shown in a working example 4 below.

### Working Example 4

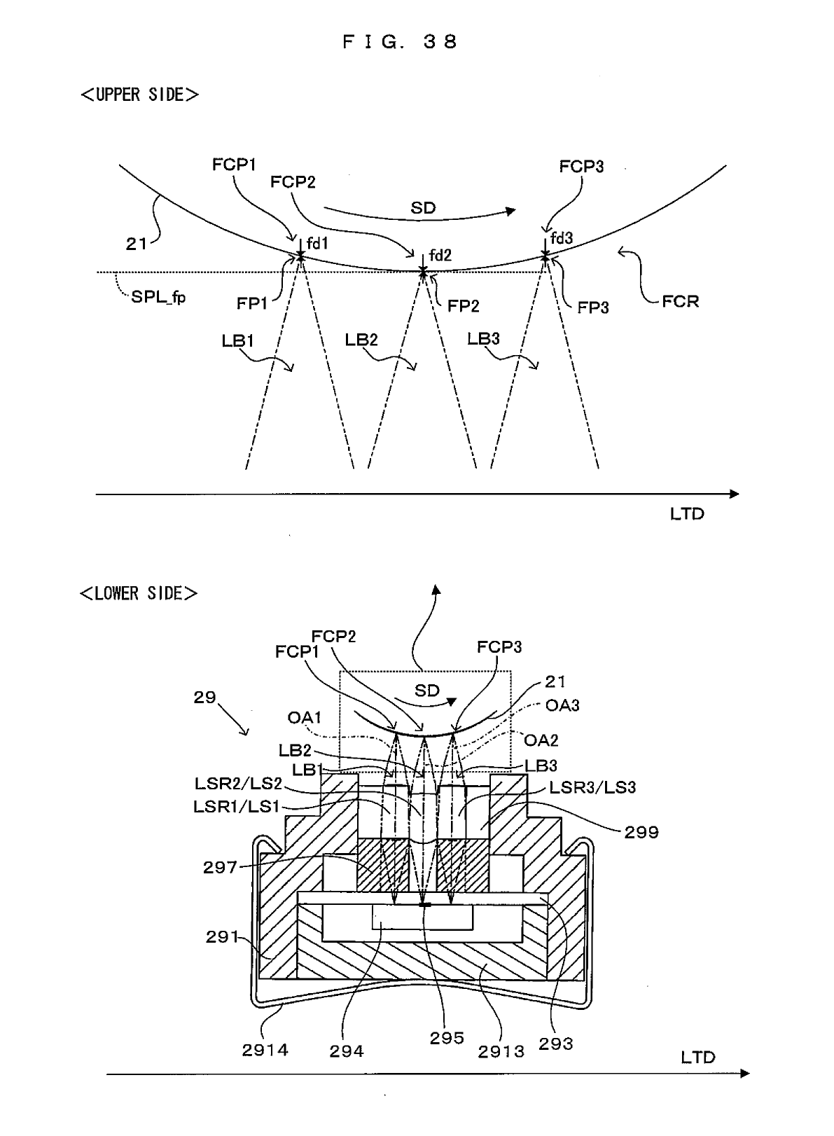

FIG. 38 is a sectional view along the sub scanning direction showing the relationship of arrangement of a lens array and a photosensitive drum according to the working example 4 of the invention. An upper side of FIG. 38 enlargedly shows a rectangular part enclosed by broken line in a lower side of FIG. 38. Lenses LS1 to LS3 in the lower side of FIG. 38 are lenses belonging to mutually different lens rows LSR1 to LSR3.

In the working example 4, the relationship of arrangement of the lens array 299 and the photosensitive drum 21 is the same as in the working example 1. Specifically, as described with reference to FIG. 22, three lens rows LSR1 to LSR3 are arranged at lens row pitches Plsr in the width direction LTD and are substantially symmetrically arranged in the width direction LTD with respect to a symmetry axis SA. Further, the lens rows LSR1 to LSR3 are arranged such that optical axes OA1 to OA3 of the lenses LS1 to LS3 belonging to the lens rows LSR1 to LSR3 are parallel to each other. The lens array 299 is arranged such that the symmetry axis SA passes a curvature center CC21 of the photosensitive drum 21 (that is, rotation axis of the photosensitive drum 21).

The lens rows LSR1 to LSR3 are all arranged to face the surface of the photosensitive drum 21. At this time, the respective lens rows LSR1 to LSR3 face facing positions FCP1 to FCP3 of the photosensitive drum surface (latent image carrier surface) mutually different in the sub scanning direction SD. Accordingly, the lens LS1 belonging to the lens row LSR1 focuses a light beam LB 1 emitted from a light emitting element group 295, which the lens LS1 is facing, toward the facing position FCP1. The lens LS2 belonging to the lens row LSR2 focuses a light beam LB2 emitted from a light emitting element group 295, which the lens LS2 is facing, toward the facing position FCP2. The lens LS3 belonging to the lens row LSR3 focuses a light beam LB3 emitted from a light emitting element group 295, which the lens LS3 is facing, toward the facing position FCP3. In other words, the focus positions of the light beams focused by the lenses LS belonging to the different lens rows LSR mutually differ in the sub scanning direction SD.

Accordingly, if the lens configurations and the lens positions of all the lenses LS are the same as in the working example 1, spot diameter differences to such an extent as shown in the working example 1 occur. On the contrary, in the working example 4 of the invention, the focus positions FP1 to FP3 of the light beams by the lenses LS1 to LS3 are set at positions in conformity with the curvature shape of the surface of the photosensitive drum 21 (FIG. 38). The lens shapes (lens configurations), the lens thicknesses (lens configurations) and the lens positions of the lenses LS1 to LS3 are constructed to conform the focus positions to the curvature shape in this way. This construction is specifically as follows.

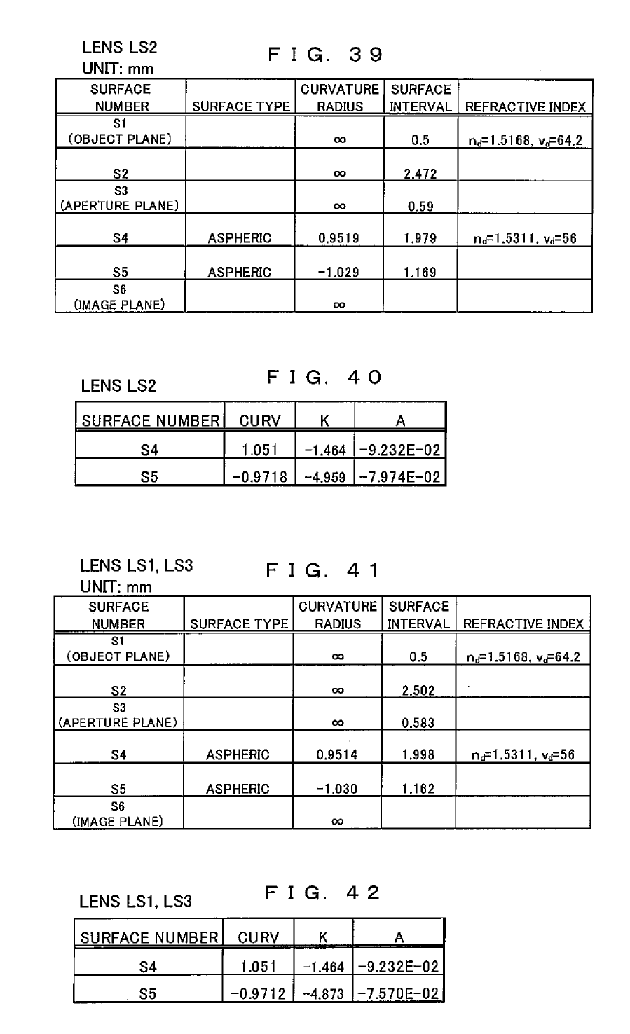

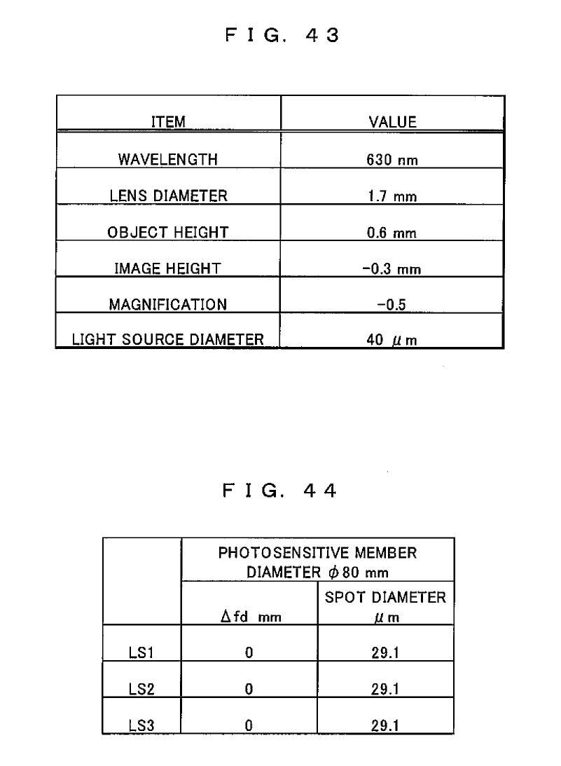

FIG. 39 shows the lens data of the lens LS2, and FIG. 40 shows the aspherical surface coefficient of the lens LS2. On the other hand, FIG. 41 shows the lens data of the lenses LS1, LS3, and FIG. 42 shows the aspherical surface coefficients of the lenses LS1, LS3. As can be understood from a difference in the aspherical surface coefficient of the surface number S5 between the lens LS2 and the lenses LS1, LS3, the aspherical surface coefficients of the second surfaces LSFs differ between the lens LS2 and lenses LS1, LS3 in the working example 4. Further, as can be understood from a difference in the sum of the surface intervals from the surface number S1 to the surface number S3 between the lens LS2 and the lenses LS1, LS3, the lens positions differ between the lens LS2 and the lenses LS1, LS3 in the working example 4. Further, as can be understood from a difference in the surface interval of the surface number S4 between the lens LS2 and the lenses LS1 and LS3, the lens thicknesses differ between the lens LS2 and the lenses LS1, LS3 in the working example 4. FIG. 43 shows the specification of an optical system used in a simulation of the working example 4. Thus, the lenses LS1 and LS3 are the same in the working example 4 of the invention. On the other hand, the lenses LS1, LS3 differ from the lens LS2.

FIG. 44 shows a simulation result in the case where the lenses LS 1 to LS3 are formed based on the data given by above FIG. 39 to FIG. 43. In this simulation, a lens row pitch Plsr, a light emitting element group row pitch Pegr, a photosensitive drum diameter and other conditions are the same as in the working example 1. Differences Δfd shown in FIG. 44 are differences between image-photosensitive member distances fd1 to fd3 corresponding to the lenses LS1 to LS3 and the image-photosensitive member distance fd2. In other words, the differences Δfd among the image-photosensitive member distances fd1 to fd3 are calculated based on the image-photosensitive member distance fd2. As shown in FIG. 44, the differences Δfd are 0 in the working example 4. In other words, the image-photosensitive member distances fd1 to fd3 are equal to each other. This is because the focus positions FP1 to FP3 of the light beams by the lenses LS1 to LS3 are adjusted to the positions in conformity with the curvature shape of the photosensitive drum 21 (substantially on the surface of the photosensitive drum 21 as shown in FIG. 38 in the working example 4) as shown in FIG. 38. As shown in a column “Spot Diameter” of FIG. 44, it can be understood that differences in the diameters of spots formed on the surface of the photosensitive drum 21 are suppressed by suppressing the differences of the image-photosensitive member distances fd1 to fd3 (in other words, all the spot diameters corresponding to the lenses LS1 to LS3 are 29.1 μm). Specifically, the diameter of the spots formed by the lens LS2 is 29.1 μm, and the diameter of the spots formed by the lenses LS1, LS3 are also 29.1 μm. Accordingly, a spot diameter difference in the working example 4 is 0 μm and a remarkable improvement as compared to the spot diameter difference of 3.2 μm in the working example 1 can be understood. In other words, the differences in the diameters of the spots formed by a plurality of lens rows LSR1 to LSR3 are further suppressed in the working example 4 as compared to the working example 1.

In this way, in the working example 4, the lens shapes (lens configurations), the lens thicknesses (lens configurations) and the lens positions of the lenses LS1 to LS3 belonging to the mutually different lens rows LSR are constructed such that the focus positions FP1 to FP3 of the light beams by the plurality of respective lenses LS1 to LS3 conform to the curvature shape of the surface of the photosensitive drum 21 (latent image carrier surface). Accordingly, an occurrence of such a problem that the distances between the focus positions and the latent image carrier surface (image-photosensitive member distances) differ depending on the lens rows LSR as described above can be suppressed. As a result a satisfactory exposure can be advantageously realized by suppressing the differences in the spot diameters as shown in FIG. 44.

However, there are cases of inducing an exposure failure that the efficiencies of the lenses (lens efficiencies) differ among the respective lenses LS by adjusting the lens configurations and the lens positions of the respective lenses LS so as to conform the focus positions FP to the curvature shape of the photosensitive drum surface (latent image carrier surface) as described above. In other words, there are cases where the exposure failure described with reference to FIG. 37 occurs. On the contrary, in the working example 4, the lens diameters Dout of the lens surfaces LSFs of the plurality of lenses LS facing toward the photosensitive drum are equal to each other. Specifically, the lens diameters are 1.7 mm in all the lenses LS (FIG. 43). Accordingly, even if the lens configurations of the respective lenses LS are constructed to adjust as above, the lens efficiencies of the respective lenses LS are substantially constant. Therefore, the above working example 4 is preferable because an occurrence of such an exposure failure that the light quantities of the light beams LB relating to the image formation differ depending on the lenses LS and no satisfactory exposure can be performed can be suppressed.

### Working Example 5

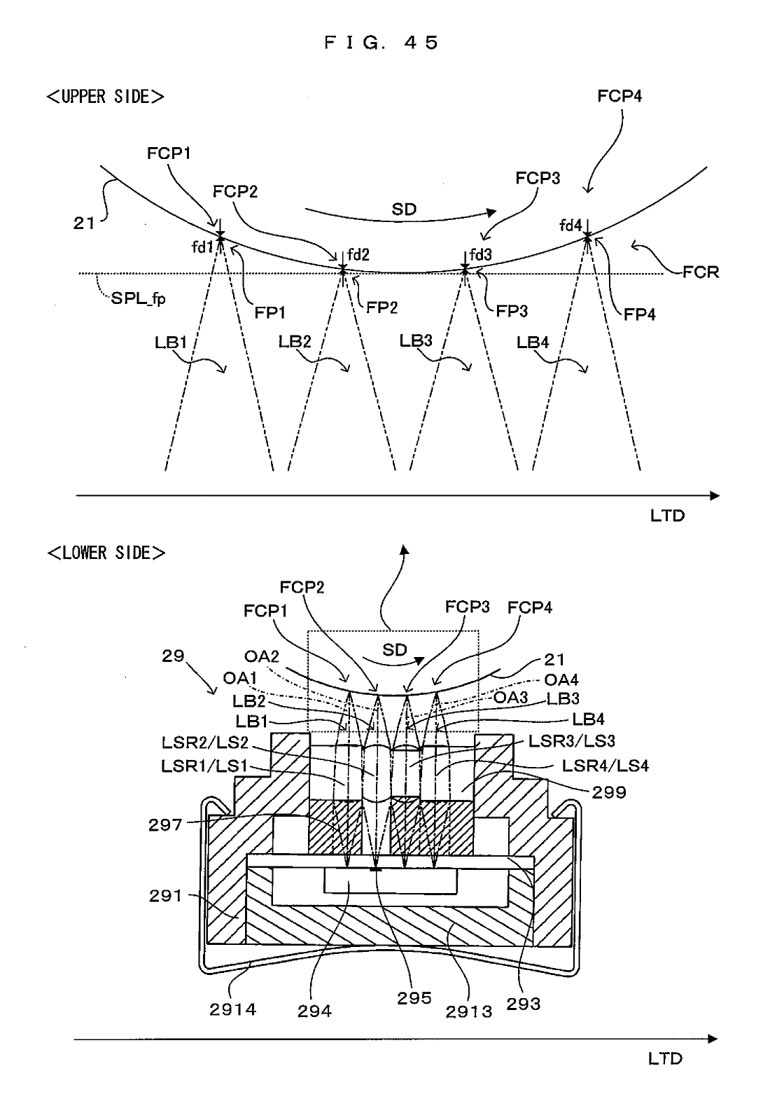

FIG. 45 is a sectional view along the sub scanning direction showing the relationship of arrangement of a lens array and a photosensitive drum according to a working example 5 of the invention. An upper side of FIG. 45 enlargedly shows a rectangular part enclosed by broken line in a lower side of FIG. 45. Lenses LS1 to LS4 in the lower side of FIG. 45 are lenses belonging to mutually different lens rows LSR1 to LSR4.

In the working example 5, the relationship of arrangement of the lens array 299 and the photosensitive drum 21 is the same as in the working example 2. Specifically, as described with reference to FIG. 28, four lens rows LSR1 to LSR4 are arranged at lens row pitches Plsr in the width direction LTD and are substantially symmetrically arranged in the width direction LTD with respect to a symmetry axis SA. Further, the lens rows LSR1 to LSR4 are arranged such that optical axes OA1 to OA4 of the lenses LS1 to LS4 belonging to the lens rows LSR1 to LSR4 are parallel to each other. The lens array 299 is arranged such that the symmetry axis SA passes a curvature center CC21 of the photosensitive drum 21 (that is, rotation axis of the photosensitive drum 21).

The lens rows LSR1 to LSR4 are all arranged to face the surface of the photosensitive drum 21. At this time, the respective lens rows LSR1 to LSR4 face facing positions FCP1 to FCP4 of the photosensitive drum surface (latent image carrier surface) mutually different in the sub scanning direction SD. Accordingly, the lens LS1 belonging to the lens row LSR1 focuses a light beam LB1 emitted from a light emitting element group 295, which the lens LS1 is facing, toward the facing position FCP1. The lens LS2 belonging to the lens row LSR2 focuses a light beam LB2 emitted from a light emitting element group 295, which the lens LS2 is facing, toward the facing position FCP2. The lens LS3 belonging to the lens row LSR3 focuses a light beam LB3 emitted from a light emitting element group 295, which the lens LS3 is facing, toward the facing position FCP3. The lens LS4 belonging to the lens row LSR4 focuses a light beam LB4 emitted from a light emitting element group 295, which the lens LS4 is facing, toward the facing position FCP4. In other words, the focus positions of the light beams focused by the lenses LS belonging to the different lens rows LSR mutually differ in the sub scanning direction SD.

Accordingly, if the lens configurations and the lens positions of all the lenses LS are the same as in the working example 2, spot diameter differences to such an extent as shown in the working example 2 occur. On the contrary, in the working example 5 of the invention, the focus positions FP1 to FP4 of the light beams by the lenses LS1 to LS4 are set at positions in conformity with the curvature shape of the surface of the photosensitive drum 21 (FIG. 45). The lens shapes of the lenses LS1 to LS4 are constructed to conform the focus positions to the curvature shape in this way. This construction is specifically as follows.

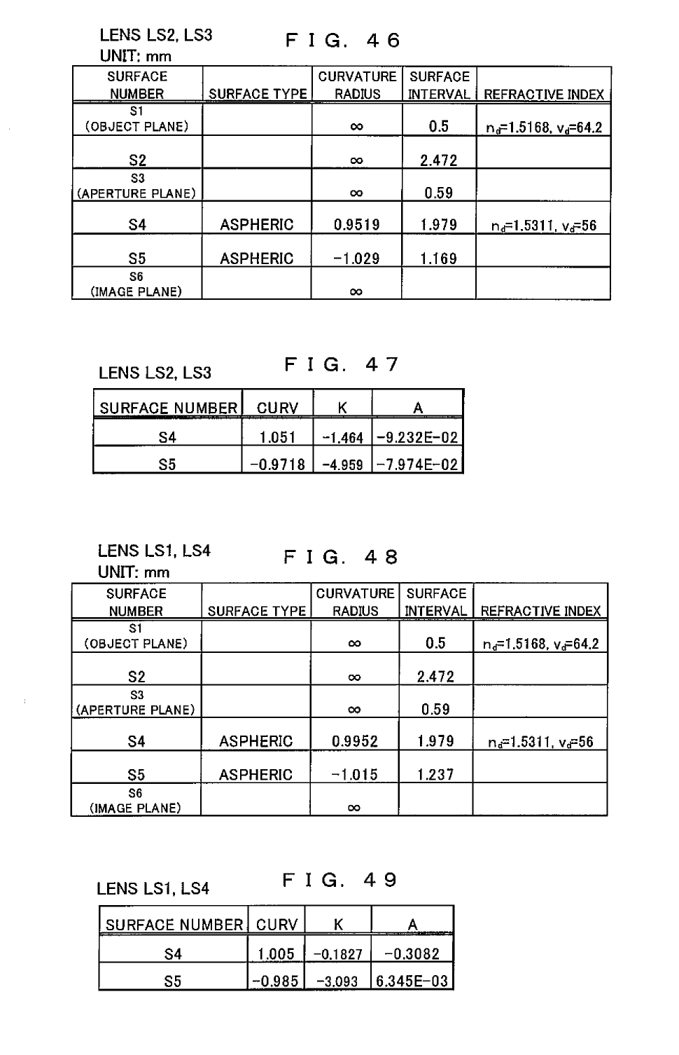

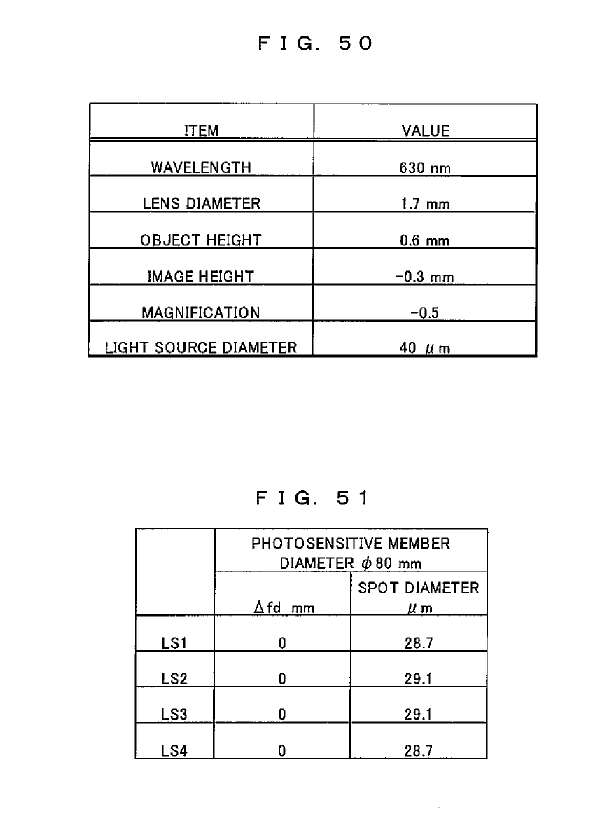

FIG. 46 shows the lens data of the lenses LS2, LS3, and FIG. 47 shows the aspherical surface coefficients of the lenses LS2, LS3. On the other hand. FIG. 48 shows the lens data of the lenses LS1, LS4, and FIG. 49 shows the aspherical surface coefficients of the lenses LS1, LS4. As can be understood from these data, the aspherical surface coefficients differ between the lenses LS2, LS3 and lenses LS1, LS4 in the working example 5. The lenses LS2, LS3 and the lenses LS1, LS4 have the same lens thickness and lens position. FIG. 50 shows the specification of an optical system used in a simulation of the working example 5. Thus, the lenses LS2 and LS3 are the same and the lenses LS1 and LS4 are the same in the working example 5 of the invention. Further, the lenses LS2, LS3 differ from the lenses LS1, LS4.

FIG. 51 shows a simulation result in the case where the lenses LS1 to LS4 are formed based on the data given by above FIG. 46 to FIG. 50. In this simulation, a lens row pitch Plsr, a light emitting element group row pitch Pegr, a photosensitive drum diameter and other conditions are the same as in the working example 2. Differences Δfd shown in FIG. 51 are differences between image-photosensitive member distances fd1 to fd4 corresponding to the lenses LS1 to LS4 and the image-photosensitive member distance fd2. In other words, the differences Δfd among the image-photosensitive member distances fd1 to fd4 are calculated based on the image-photosensitive member distance fd2. As shown in FIG. 51, the differences Δfd are 0 in the working example 5. In other words, the image-photosensitive member distances fd1 to fd4 are equal to each other. This is because the focus positions FP1 to FP4 of the light beams by the lenses LS1 to LS4 are adjusted to the positions in conformity with the curvature shape of the photosensitive drum 21 (substantially on the surface of the photosensitive drum 21 as shown in FIG. 45 in the working example 5) as shown in FIG. 45. As shown in a column “Spot Diameter” of FIG. 51, it can be understood that differences in the diameters of spots formed on the surface of the photosensitive drum 21 are suppressed by suppressing the differences of the image-photosensitive member distances fd1 to fd4. Specifically, the diameter of the spots formed by the lenses LS2, LS3 is 29.1 μm, whereas the diameter of the spots formed by the lenses LS1, LS4 are 28.7 μm. Accordingly, a spot diameter difference in the working example 5 is 0.4 μm (=29.1 μm-28.7 μm) and an improvement as compared to the spot diameter difference of 11.1 μm in the working example 2 can be understood. In other words, the differences in the diameters of the spots formed by a plurality of lens rows LSR1 to LSR4 are further suppressed in the working example 5 as compared to the working example 2.

In this way, in the working example 5, the lens shapes (lens configurations) of the lenses LS1 to LS4 belonging to the mutually different lens rows LSR are constructed such that the focus positions FP1 to FP4 of the light beams by the plurality of respective lenses LS1 to LS4 conform to the curvature shape of the surface of the photosensitive drum 21 (latent image carrier surface). Accordingly, an occurrence of such a problem that the distances between the focus positions and the latent image carrier surface (image-photosensitive member distances) differ depending on the lens rows LSR as described above can be suppressed. As a result, a satisfactory exposure can be advantageously realized by suppressing the differences in the spot diameters as shown in FIG. 51.

However, there are cases of inducing an exposure failure that the efficiencies of the lenses (lens efficiencies) differ among the respective lenses LS by adjusting the lens configurations of the respective lenses LS so as to conform the focus positions FP to the curvature shape of the photosensitive drum surface (latent image carrier surface) as described above. In other words, there are cases where the exposure failure described with reference to FIG. 37 occurs. On the contrary, in the working example 5, the lens diameters Dout of the lens surfaces LSFs of the plurality of lenses LS facing toward the photosensitive drum are equal to each other. Specifically, the lens diameters are 1.7 mm in all the lenses LS (FIG. 50). Accordingly, even if the lens configurations of the respective lenses LS are constructed to adjust as above, the lens efficiencies of the respective lenses LS are substantially constant. Therefore, the above working example 5 is preferable because an occurrence of such an exposure failure that the light quantities of the light beams LB relating to the image formation differ depending on the lenses LS and no satisfactory exposure can be performed can be suppressed.

In the working example 5, the focus positions FP1 to FP4 are adjusted to those in conformity with the curvature shape of the surface of the photosensitive drum 21 by constructing to adjust as above only the lens shapes. However, the lens thickness (lens configuration) and the lens position may be constructed to adjust as above in addition to the lens shape (lens configuration), for example, as shown in a working example 6 below.

### Working Example 6

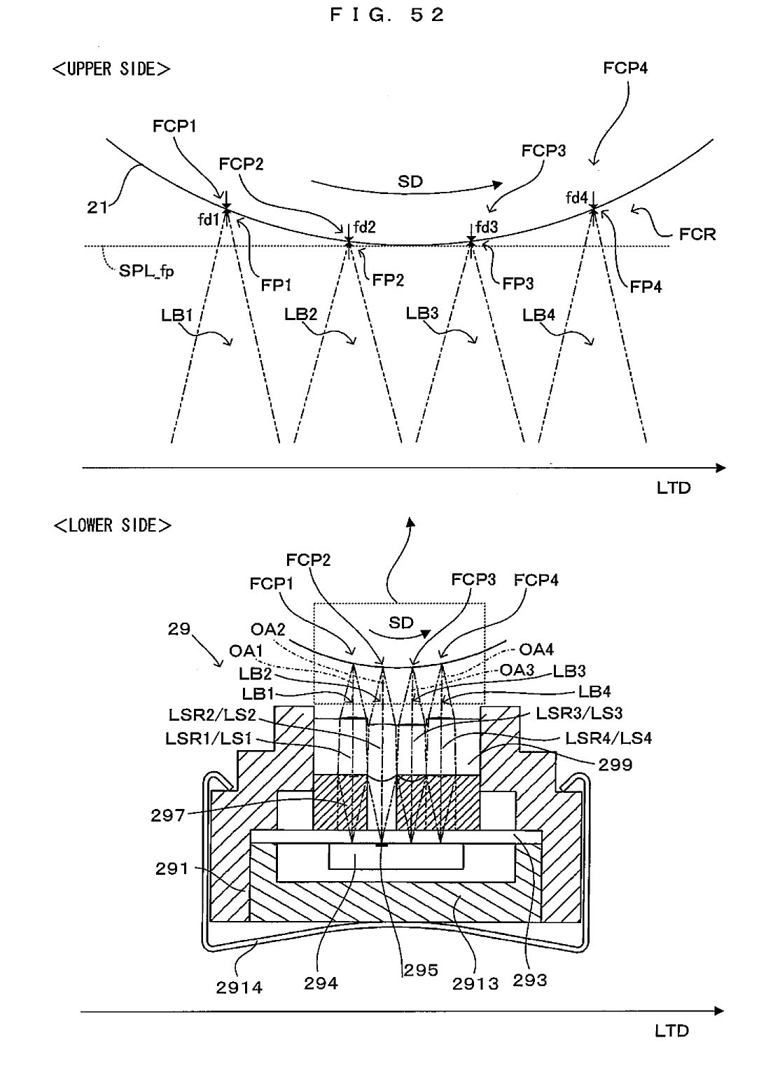

FIG. 52 is a sectional view along the sub scanning direction showing the relationship of arrangement of a lens array and a photosensitive drum according to the working example 6 of the invention. An upper side of FIG. 52 enlargedly shows a rectangular part enclosed by broken line in a lower side of FIG. 52. Lenses LS1 to LS4 in the lower side of FIG. 52 are lenses belonging to mutually different lens rows LSR1 to LSR4.

In the working example 6, the relationship of arrangement of the lens array 299 and the photosensitive drum 21 is the same as in the working example 2. Specifically, as described with reference to FIG. 28, four lens rows LSR1 to LSR4 are arranged at lens row pitches Plsr in the width direction LTD and are substantially symmetrically arranged in the width direction LTD with respect to a symmetry axis SA. Further, the lens rows LSR1 to LSR4 are arranged such that optical axes OA1 to OA4 of the lenses LS1 to LS4 belonging to the lens rows LSR1 to LSR4 are parallel to each other. The lens array 299 is arranged such that the symmetry axis SA passes a curvature center CC21 of the photosensitive drum 21 (that is, rotation axis of the photosensitive drum 21).

The lens rows LSR1 to LSR4 are all arranged to face the surface of the photosensitive drum 21. At this time, the respective lens rows LSR1 to LSR4 face facing positions FCP1 to FCP4 of the photosensitive drum surface (latent image carrier surface) mutually different in the sub scanning direction SD. Accordingly, the lens LS1 belonging to the lens row LSR1 focuses a light beam LB1 emitted from a light emitting element group 295, which the lens LS1 is facing, toward the facing position FCP1. The lens LS2 belonging to the lens row LSR2 focuses a light beam LB2 emitted from a light emitting element group 295, which the lens LS2 is facing, toward the facing position FCP2. The lens LS3 belonging to the lens row LSR3 focuses a light beam LB3 emitted from a light emitting element group 295, which the lens LS3 is facing, toward the facing position FCP3. The lens LS4 belonging to the lens row LSR4 focuses a light beam LB4 emitted from a light emitting element group 295, which the lens LS4 is facing, toward the facing position FCP4. In other words, the focus positions of the light beams focused by the lenses LS belonging to the different lens rows LSR mutually differ in the sub scanning direction SD.

Accordingly, if the lens configurations and the lens positions of all the lenses LS are the same as in the working example 2, spot diameter differences to such as an extent as shown in the working example 2 occur. On the contrary, in the working example 6 of the invention, the focus positions FP1 to FP4 of the light beams by the lenses LS1 to LS4 are set at positions in conformity with the curvature shape of the surface of the photosensitive drum 21 (FIG. 52). The lens shapes (lens configurations), the lens thicknesses (lens configurations) and the lens positions of the lenses LS1 to LS4 are constructed to conform the focus positions to the curvature shape in this way. This construction is specifically as follows.

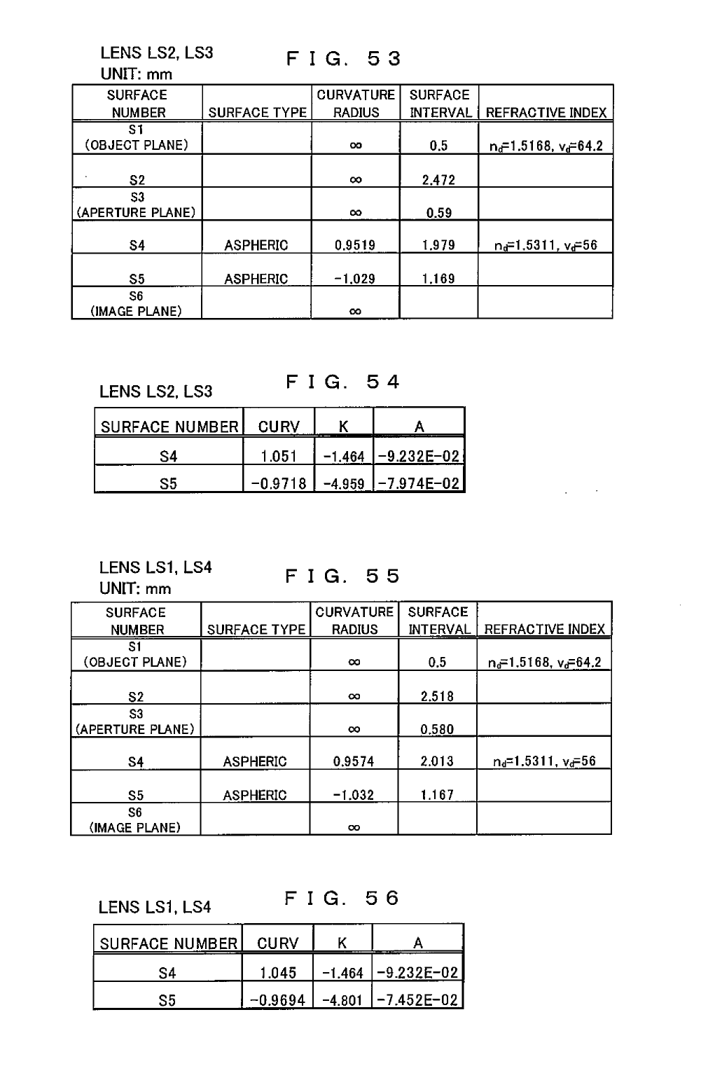

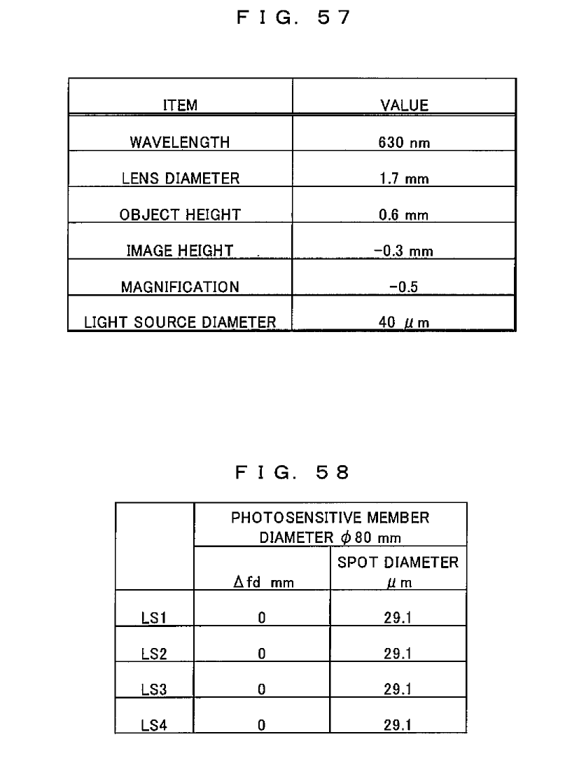

FIG. 53 shows the lens data of the lenses LS2, LS3, and FIG. 54 shows the aspherical surface coefficients of the lenses LS2, LS3. On the other hand, FIG. 55 shows the lens data of the lenses LS1, LS4, and FIG. 56 shows the aspherical surface coefficients of the lenses LS1, LS4. As can be understood from a difference in the aspherical surface coefficient of the surface number S5 between the lenses LS2, LS3 and the lenses LS1, LS4, the aspherical surface coefficients differ between the lenses LS2, LS3 and lenses LS1, LS4 in the working example 6. Further, as can be understood from a difference in the sum of the surface intervals from the surface number S1 to the surface number S3 between the lenses LS2, LS3 and the lenses LS1, LS4, the lens positions differ between the lenses LS2, LS3 and the lenses LS1, LS4 in the working example 6. Further, as can be understood from a difference in the surface interval of the surface number S4 between the lenses LS2, LS3 and the lenses LS1, LS4, the lens thicknesses differ between the lenses LS2, LS3 and the lenses LS1, LS4 in the working example 6. FIG. 57 shows the specification of an optical system used in a simulation of the working example 6. Thus, the lenses LS2 and LS3 are the same and the lenses LS1 and LS4 are the same in the working example 6 of the invention. Further, the lenses LS2, LS3 differ from the lenses LS1, LS4.

FIG. 58 shows a simulation result in the case where the lenses LS 1 to LS4 are formed based on the data given by above FIG. 53 to FIG. 57. In this simulation, a lens row pitch Plsr, a light emitting element group row pitch Pegr, a photosensitive drum diameter and other conditions are the same as in the working example 2. Differences Δfd shown in FIG. 58 are differences between image-photosensitive member distances fd1 to fd4 corresponding to the lenses LS1 to LS4 and the image-photosensitive member distance fd2. In other words, the differences Δfd among the image-photosensitive member distances fd1 to fd4 are calculated based on the image-photosensitive member distance fd2.

As shown in FIG. 58, the differences Δfd are 0 in the working example 6. In other words, the image-photosensitive member distances fd1 to fd4 are equal to each other. This is because the focus positions FP1 to FP4 of the light beams by the lenses LS1 to LS4 are adjusted to the positions in conformity with the curvature shape of the photosensitive drum 21 (substantially on the surface of the photosensitive drum 21 as shown in FIG. 52 in the working example 6) as shown in FIG. 52. As shown in a column “Spot Diameter” of FIG. 58, it can be understood that differences in the diameters of spots formed on the surface of the photosensitive drum 21 are suppressed by suppressing the differences of the image-photosensitive member distances fd1 to fd4. Specifically, the diameter of the spots formed by the lenses LS2, LS3 is 29.1 μm, and the diameter of the spots formed by the lenses LS1, LS4 are also 29.1 μm. Accordingly, a spot diameter difference in the working example 6 is 0 μm and a remarkable improvement as compared to the spot diameter difference of 11.1 μm in the working example 2 can be understood. In other words, the differences in the diameters of the spots formed by a plurality of lens rows LSR1 to LSR4 are further suppressed in the working example 6 as compared to the working example 2.

In this way, in the working example 6, the lens shapes (lens configurations), the lens thicknesses (lens configurations) and the lens positions of the lenses LS1 to LS4 belonging to the mutually different lens rows LSR are constructed such that the focus positions FF1 to FP4 of the light beams by the plurality of respective lenses LS1 to LS4 conform to the curvature shape of the surface of the photosensitive drum 21 (latent image carrier surface). Accordingly, an occurrence of such a problem that the distances between the focus positions and the latent image carrier surface (image-photosensitive member distances) differ depending on the lens rows LSR as described above can be suppressed. As a result, a satisfactory exposure can be advantageously realized by suppressing the differences in the spot diameters as shown in FIG. 58.

There are cases where pitch magnifications to be described later differ depending on the lenses LS if the lens configurations and the like of the lenses LS are constructed in conformity with the curvature shape of the photosensitive drum surface. Accordingly, the invention for realizing a satisfactory exposure even in the case of such differences in the pitch magnifications is described below.

### Working Example 7

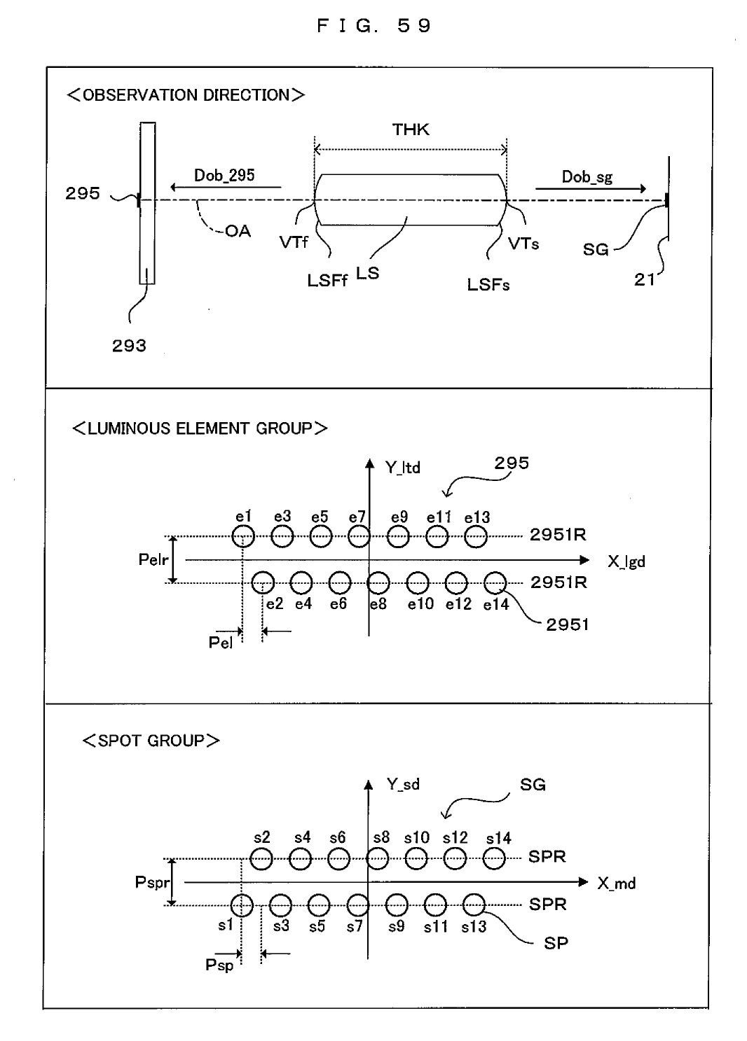

FIG. 59 is a chart showing the arrangement of light emitting elements and the formation positions of spots in a working example 7. As described above, a line head 29 is arranged such that lenses LS face light emitting element groups 295. Light beams emitted from a plurality of light emitting elements 2951 of the light emitting element groups 295 are focused toward the surface of the photosensitive drum 21 by the lenses LS. As a result, spot groups SG each comprised of a plurality of spots SP are formed on the surface of the photosensitive drum 21.

A section “Light emitting element group” of FIG. 59 shows the arrangement of the light emitting elements 2951 in the light emitting element group 295. A section “Spot Group” of FIG. 59 shows the spot group SG formed corresponding to such a light emitting element group 295. The section “Light emitting element group” of FIG. 59 shows the arrangement of the light emitting elements 2951 in the case where the light emitting element group 295 is seen in a light emitting element group observation direction Dob_295 shown in a section “Observation Direction” of FIG. 59. The section “Spot Group” shows the formation positions of the spots SP in the case where the spot group SG is seen in a spot group observation direction Dob_sg shown in the section “Observation Direction” of FIG. 59.

In the section “Light emitting element group” of FIG. 59, a coordinate axis X_lgd corresponds to the longitudinal direction LGD and a coordinate axis Y_ltd corresponds to the width direction LTD. The coordinate axes X_lgd, Y_ltd are provided for each light emitting element group 295. An optical axis OA of the lens LS the light emitting element group 295 is facing passes an intersection (that is, origin) of the coordinate axes X_lgd and Y_ltd for the light emitting element group 295.

In the section “Spot Group”, a coordinate axis X_md corresponds to the main scanning direction MD and a coordinate axis Y_sd corresponds to the sub scanning direction SD. The optical axis OA of the lens LS forming the spot group SG passes an intersection (that is, origin) of the coordinate axes X_md and Y_sd for the spot group SG.

As shown in the section “Light emitting element group” of FIG. 59, seven light emitting elements 2951 aligned in the direction of the coordinate axis X_lgd (that is, longitudinal direction LGD) constitute a light emitting element row 2951R. Two light emitting element rows 2951R are arranged in the direction of the coordinate axis Y_ltd (that is, width direction LTD). In other words, the light emitting element group 295 is comprised of fourteen light emitting elements 2951. The fourteen light emitting elements 2951 are arranged at light emitting element pitches Pel, and two light emitting element rows 2951R are arranged at a light emitting element row pitch Pelr. As shown in FIG. 59, the fourteen light emitting elements 2951 are respectively identified by light emitting element numbers e1 to e14.

As shown in the section “Spot Group” of FIG. 59, the spot group SG made up of fourteen spots SP is formed corresponding to the fourteen light emitting elements 2951. Working Example 7 corresponds to a case where spots are formed with the surface of the photosensitive drum 21 held stationary. It should be noted that any of working examples 7 to 14 described below corresponds to the case where spots are formed with the surface of the photosensitive drum 21 held stationary. Accordingly, the shape of the spot group SG formed on the surface of the photosensitive drum 21 is substantially similar to the shape of the light emitting element group 295. Specifically, seven spots SP aligned in the direction of the coordinate axis X_md (that is, main scanning direction MD) constitute a spot row SPR. Two spot rows SPR are arranged in the direction of the coordinate axes Y_sd (that is, sub scanning direction SD). In other words, the spot group SG is made up of the fourteen spots SP. The fourteen spots SP are formed at spot pitches Psp, and two spot rows SPR are formed at a spot row pitch Pspr. As shown in FIG. 59, the fourteen spots SP formed corresponding to the fourteen light emitting elements e1 to e14 are respectively assigned with spot numbers s1 to s14.

In this way, the spot group SG is formed at the spot pitches Psp by focusing the light beams emitted from the light emitting element group 295 arranged at the light emitting element pitches Pel by means of the lens LS corresponding to the light emitting element group 295. Accordingly, in this specification, a ratio of the spot pitch Psp to the light emitting element pitch Pel (that is, Psp/Pel) is defined to be the pitch magnification of the lens LS.

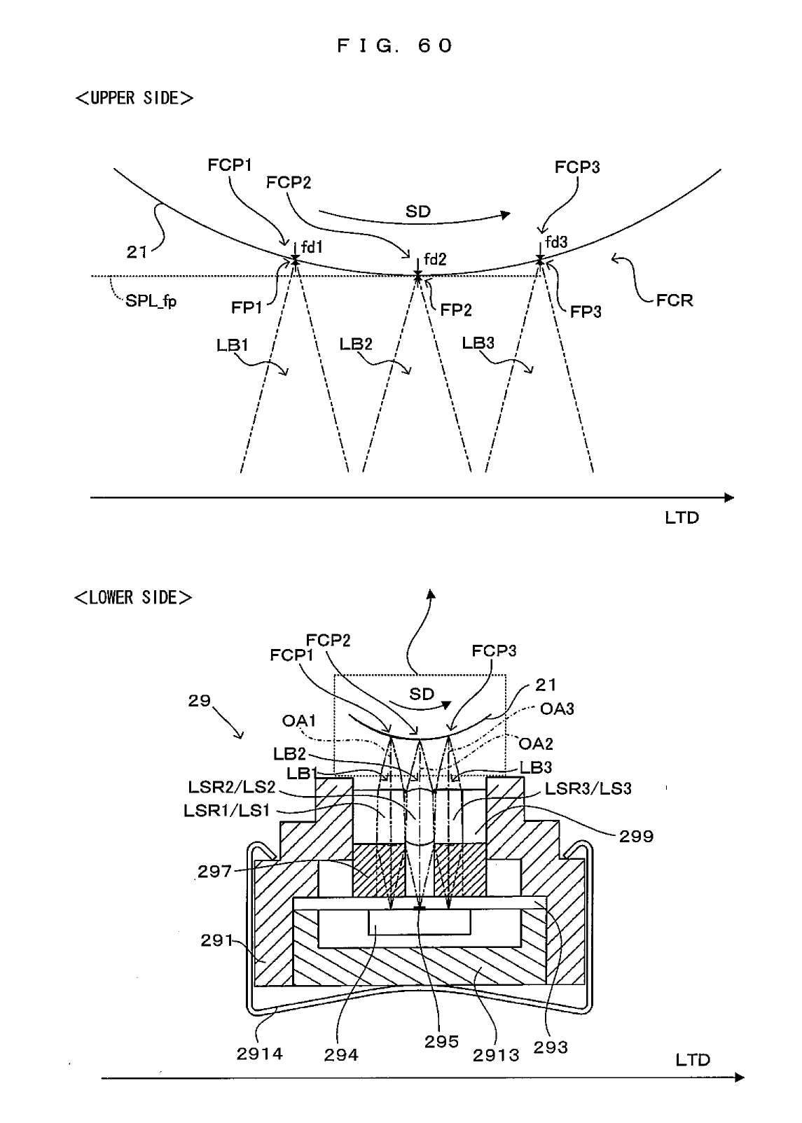

FIG. 60 is a sectional view along the sub scanning direction showing the relationship of arrangement of a lens array and a photosensitive drum according to a working example 7 of the invention. An upper side of FIG. 60 enlargedly shows a rectangular part enclosed by broken line in a lower side of FIG. 60. Lenses LS1 to LS3 in the lower side of FIG. 60 are lenses belonging to mutually different lens rows LSR1 to LSR3.

The relationship of arrangement of the lens array 299 and the photosensitive drum 21 in the working example 7 is the same as in the working example 1. Specifically, three lens rows LSR1 to LSR3 are arranged at lens row pitches Plsr in the width direction LTD and are substantially symmetrically arranged in the width direction LTD with respect to a symmetry axis SA. Further, the lens rows LSR1 to LSR3 are arranged such that optical axes OA1 to OA3 of the lenses LS1 to LS3 belonging to the lens rows LSR1 to LSR3 are parallel to each other. The lens array 299 is arranged such that the symmetry axis SA passes a curvature center CC21 of the photosensitive drum 21 (that is, rotation axis of the photosensitive drum 21).

The lens rows LSR1 to LSR3 are all arranged to face the surface of the photosensitive drum 21. At this time, the respective lens rows LSR1 to LSR3 face facing positions FCP1 to FCP3 of the photosensitive drum surface (latent image carrier surface) mutually different in the sub scanning direction SD. Accordingly, focus positions FP1 to FP3 of the light beams focused by the lenses LS1 to LS3 belonging to the different lens rows LSR1 to LSR3 mutually differ in the sub scanning direction SD.

Accordingly, if the lens configurations and the lens positions of all the lenses LS are the same as in the working example 1, spot diameter differences to such an extent as shown in the working example 1 occur. On the contrary, in the working example 7 of the invention, the focus positions FP1 to FP3 of the light beams by the lenses LS1 to LS3 are set at positions in conformity with the curvature shape of the surface of the photosensitive drum 21 (FIG. 60). The lens shapes of the lenses LS1 to LS3 are constructed to conform the focus positions FP1 to FP3 to the curvature shape in this way. This construction is specifically as follows.

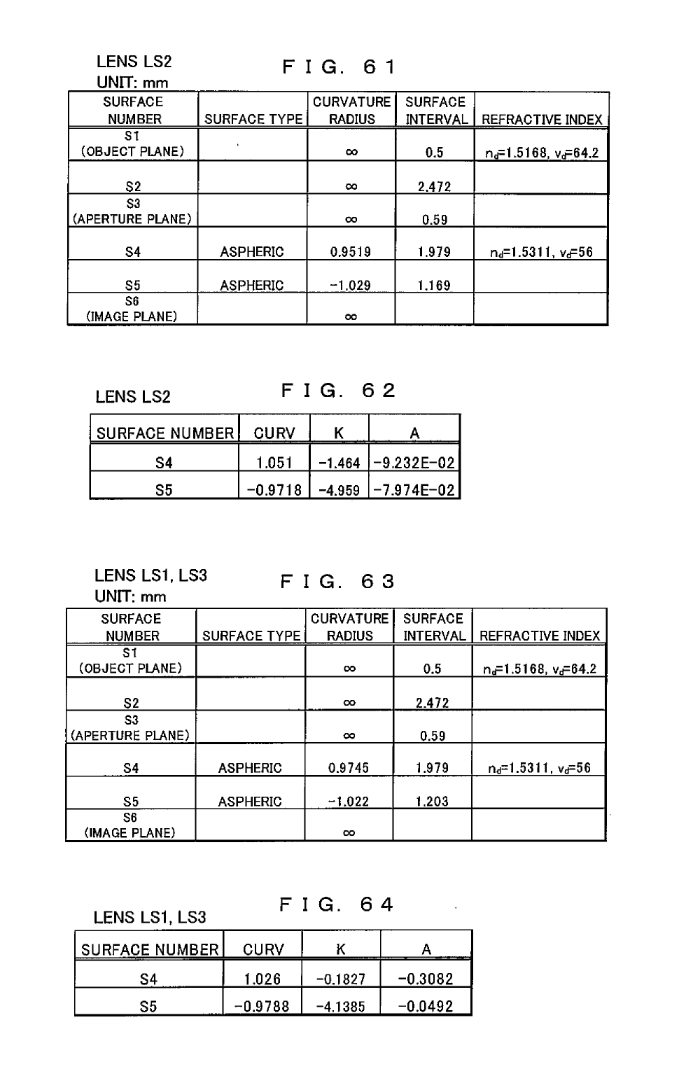

FIG. 61 shows the lens data of the lens LS2, and FIG. 62 shows the aspherical surface coefficient of the lens LS2. On the other hand, FIG. 63 shows the lens data of the lenses LS1, LS3, and FIG. 64 shows the aspherical surface coefficients of the lenses LS1, LS3. As can be understood from these data, the aspherical surface coefficients differ between the lens LS2 and lenses LS1, LS3 in the working example 7 (that is, the lens shapes are changed). The specification of an optical system used in a simulation of the working example 7 is similar to the contents shown in FIG. 19 of the working example 1. Thus, the lenses LS 1 and LS3 are the same in the working example 7 of the invention. On the other hand, the lenses LS1, LS3 differ from the lens LS2 in the lens shape.

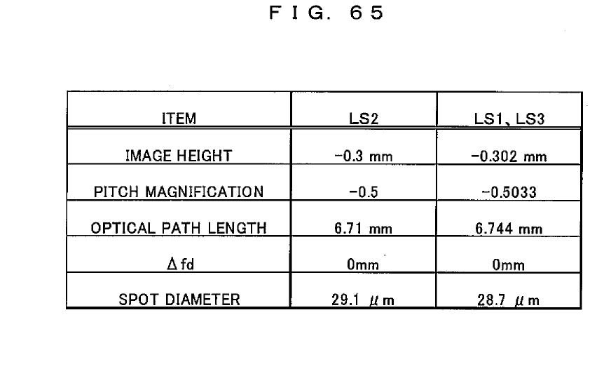

FIG. 65 shows a simulation result in the case where the lenses LS1 to LS3 are formed based on the data given by above FIG. 61 to FIG. 64. In this simulation, a lens row pitch Plsr, a light emitting element group row pitch Pegr, a photosensitive drum diameter and other conditions are the same as in the working example 1. Optical path lengths in FIG. 65 are those from the position of an object height of 0.6 mm (see FIG. 19) to the positions of image heights corresponding to the respective lenses LS1 to LS3 (according to FIG. 65, the image height corresponding to the lens LS2 is −0.3 mm and those corresponding to the lenses LS1, LS3 are −0.302 mm).

Differences Δfd shown in FIG. 65 are differences between image-photosensitive member distances fd1 to fd3 corresponding to the lenses LS1 to LS3 and the image-photosensitive member distance fd2. In other words, the differences Δfd among the image-photosensitive member distances fd1 to fd3 are calculated based on the image-photosensitive member distance fd2. As shown in FIG. 65, the differences Δfd are 0 in the working example 7. In other words, the image-photosensitive member distances fd1 to fd3 are equal to each other. This is because the focus positions FP1 to FP3 of the light beams by the lenses LS1 to LS3 are adjusted to the positions in conformity with the curvature shape of the photosensitive drum 21 (substantially on the surface of the photosensitive drum 21 as shown in FIG. 60 in the working example 7) as shown in FIG. 60. As shown in a column “Spot Diameter” of FIG. 65, it can be understood that differences in the diameters of spots formed on the surface of the photosensitive drum 21 are suppressed by suppressing the differences of the image-photosensitive member distances fd1 to fd3. Specifically, the diameter of the spots formed by the lens LS2 in the working example 7 is 29.1 μm, whereas the diameter of the spots formed by the lenses LS1, LS3 is 28.7 μm. Accordingly, a spot diameter difference in the working example 7 is 0.4 μm (=29.1 μm-28.7 μm) and an improvement as compared to the spot diameter difference of 3.2 μm in the working example 1 can be understood. In other words, in the working example 7, the differences in the diameters of the spots formed by a plurality of lens rows LSR1 to LSR3 are further suppressed as compared to the working example 1.

In this way, in the working example 7, the lens shapes (lens configurations) of the lenses LS1 to LS3 belonging to the mutually different lens rows LSR are constructed such that the focus positions FP1 to FP3 of the light beams by the plurality of respective lenses LS1 to LS3 conform to the curvature shape of the surface of the photosensitive drum 21 (latent image carrier surface). Accordingly, an occurrence of such a problem that the distances between the focus positions and the latent image carrier surface (image-photosensitive member distances) differ depending on the lens rows LSR as described above can be suppressed. As a result, a satisfactory exposure can be advantageously realized by suppressing the differences in the spot diameters as shown in FIG. 65.

As shown by pitch magnifications of FIG. 65, the pitch magnification of the lens LS2 and that of the lenses LS1, LS3 differ. Specifically, the pitch magnification of the lens LS2 is −0.5, whereas that of the lenses LS1, LS3 is −0.5033. The cause of such a difference in the pitch magnification among the lenses LS1 to LS3 results from the construction of the lens shapes of the respective lenses LS1 to LS3 to adjust as above. In other words, the pitch magnifications differ among the lenses LS1 to LS3 due to the construction of the lens shapes to suppress the differences in the diameters of the spots to be formed by the respective lenses LS1 to LS3. If there is such a difference in the pitch magnification when the light emitting element pitch Pel of the light emitting element groups 295 corresponding to the respective lenses LS1 to LS3 are constant, there are cases of inducing a problem that the spot pitches Psp of the spot groups SG formed by the respective lenses LS1 to LS3 differ depending on the spot groups SG. Specifically, the spot pitch Psp of the spot group SG formed by the lens LS having a large absolute value of the pitch magnification becomes relatively large, whereas the spot pitch formed by the lens LS having a small absolute value of the pitch magnification becomes relatively small. In other words, there is a possibility of an occurrence of such an exposure failure that the spot pitches Psp differ due to the differences in the pitch magnifications of the lenses LS.

In order to cope with such a problem, in the working example 7, the arrangement of the plurality of light emitting elements 2951 are adjusted in each light emitting element group 295 in accordance with the pitch magnification of the lens LS corresponding to the light emitting element group 295 so that the spot pitch Psp becomes constant independently of the spot groups SG. Specifically, in each light emitting element group 295, the light emitting element pitch Pel and the light emitting element row pitch Pelr are adjusted in accordance with the pitch magnification of the lens LS corresponding to this light emitting element group 295 as described below.

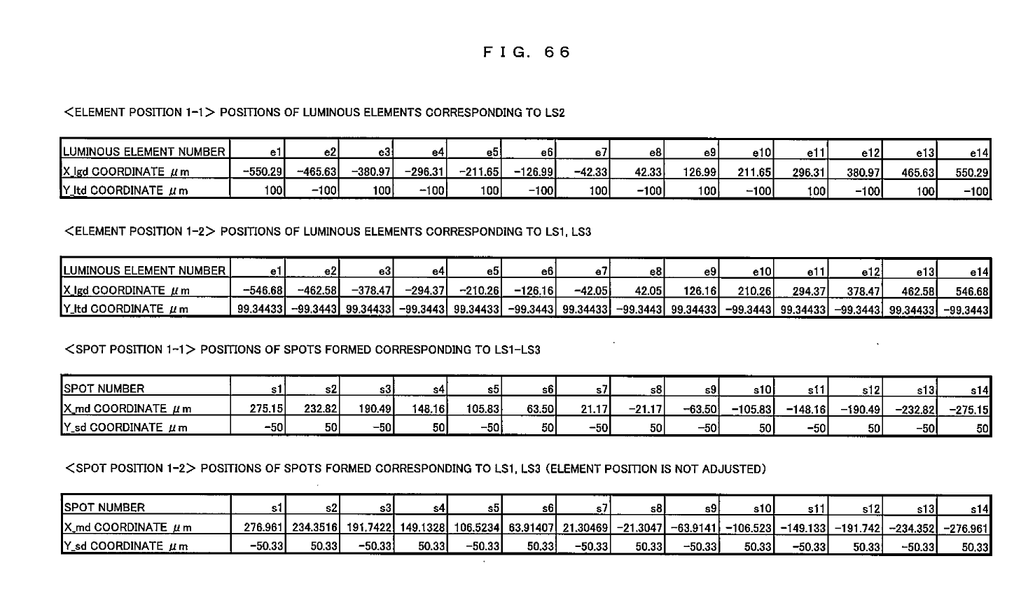

FIG. 66 is a group of tables showing the arrangement of the light emitting elements and the formation positions of the spots in the working example 7. Light emitting element numbers e1 to e14 in FIG. 66 are the numbers assigned to the respective light emitting elements 2951 constituting the light emitting element group 295 in FIG. 59. Coordinate axes X_lgd, Y_ltd are coordinate axes provided for each light emitting element group 295 in FIG. 59. In other words, the table titled with “Element Position 1-1” shows the positions of the light emitting elements e1 to e14 in the light emitting element group 295 corresponding to the lens LS2, and the table titled with “Element Position 1-2” shows the positions of the light emitting elements e1 to e14 in the light emitting element groups 295 corresponding to the lenses LS1, LS3.

Spot numbers s1 to s14 in FIG. 66 are the numbers assigned to the respective spots SP constituting the spot group SG in FIG. 59. Coordinate axes X_md, Y_sd are coordinate axes provided for each spot group SG in FIG. 59. In other words, the tables titled with “Spot Position 1-1” and “Spot Position 1-2” show the positions of the spots s1 to s14 in the spot groups SG formed on the photosensitive drum surface.

The light emitting element pitch Pel and the light emitting element row pitch Pelr are calculated from these tables shown in FIG. 66. The light emitting element pitch Pel is calculated from a difference in the X_lgd coordinate positions of the respective light emitting elements (e.g. light emitting elements e1, e2) adjacent in the direction of the X_lgd coordinate. The light emitting element row pitch Pelr is calculated from a difference in the Y_ltd coordinate positions of the respective light emitting elements (e.g. light emitting elements e1, e2) adjacent in the direction of the Y_ltd coordinate.

In the light emitting element group 295 corresponding to the lens LS2, the light emitting element pitch Pel is 84.66 μm and the light emitting element row pitch Pelr is 200 μm. On the other hand, in the light emitting element groups 295 corresponding to the lenses LS1, LS3, the light emitting element pitch Pel is 84.1 μm and the light emitting element row pitch Pelr is 198.7 μm. Thus, in the working example 7, the light emitting element pitch Pel and the light emitting element row pitch Pelr of the light emitting element group 295 corresponding to the lens LS2 are larger than those of the light emitting element groups 295 corresponding to the lenses LS1, LS3.

Specifically, as shown in FIG. 65, the pitch magnification of the lens LS2 is smaller in absolute value than that of the lenses LS1, LS3. Accordingly, if the light emitting element pitch Pel and the light emitting element row pitch Pelr are made equal in all the light emitting element groups 295, the spot pitch Psp of the spot group SG by the lens LS2 is smaller than that of the spot groups SG by the lenses LS1, LS3, and the spot row pitch Pspr of the spot group SG by the lens LS2 is smaller than that of the spot groups SG by the lenses LS1, LS3. Therefore, the spot pitch Psp and the spot row pitch Pspr differ depending on the spot groups SG.

Accordingly, in the working example 7, the light emitting element pitch Pel and the light emitting element row pitch Pelr of the light emitting element group 295 corresponding to the lens LS2 are made larger than those of the light emitting element groups 295 corresponding to the lenses LS1, LS3 based on the fact that the absolute value of the pitch magnification of the lens LS2 is smaller than that of the pitch magnification of the lenses LS1, LS3. Specifically, the arrangement of the light emitting elements 2951 are adjusted in each light emitting element group 295 such that a product of the light emitting element pitch Pel and the pitch magnification of the lens LS corresponding to this light emitting element group 295 is made substantially equal to a specified spot pitch Psp and a product of the light emitting element row pitch Pelr and the pitch magnification of the lens LS corresponding to this light emitting element group 295 is made substantially equal to a specified spot row pitch Pspr.

The table of FIG. 66 titled with the “Spot Position 1-1” shows the formation positions of the spots SP in the case where the arrangement of the light emitting elements 2951 are adjusted in accordance with the pitch magnification of the lens LS as described above. In other words, this table of FIG. 66 shows the positions of the spots SP in the spot groups SG formed by the respective lenses LS1 to LS3. Thus, in the working example 7, the spot pitch Psp is 42.34 μm and the spot row pitch Pspr is 100 μm in each spot group SG. In other words, the spot pitch Psp and the spot row pitch Pspr are constant independently of the spot groups SG. The spot pitch Psp is calculated from a difference in X_md coordinate positions of the respective spots (e.g. spots s1, s2) adjacent to each other in the direction of the X_md coordinate. The spot row pitch Pspr is calculated from a difference in Y_sd coordinate positions of the respective spots (e.g. spots s1, s2) adjacent to each other in the direction of the Y_sd coordinate.

The table of FIG. 66 titled with “Spot Position 1-2” shows the formation positions of the spots SP in the spot groups SG formed by the lenses LS1, LS3 in the case where the light emitting elements 2951 are arranged as shown in “Element Position 1-1” of FIG. 66 in all the light emitting element groups 295. At this time, the formation positions of the spots SP in the spot group SG formed by the lens LS2 are as shown in “Spot Position 1-1”. From these tables, the spot pitch Psp of the spot groups SG formed by the lenses LS1, LS3 is 42.61 μm and different from the spot pitch of 42.34 μm of the spot group SG formed by the lens LS2. The spot row pitch Pspr of the spot groups SG formed by the lenses LS1, LS3 is 100.66 μm and different from the spot row pitch of 100 μm of the spot group SG formed by the lens LS2. In other words, by identically arranging the light emitting elements 2951 in all the light emitting element groups 295, there occurs such an exposure failure that the spot pitch Psp and the spot row pitch Psgr differ depending on the spot groups SG.

In this way, in the working example 7, the arrangement of the plurality of light emitting elements 2951 is adjusted in each light emitting element group 295 in accordance with the pitch magnification of the lens LS corresponding to the light emitting element group 295 so that the spot pitch Psp becomes constant independently of the spot groups SG. Accordingly, even if the pitch magnification differs depending on the lenses LS due to the construction of the lens shapes (lens configurations) of the lenses LS, the spot pitches Psp of the plurality of spots SP formed on the photosensitive drum surface (latent image carrier surface) are substantially constant independently of the spot groups SG. This is preferable since a satisfactory spot formation is possible.

In the working example 7, the focus positions FP1 to FP3 are set at the positions in conformity with the curvature shape of the surface of the photosensitive drum 21 by adjusting the lens shapes. However, the lens positions of the lenses LS may be constructed to adjust as above, for example, as shown in a working example 8 below.

### Working Example 8

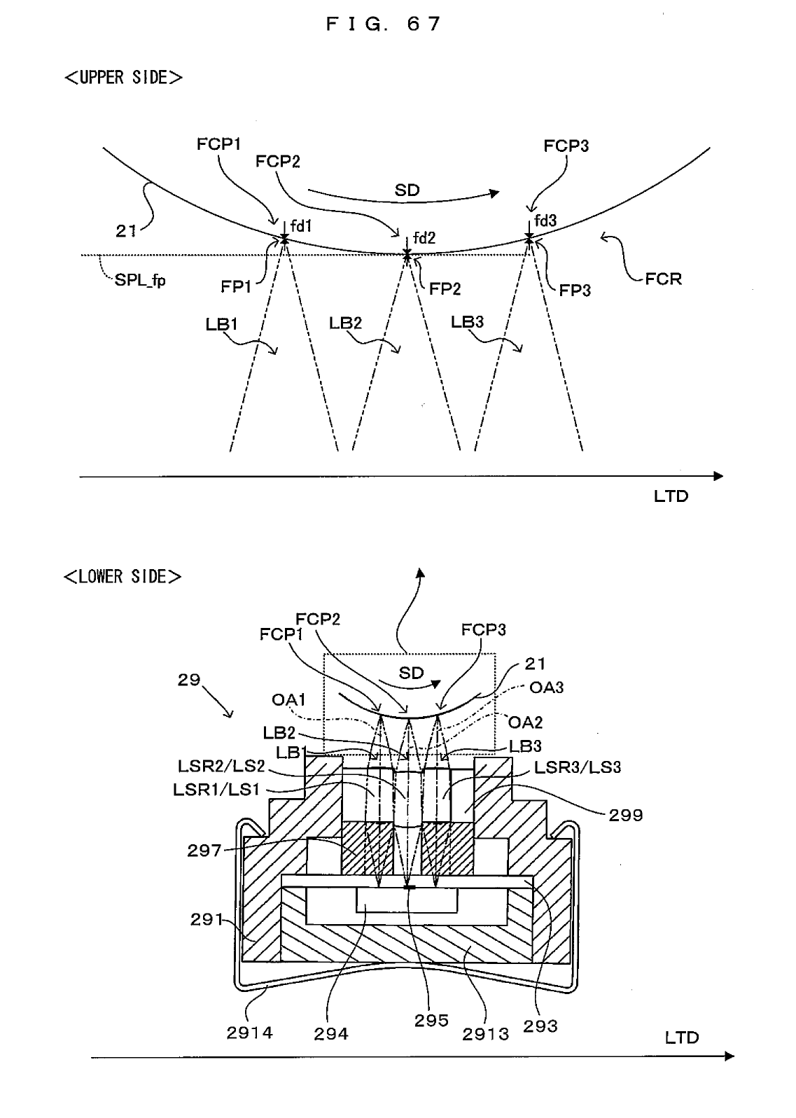

FIG. 67 is a sectional view along the sub scanning direction showing the relationship of arrangement of a lens array and a photosensitive drum according to the working example 8 of the invention. An upper side of FIG. 67 enlargedly shows a rectangular part enclosed by broken line in a lower side of FIG. 67. Lenses LS1 to LS3 in the lower side of FIG. 67 are lenses belonging to mutually different lens rows LSR1 to LSR3.

The relationship of arrangement of the lens array 299 and the photosensitive drum 21 in the working example 8 is the same as in the working example 1. Specifically, the respective lens rows LSR1 to LSR3 face facing positions FCP1 to FCP3 of the photosensitive drum surface (latent image carrier surface) mutually different in the sub scanning direction SD. Accordingly, focus positions FP1 to FP3 of light beams focused by the lenses LS1 to LS3 belonging to the different lens rows LSR1 to LSR3 mutually differ in the sub scanning direction SD. Thus, if the lens configurations and the lens positions of all the lenses FL are the same as in the working example 1, spot diameter differences to such an extent as shown in the working example 1 occur. On the contrary, in the working example 8 of the invention, the focus positions FP1 to FP3 of the light beams by the lenses LS1 to LS3 are set at positions in conformity with the curvature shape of the surface of the photosensitive drum 21 (FIG. 67). The lens positions of the lenses LS1 to LS3 are constructed to conform the focus positions FP1 to FP3 to the curvature shape in this way. This construction is specifically as follows.

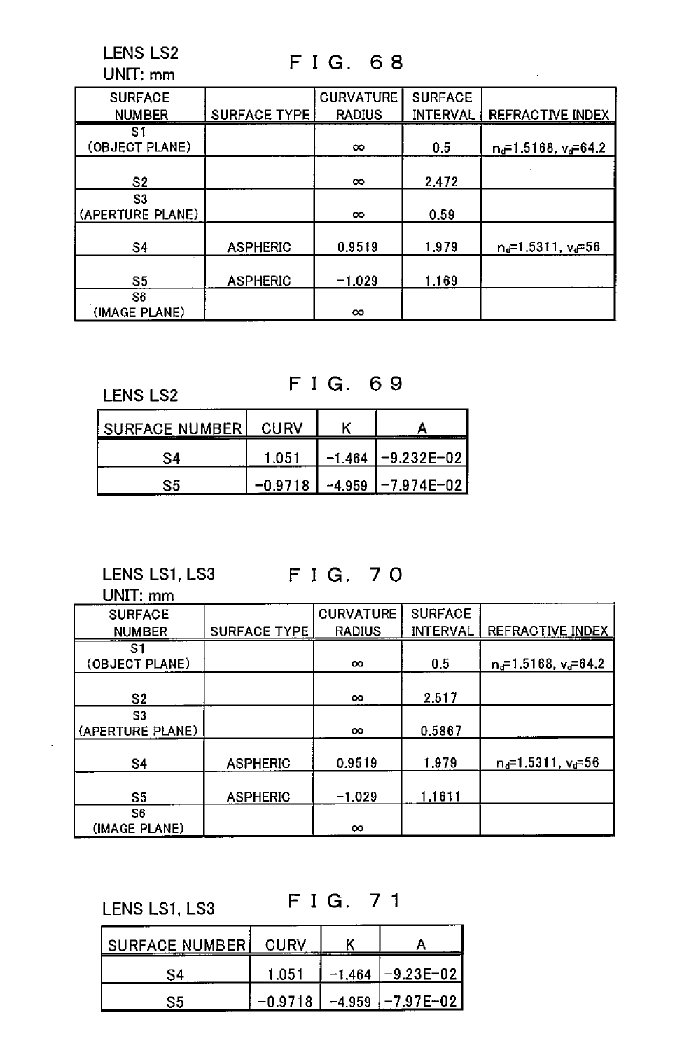

FIG. 68 shows the lens data of the lens LS2, and FIG. 69 shows the aspherical surface coefficient of the lens LS2. On the other hand, FIG. 70 shows the lens data of the lenses LS1, LS3, and FIG. 71 shows the aspherical surface coefficients of the lenses LS1, LS3. As can be understood from a difference in the sum of the surface intervals from the surface number S1 to the surface number S3 between FIG. 68 and FIG. 70, the lens positions differ between the lens LS2 and the lenses LS1, LS3 in the working example 8. The specification of an optical system used in a simulation of the working example 8 is similar to the contents shown in FIG. 19 of the working example 1. Thus, the lenses LS1 and LS3 are the same in the working example 8 of the invention. On the other hand, the lenses LS1, LS3 differ from the lens LS2 in the lens position.

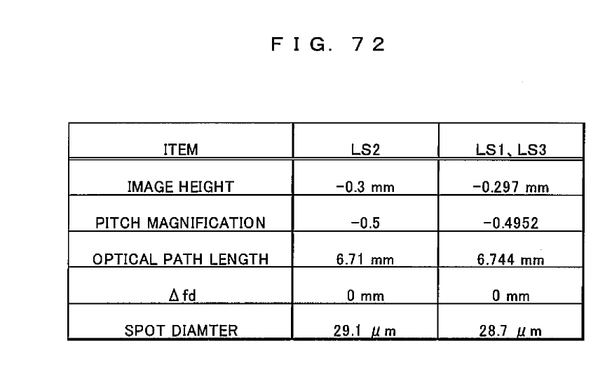

FIG. 72 shows a simulation result in the case where the lenses LS1 to LS3 are formed based on the data given by above FIG. 68 to FIG. 71. In this simulation, a lens row pitch Plsr, a light emitting element group row pitch Pegr, a photosensitive drum diameter and other conditions are the same as in the working example 1. Optical path lengths in FIG. 72 are those from the position of an object height of 0.6 mm (see FIG. 19) to the positions of image heights corresponding to the respective lenses LS1 to LS3 (according to FIG. 72, the image height corresponding to the lens LS2 is −0.3 mm and those corresponding to the lenses LS1, LS3 are −0.297 mm).

Differences Δfd shown in FIG. 72 are differences between image-photosensitive member distances fd1 to fd3 corresponding to the lenses LS1 to LS3 and the image-photosensitive member distance fd2. In other words, the differences Δfd among the image-photosensitive member distances fd1 to fd3 are calculated based on the image-photosensitive member distance fd2. As shown in FIG. 72, the differences Δfd are 0 in the working example 8. In other words, the image-photosensitive member distances fd1 to fd3 are equal to each other. This is because the focus positions FP1 to FP3 of the light beams by the lenses LS1 to LS3 are adjusted to the positions in conformity with the curvature shape of the photosensitive drum 21 (substantially on the surface of the photosensitive drum 21 as shown in FIG. 67 in the working example 8) as shown in FIG. 67. As shown in a column “Spot Diameter” of FIG. 72, it can be understood that differences in the diameters of spots formed on the surface of the photosensitive drum 21 are suppressed by suppressing the differences of the image-photosensitive member distances fd1 to fd3. Specifically, the diameter of the spots formed by the lens LS2 in the working example 8 is 29.1 μm, whereas the diameter of the spots formed by the lenses LS1, LS3 is 28.7 μm. Accordingly, a difference between the spot diameter by the lens LS2 and the one by the lenses LS1, LS3 in the working example 8 is 0.4 μm (=29.1 μm-28.7 μm) and an improvement as compared to the spot diameter difference of 3.2 μm in the working example 1 can be understood. In other words, in the working example 8, the differences in the diameters of the spots formed by a plurality of lens rows LSR1 to LSR3 are further suppressed as compared to the working example 1.

In this way, in the working example 8, the lens positions of the lenses LS1 to LS3 belonging to the mutually different lens rows LSR are constructed such that the focus positions FP1 to FP3 of the light beams by the plurality of respective lenses LS1 to LS3 conform to the curvature shape of the surface of the photosensitive drum 21 (latent image carrier surface). Accordingly, an occurrence of such a problem that the distances between the focus positions and the latent image carrier surface (image-photosensitive member distances) differ depending on the lens rows LSR as described above can be suppressed. As a result, a satisfactory exposure can be advantageously realized by suppressing the differences in the spot diameters as shown in FIG. 72.

As shown by pitch magnifications of FIG. 72, the pitch magnification of the lens LS2 and that of the lenses LS1, LS3 differ. Specifically, the pitch magnification of the lens LS2 is −0.5, whereas that of the lenses LS1, LS3 is −0.4952. The cause of such a difference in the pitch magnification among the lenses LS1 to LS3 results from the construction of the lens positions of the respective lenses LS1 to LS3 to adjust as above. In other words, the pitch magnifications differ among the lenses LS1 to LS3 due to the construction of the lens positions to suppress the occurrence of such an exposure failure that the diameters of the spots to be formed by the respective lenses LS1 to LS3 differ. Accordingly, there is a possibility of an occurrence of such an exposure failure that the spot pitches Psp differ due to the differences in the pitch magnifications of the lenses LS as described in the working example 7.

In order to cope with such a problem, in the working example 8, the arrangement of the plurality of light emitting elements 2951 are adjusted in each light emitting element group 295 in accordance with the pitch magnification of the lens LS corresponding to the light emitting element group 295 so that the spot pitch Psp becomes constant independently of the spot groups SG. Specifically, in each light emitting element group 295, the light emitting element pitch Pel and the light emitting element row pitch Pelr are adjusted in accordance with the pitch magnification of the lens LS corresponding to this light emitting element group 295 as described below.

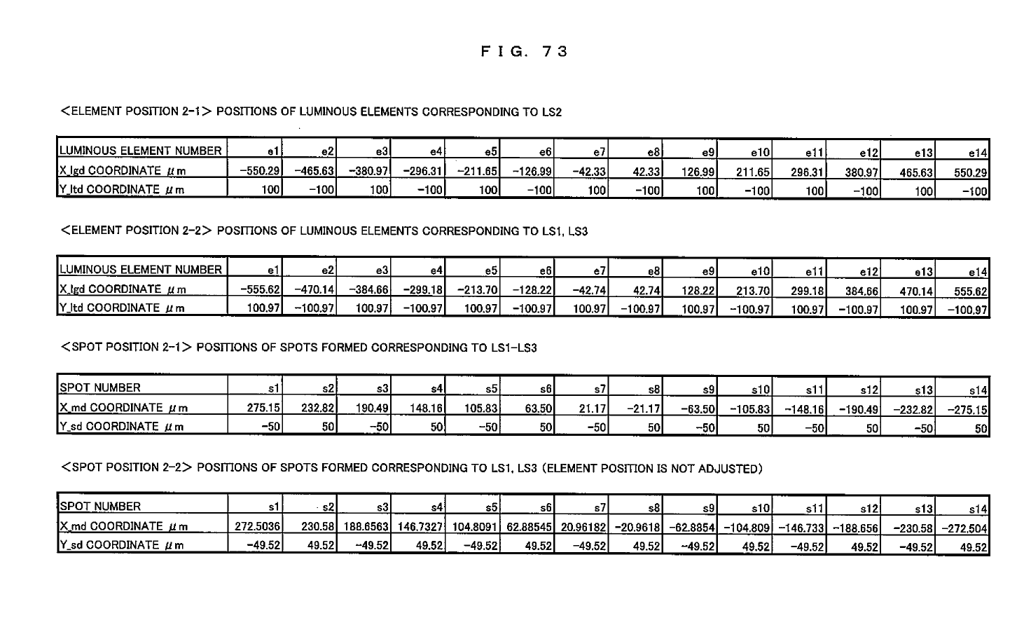

FIG. 73 is a group of tables showing the arrangement of the light emitting elements and the formation positions of the spots in the working example 8. In FIG. 73, the table titled with “Element Position 2-1” shows the positions of light emitting elements e1 to e14 in the light emitting element group 295 corresponding to the lens LS2, and the table titled with “Element Position 2-2” shows the positions of light emitting elements e1 to e14 in the light emitting element groups 295 corresponding to the lenses LS1, LS3. Further, the tables titled with “Spot Position 2-1” and “Spot Position 2-2” show the positions of spots s1 to s14 in the spot group SG formed on the photosensitive drum surface.

The light emitting element pitch Pel and the light emitting element row pitch Pelr are calculated from these tables shown in FIG. 73. In the light emitting element group 295 corresponding to the lens LS2, the light emitting element pitch Pel is 84.66 μm and the light emitting element row pitch Pelr is 200 μm. On the other hand, in the light emitting element groups 295 corresponding to the lenses LS1, LS3, the light emitting element pitch Pel is 85.48 μm and the light emitting element row pitch Pelr is 201.94 μm. Thus, in the working example 8, the light emitting element pitch Pel and the light emitting element row pitch Pelr of the light emitting element group 295 corresponding to the lens LS2 are smaller than those of the light emitting element groups 295 corresponding to the lenses LS1, LS3.

Specifically, as shown in FIG. 72, the pitch magnification of the lens LS2 is larger in absolute value than the pitch magnification of the lenses LS1, LS3. Accordingly, if the light emitting element pitch Pel and the light emitting element row pitch Pelr are the same in all the light emitting element groups 295, the spot pitch Psp of the spot group SG by the lens LS2 becomes larger than the spot pitch Psp of the spot groups SG by the lenses LS1, LS3 and the spot row pitch Pspr of the spot group SG by the lens LS2 becomes larger than the spot row pitch Pspr of the spot groups SG by the lenses LS1, LS3. Therefore, the spot pitch Psp and the spot row pitch Pspr differ depending on the spot groups SG.

Accordingly, in the working example 8, the light emitting element pitch Pel and the light emitting element row pitch Pelr of the light emitting element group 295 corresponding to the lens LS2 are made smaller than those of the light emitting element groups 295 corresponding to the lenses LS1, LS3 based on the fact that the absolute value of the pitch magnification of the lens LS2 is larger than that of the pitch magnification of the lenses LS1, LS3. Specifically, the arrangement of the light emitting elements 2951 is adjusted in each light emitting element group 295 such that a product of the light emitting element pitch Pel and the pitch magnification of the lens LS corresponding to the light emitting element group 295 is substantially equal to a specified spot pitch Psp and a product of the light emitting element row pitch Pelr and the pitch magnification of the lens LS corresponding to the light emitting element group 295 is substantially equal to a specified spot row pitch Pspr.

The table titled with “Spot Position 2-1” in FIG. 73 shows the formation positions of the spots SP in the case where the arrangement of the light emitting elements 2951 is adjusted in accordance with the pitch magnification of the lens LS as described above. In other words, this table in FIG. 73 shows the positions of the spots SP in the spot group SG formed by each of the lenses LS1 to LS3. Thus, in the working example 8, the spot pitch Psp is 42.34 μm and the spot row pitch Pspr is 100 μm in each spot group SG. In other words, the spot pitch Psp and the spot row pitch Pspr are constant independently of the spot groups SG.

The table of FIG. 73 titled with “Spot Position 2-2” shows the formation positions of the spots SP in the spot groups SG formed by the lenses LS1, LS3 in the case where the light emitting elements 2951 are arranged as shown in “Element Position 2-1” of FIG. 73 in all the light emitting element groups 295. At this time, the formation positions of the spots SP in the spot group SG formed by the lens LS2 are as shown in “Spot Position 2-1”. From these tables, the spot pitch Psp of the spot groups SG formed by the lenses LS1, LS3 is 41.92 μm and different from the spot pitch of 42.34 μm of the spot group SG formed by the lenses LS2. The spot row pitch Pspr of the spot groups SG formed by the lenses LS1, LS3 is 99.04 μm and different from the spot row pitch of 100 μm of the spot group SG formed by the lens LS2. In other words, by identically arranging the light emitting elements 2951 in all the light emitting element groups 295, there occurs such an exposure failure that the spot pitch Psp and the spot row pitch Psgr differ depending on the spot groups SG.

In this way, in the working example 8, the arrangement of the plurality of light emitting elements 2951 is adjusted in each light emitting element group 295 in accordance with the pitch magnification of the lens LS corresponding to the light emitting element group 295 so that the spot pitch Psp becomes constant independently of the spot groups SG. Accordingly, even if the pitch magnification differs depending on the lenses LS due to the construction of the lens positions of the lenses LS, the spot pitches Psp of the plurality of spots SP formed on the photosensitive drum surface (latent image carrier surface) are substantially constant independently of the spot groups SG. This is preferable since a satisfactory spot formation is possible.

In the working example 8, the focus positions FP1 to FP3 are set at the positions in conformity with the curvature shape of the surface of the photosensitive drum 21 by adjusting the lens positions. However, the lens thicknesses (lens configurations) of the lenses LS may be constructed to adjust as above, for example, as shown in a working example 9 below.

### Working Example 9

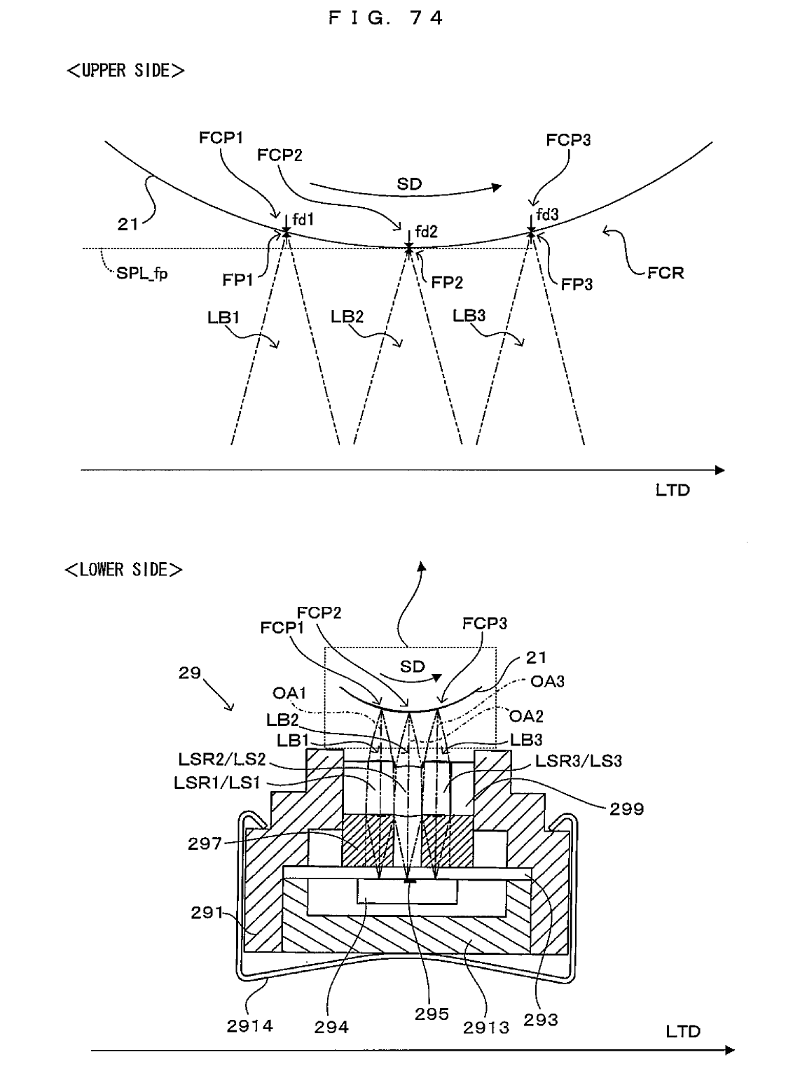

FIG. 74 is a sectional view along the sub scanning direction showing the relationship of arrangement of a lens array and a photosensitive drum according to the working example 9 of the invention. An upper side of FIG. 74 enlargedly shows a rectangular part enclosed by broken line in a lower side of FIG. 74. Lenses LS1 to LS3 in the lower side of FIG. 74 are lenses belonging to mutually different lens rows LSR1 to LSR3.

The relationship of arrangement of the lens array 299 and the photosensitive drum 21 in the working example 9 is the same as in the working example 1. Specifically, the respective lens rows LSR1 to LSR3 face facing positions FCP1 to FCP3 of the photosensitive drum surface (latent image carrier surface) mutually different in the sub scanning direction SD. Accordingly, focus positions FP1 to FP3 of light beams focused by the lenses LS1 to LS3 belonging to the different lens rows LSR1 to LSR3 mutually differ in the sub scanning direction SD. Thus, if the lens configurations and the lens positions of all the lenses LS are the same as in the working example 1, spot diameter differences to such an extent as shown in the working example 1 occur. On the contrary, in the working example 9 of the invention, the focus positions FP1 to FP3 of the light beams by the lenses LS1 to LS3 are set at positions in conformity with the curvature shape of the surface of the photosensitive drum 21 (FIG. 74). The lens thicknesses (lens configurations) of the lenses LS1 to LS3 are constructed to conform the focus positions FP1 to FP3 to the curvature shape in this way. This construction is specifically as follows.

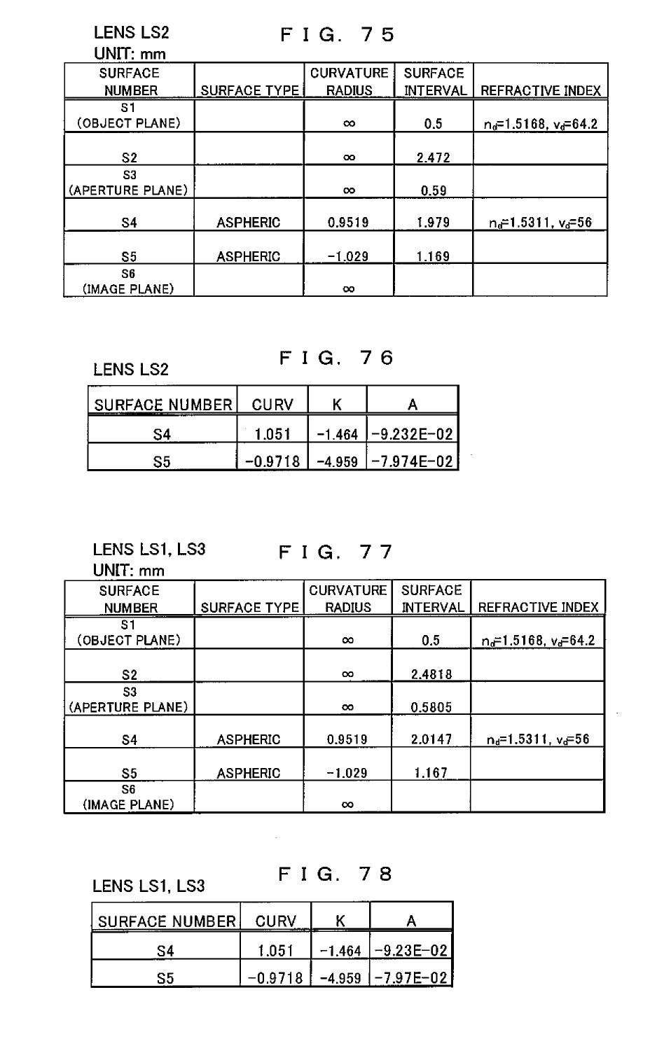

FIG. 75 shows the lens data of the lens LS2, and FIG. 76 shows the aspherical surface coefficient of the lens LS2. On the other hand, FIG. 77 shows the lens data of the lenses LS1, LS3, and FIG. 78 shows the aspherical surface coefficients of the lenses LS1, LS3. As can be understood from a difference in the surface interval of the surface number S4 between FIG. 75 and FIG. 77, the lens thicknesses differ between the lens LS2 and the lenses LS1, LS3 in the working example 9. The specification of an optical system used in a simulation of the working example 9 is similar to the contents shown in FIG. 19 of the working example 1. Thus, the lenses LS1 and LS3 are the same in the working example 9 of the invention. On the other hand, the lenses LS1, LS3 differ from the lens LS2 in the lens thickness.

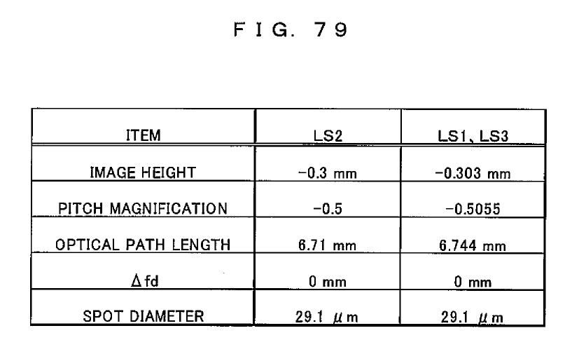

FIG. 79 shows a simulation result in the case where the lenses LS1 to LS3 are formed based on the data given by above FIG. 75 to FIG. 78. In this simulation, a lens row pitch Plsr, a light emitting element group row pitch Pegr, a photosensitive drum diameter and other conditions are the same as in the working example 1. Optical path lengths in FIG. 79 are those from the position of an object height of 0.6 mm (see FIG. 19) to the positions of image heights corresponding to the respective lenses LS1 to LS3 (according to FIG. 79, the image height corresponding to the lens LS2 is −0.3 mm and those corresponding to the lenses LS1, LS3 are −0.303 mm).

Differences Δfd shown in FIG. 79 are differences between image-photosensitive member distances fd1 to fd3 corresponding to the lenses LS1 to LS3 and the image-photosensitive member distance fd2. In other words, the differences Δfd among the image-photosensitive member distances fd1 to fd3 are calculated based on the image-photosensitive member distance fd2. As shown in FIG. 79, the differences Δfd are 0 in the working example 9. In other words, the image-photosensitive member distances fd1 to fd3 are equal to each other. This is because the focus positions FP1 to FP3 of the light beams by the lenses LS1 to LS3 are adjusted to the positions in conformity with the curvature shape of the photosensitive drum 21 (substantially on the surface of the photosensitive drum 21 as shown in FIG. 74 in the working example 9) as shown in FIG. 74. As shown in a column “Spot Diameter” of FIG. 79, it can be understood that differences in the diameters of spots formed on the surface of the photosensitive drum 21 are suppressed by suppressing the differences of the image-photosensitive member distances fd1 to fd3. Specifically, the diameter of the spots formed by the lens LS2 in the working example 9 is 29.1 μm, and the diameter of the spots formed by the lenses LS1, LS3 is also 29.1 μm. Accordingly, a difference between the spot diameter by the lens LS2 and the one by the lenses LS1, LS3 in the working example 9 is 0 μm (=29.1 μm-29.1 μm) and a remarkable improvement as compared to the spot diameter difference of 3.2 μm in the working example 1 can be understood. In other words, in the working example 9, the differences in the diameters of the spots formed by a plurality of lens rows LSR1 to LSR3 are further suppressed as compared to the working example 1.

In this way, in the working example 9, the lens thicknesses of the lenses LS1 to LS3 belonging to the mutually different lens rows LSR are constructed such that the focus positions FP1 to FP3 of the light beams by the plurality of respective lenses LS1 to LS3 conform to the curvature shape of the surface of the photosensitive drum 21 (latent image carrier surface). Accordingly, an occurrence of such a problem that the distances between the focus positions and the latent image carrier surface (image-photosensitive member distances) differ depending on the lens rows LSR as described above can be suppressed. As a result, a satisfactory exposure can be advantageously realized by suppressing the differences in the spot diameters as shown in FIG. 79.

As shown by pitch magnifications of FIG. 79, the pitch magnification of the lens LS2 and that of the lenses LS1, LS3 differ. Specifically, the pitch magnification of the lens LS2 is −0.5, whereas that of the lenses LS1, LS3 is −0.5055. The cause of such a difference in the pitch magnification among the lenses LS1 to LS3 results from the construction of the lens thicknesses of the respective lenses LS1 to LS3 to adjust as above. In other words, the pitch magnifications differ among the lenses LS1 to LS3 due to the construction of the lens thicknesses to suppress the occurrence of such an exposure failure that the diameters of the spots to be formed by the respective lenses LS1 to LS3 differ. Accordingly, there is a possibility of an occurrence of such an exposure failure that the spot pitches Psp differ due to the differences in the pitch magnifications of the lenses LS as described in the working example 7.

In order to cope with such a problem, in the working example 9, the arrangement of the plurality of light emitting elements 2951 are adjusted in each light emitting element group 295 in accordance with the pitch magnification of the lens LS corresponding to the light emitting element group 295 so that the spot pitch Psp becomes constant independently of the spot groups SG. Specifically, in each light emitting element group 295, the light emitting element pitch Pel and the light emitting element row pitch Pelr are adjusted in accordance with the pitch magnification of the lens LS corresponding to this light emitting element group 295 as described below.

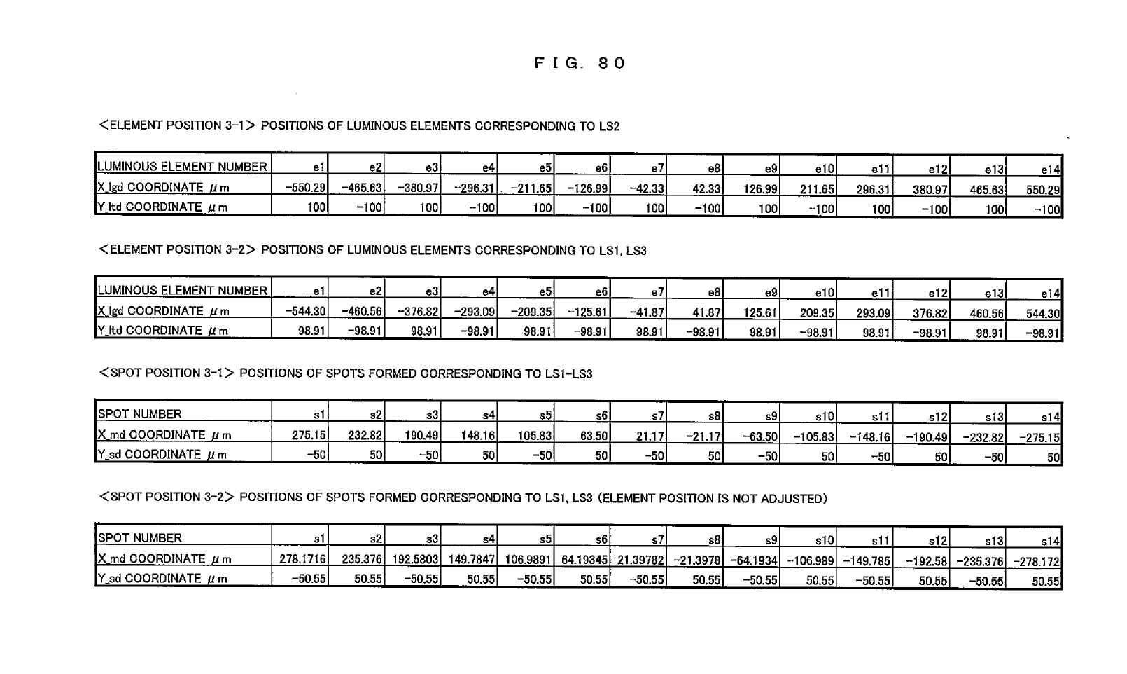

FIG. 80 is a group of tables showing the arrangement of the light emitting elements and the formation positions of the spots in the working example 9. In FIG. 80, the table titled with “Element Position 3-1” shows the positions of light emitting elements e1 to e14 in the light emitting element group 295 corresponding to the lens LS2, and the table titled with “Element Position 3-2” shows the positions of light emitting elements e1 to e14 in the light emitting element groups 295 corresponding to the lenses LS1, LS3. Further, the tables titled with “Spot Position 3-1” and “Spot Position 3-2” show the positions of spots s1 to s14 in the spot group SG formed on the photosensitive drum surface.

The light emitting element pitch Pel and the light emitting element row pitch Pelr are calculated from these tables shown in FIG. 80. In the light emitting element group 295 corresponding to the lens LS2, the light emitting element pitch Pel is 84.66 μm and the light emitting element row pitch Pelr is 200 μm. On the other hand, in the light emitting element groups 295 corresponding to the lenses LS1, LS3, the light emitting element pitch Pel is 83.74 μm and the light emitting element row pitch Pelr is 197.82 μm. Thus, in the working example 9, the light emitting element pitch Pel and the light emitting element row pitch Pelr of the light emitting element group 295 corresponding to the lens LS2 are larger than those of the light emitting element groups 295 corresponding to the lenses LS1, LS3.

Specifically, as shown in FIG. 79, the pitch magnification of the lens LS2 is smaller in absolute value than the pitch magnification of the tenses LS1, LS3. Accordingly, if the light emitting element pitch Pel and the light emitting element row pitch Pelr are the same in all the light emitting element groups 295, the spot pitch Psp of the spot group SG by the lens LS2 becomes smaller than the spot pitch Psp of the spot groups SG by the lenses LS1, LS3 and the spot row pitch Pspr of the spot group SG by the lens LS2 becomes smaller than the spot row pitch Pspr of the spot groups SG by the lenses LS1, LS3. Therefore, the spot pitch Psp and the spot row pitch Pspr differ depending on the spot groups SG.

Accordingly, in the working example 9, the light emitting element pitch Pel and the light emitting element row pitch Pelr of the light emitting element group 295 corresponding to the lens LS2 are made larger than those of the light emitting element groups 295 corresponding to the lenses LS1, LS3 based on the fact that the absolute value of the pitch magnification of the lens LS2 is smaller than that of the pitch magnification of the lenses LS1, LS3. Specifically, the arrangement of the light emitting elements 2951 is adjusted in each light emitting element group 295 such that a product of the light emitting element pitch Pel and the pitch magnification of the lens LS corresponding to the light emitting element group 295 is substantially equal to a specified spot pitch Psp and a product of the light emitting element row pitch Pelr and the pitch magnification of the lens LS corresponding to the light emitting element group 295 is substantially equal to a specified spot row pitch Pspr.

The table titled with “Spot Position 3-1” in FIG. 80 shows the formation positions of the spots SP in the case where the arrangement of the light emitting elements 2951 is adjusted in accordance with the pitch magnification of the lens LS as described above. In other words, this table in FIG. 80 shows the positions of the spots SP in the spot group SG formed by each of the lenses LS1 to LS3. Thus, in the working example 9, the spot pitch Psp is 42.34 μm and the spot row pitch Pspr is 100 μm in each spot group SG. In other words, the spot pitch Psp and the spot row pitch Pspr are constant independently of the spot groups SG.

The table of FIG. 80 titled with “Spot Position 3-2” shows the formation positions of the spots SP in the spot groups SG formed by the lenses LS1, LS3 in the case where the light emitting elements 2951 are arranged as shown in “Element Position 3-1” of FIG. 80 in all the light emitting element groups 295. At this time, the formation positions of the spots SP in the spot group SG formed by the lens LS2 are as shown in “Spot Position 3-1”. From these tables, the spot pitch Psp of the spot groups SG formed by the lenses LS1, LS3 is 42.80 μm and different from the spot pitch of 42.34 μm of the spot group SG formed by the lenses LS2. The spot row pitch Pspr of the spot groups SG formed by the lenses LS1, LS3 is 101.1 μm and different from the spot row pitch of 100 Pn of the spot group SG formed by the lens LS2. In other words, by identically arranging the light emitting elements 2951 in all the light emitting element groups 295, there occurs such an exposure failure that the spot pitch Psp and the spot row pitch Psgr differ depending on the spot groups SG.

In this way, in the working example 9, the arrangement of the plurality of light emitting elements 2951 is adjusted in each light emitting element group 295 in accordance with the pitch magnification of the lens LS corresponding to the light emitting element group 295 so that the spot pitch Psp becomes constant independently of the spot groups SG. Accordingly, even if the pitch magnification differs depending on the lenses LS due to the construction of the lens thicknesses (lens configurations) of the lenses LS, the spot pitches Psp of the plurality of spots SP formed on the photosensitive drum surface (latent image carrier surface) are substantially constant independently of the spot groups SG. This is preferable since a satisfactory spot formation is possible.

In the working example 9, the focus positions FP1 to FP3 are set at the positions in conformity with the curvature shape of the surface of the photosensitive drum 21 by adjusting the lens thicknesses. However, not only the lens thicknesses (lens configurations) of the lenses LS, but also the lens shapes (lens configurations) and the lens positions thereof may be constructed to adjust as above, for example, as shown in a working example 10 below.

### Working Example 10

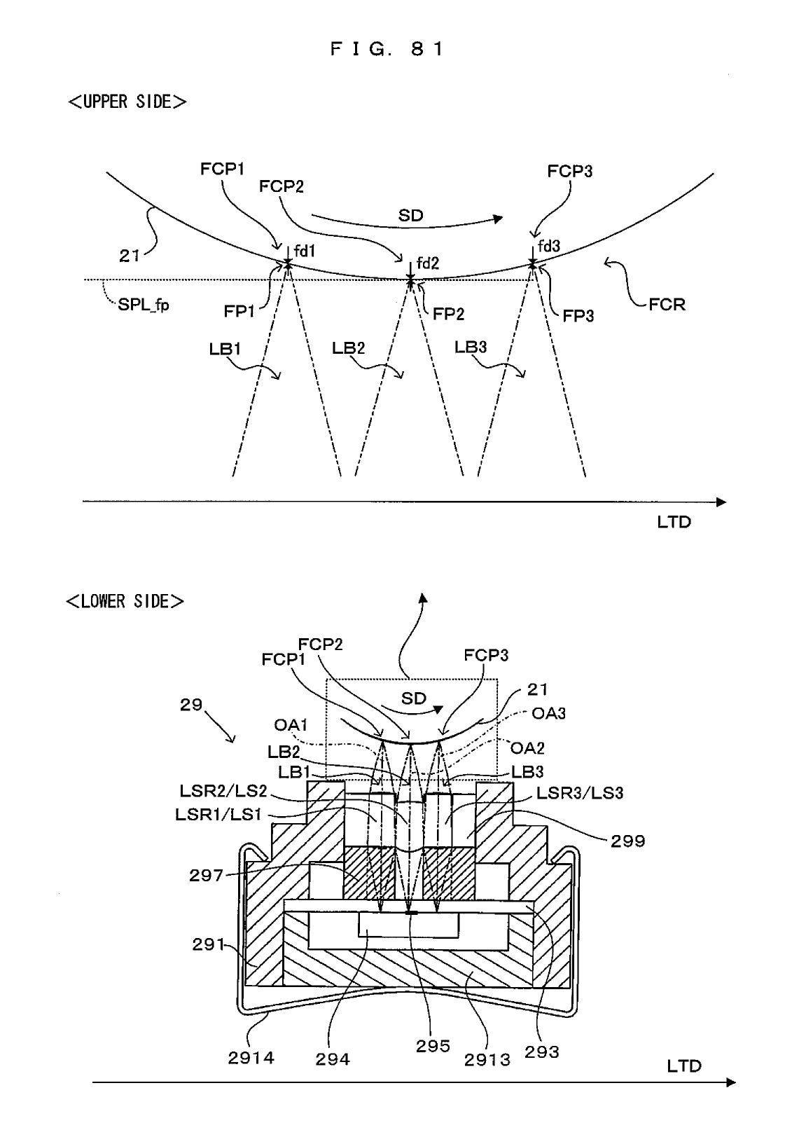

FIG. 81 is a sectional view along the sub scanning direction showing the relationship of arrangement of a lens array and a photosensitive drum according to the working example 10 of the invention. An upper side of FIG. 81 enlargedly shows a rectangular part enclosed by broken line in a lower side of FIG. 81. Lenses LS1 to LS3 in the lower side of FIG. 81 are lenses belonging to mutually different lens rows LSR1 to LSR3.

The relationship of arrangement of the lens array 299 and the photosensitive drum 21 in the working example 10 is the same as in the working example 1. Specifically, the respective lens rows LSR1 to LSR3 face facing positions FCP1 to FCP3 of the photosensitive drum surface (latent image carrier surface) mutually different in the sub scanning direction SD. Accordingly, focus positions FP1 to FP3 of light beams focused by the lenses LS1 to LS3 belonging to the different lens rows LSR1 to LSR3 mutually differ in the sub scanning direction SD. Thus, if the lens configurations and the lens positions of all the lenses LS are the same as in the working example 1, spot diameter differences to such an extent as shown in the working example 1 occur. On the contrary, in the working example 10 of the invention, the focus positions FP1 to FP3 of the light beams by the lenses LS1 to LS3 are set at positions in conformity with the curvature shape of the surface of the photosensitive drum 21 (FIG. 81). The lens shapes (lens configurations), the lens thicknesses (lens configurations) and the lens positions of the lenses LS1 to LS3 are constructed to conform the focus positions FP1 to FP3 to the curvature shape in this way. This construction is specifically as follows.

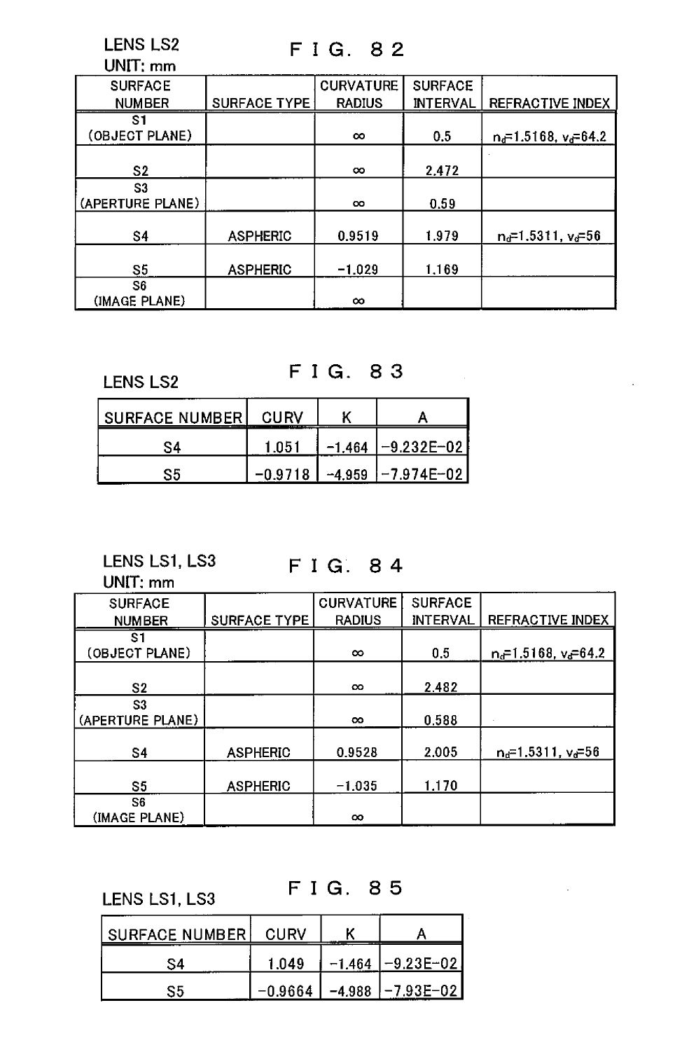

FIG. 82 shows the lens data of the lens LS2, and FIG. 83 shows the aspherical surface coefficient of the lens LS2. On the other hand, FIG. 84 shows the lens data of the lenses LS1, LS3, and FIG. 85 shows the aspherical surface coefficients of the lenses LS1, LS3. As can be understood from a difference in the sum of the surface intervals from the surface number S1 to the surface number S3 between FIG. 82 and FIG. 84, the lens positions differ between the lens LS2 and the lenses LS1, LS3 in the working example 10. Further, as can be understood from a difference in the surface interval of the surface number S4 between FIG. 82 and FIG. 84, the lens thicknesses differ between the lens LS2 and the lenses LS1, LS3 in the working example 10. The specification of an optical system used in a simulation of the working example 10 is similar to the contents shown in FIG. 19 of the working example 1. Thus, the lenses LS1 and LS3 are the same in the working example 10 of the invention. On the other hand, the lenses LS1, LS3 differ from the lens LS2 in the lens thickness.

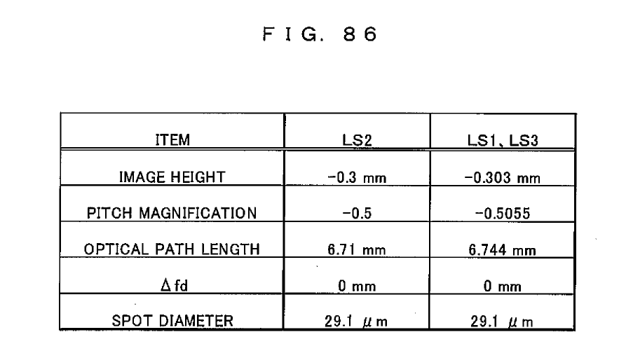

FIG. 86 shows a simulation result in the case where the lenses LS1 to LS3 are formed based on the data given by above FIG. 82 to FIG. 85. In this simulation, a lens row pitch Plsr, a light emitting element group row pitch Pegr, a photosensitive drum diameter and other conditions are the same as in the working example 1. Optical path lengths in FIG. 86 are those from the position of an object height of 0.6 mm (see FIG. 19) to the positions of image heights corresponding to the respective lenses LS1 to LS3 (according to FIG. 86, the image height corresponding to the lens LS2 is −0.3 mm and those corresponding to the lenses LS1, LS3 are −0.303 mm).

Differences Δfd shown in FIG. 86 are differences between image-photosensitive member distances fd1 to fd3 corresponding to the lenses LS1 to LS3 and the image-photosensitive member distance fd2. In other words, the differences Δfd among the image-photosensitive member distances fd1 to fd3 are calculated based on the image-photosensitive member distance fd2. As shown in FIG. 86, the differences Δfd are 0 in the working example 10. In other words, the image-photosensitive member distances fd1 to fd3 are equal to each other. This is because the focus positions FP1 to FP3 of the light beams by the lenses LS1 to LS3 are adjusted to the positions in conformity with the curvature shape of the photosensitive drum 21 (substantially on the surface of the photosensitive drum 21 as shown in FIG. 81 in the working example 10) as shown in FIG. 81. As shown in a column “Spot Diameter” of FIG. 86, it can be understood that differences in the diameters of spots formed on the surface of the photosensitive drum 21 are suppressed by suppressing the differences of the image-photosensitive member distances fd1 to fd3. Specifically, the diameter of the spots formed by the lens LS2 in the working example 10 is 29.1 μm, and the diameter of the spots formed by the lenses LS1, LS3 is also 29.1 μm. Accordingly, a difference between the spot diameter by the lens LS2 and the one by the lenses LS1, LS3 in the working example 10 is 0 μm (=29.1 μm-29.1 μm) and a remarkable improvement as compared to the spot diameter difference of 3.2 μm in the working example 1 can be understood. In other words, in the working example 10, the differences in the diameters of the spots formed by a plurality of lens rows LSR1 to LSR3 are further suppressed as compared to the working example 1.

In this way, in the working example 10, the lens shapes, the lens thicknesses and the lens positions of the lenses LS 1 to LS3 belonging to the mutually different lens rows LSR are constructed such that the focus positions FP1 to FP3 of the light beams by the plurality of respective lenses LS1 to LS3 conform to the curvature shape of the surface of the photosensitive drum 21 (latent image carrier surface). Accordingly, an occurrence of such a problem that the distances between the focus positions and the latent image carrier surface (image-photosensitive member distances) differ depending on the lens rows LSR as described above can be suppressed. As a result, a satisfactory exposure can be advantageously realized by suppressing the differences in the spot diameters as shown in FIG. 86.

As shown by pitch magnifications of FIG. 86, the pitch magnification of the lens LS2 and that of the lenses LS1, LS3 differ. Specifically, the pitch magnification of the lens LS2 is −0.5, whereas that of the lenses LS1, LS3 is −0.5055. The cause of such a difference in the pitch magnification among the lenses LS1 to LS3 results from the construction of the lens shapes, the lens thicknesses and the lens positions of the respective lenses LS1 to LS3 to adjust as above. In other words, the pitch magnifications differ among the lenses LS1 to LS3 due to the construction of the lens shapes, the lens thicknesses and the lens positions to suppress the occurrence of such an exposure failure that the diameters of the spots to be formed by the respective lenses LS1 to LS3 differ. Accordingly, there is a possibility of an occurrence of such an exposure failure that the spot pitches Psp differ due to the differences in the pitch magnifications of the lenses LS as described in the working example 7.

In order to cope with such a problem, in the working example 10, the arrangement of the plurality of light emitting elements 2951 are adjusted in each light emitting element group 295 in accordance with the pitch magnification of the lens LS corresponding to the light emitting element group 295 so that the spot pitch Psp becomes constant independently of the spot groups SG. Specifically, in each light emitting element group 295, the light emitting element pitch Pel and the light emitting element row pitch Pelr are adjusted in accordance with the pitch magnification of the lens LS corresponding to this light emitting element group 295 as described below.

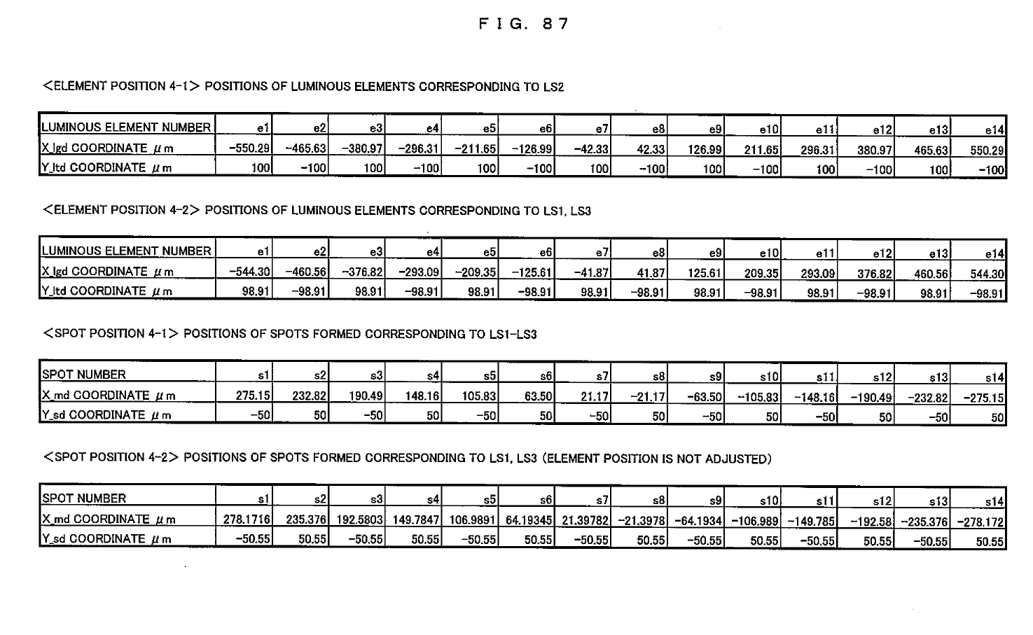

FIG. 87 is a group of tables showing the arrangement of the light emitting elements and the formation positions of the spots in the working example 10. In FIG. 87, the table titled with “Element Position 4-1” shows the positions of light emitting elements e1 to e14 in the light emitting element group 295 corresponding to the lens LS2, and the table titled with “Element Position 4-2” shows the positions of light emitting elements e1 to e14 in the light emitting element groups 295 corresponding to the lenses LS1, LS3. Further, the tables titled with “Spot Position 4-1” and “Spot Position 4-2” show the positions of spots s1 to s14 in the spot group SG formed on the photosensitive drum surface.

The light emitting element pitch Pel and the light emitting element row pitch Pelr are calculated from these tables shown in FIG. 87. In the light emitting element group 295 corresponding to the lens LS2, the light emitting element pitch Pel is 84.66 μm and the light emitting element row pitch Pelr is 200 μm. On the other hand, in the light emitting element groups 295 corresponding to the lenses LS1, LS3, the light emitting element pitch Pel is 83.74 μm and the light emitting element row pitch Pelr is 197.82 μm. Thus, in the working example 10, the light emitting element pitch Pel and the light emitting element row pitch Pelr of the light emitting element group 295 corresponding to the lens LS2 are larger than those of the light emitting element groups 295 corresponding to the lenses LS1, LS3.

Specifically, as shown in FIG. 86, the pitch magnification of the lens LS2 is smaller in absolute value than the pitch magnification of the lenses LS1, LS3. Accordingly, if the light emitting element pitch Pel and the light emitting element row pitch Pelr are the same in all the light emitting element groups 295, the spot pitch Psp of the spot group SG by the lens LS2 becomes smaller than the spot pitch Psp of the spot groups SG by the lenses LS1, LS3 and the spot row pitch Pspr of the spot group SG by the lens LS2 becomes smaller than the spot row pitch Pspr of the spot groups SG by the lenses LS1, LS3. Therefore, the spot pitch Psp and the spot row pitch Pspr differ depending on the spot groups SG.

Accordingly, in the working example 10, the light emitting element pitch Pel and the light emitting element row pitch Pelr of the light emitting element group 295 corresponding to the lens LS2 are made larger than those of the light emitting element groups 295 corresponding to the lenses LS1, LS3 based on the fact that the absolute value of the pitch magnification of the lens LS2 is smaller than that of the pitch magnification of the lenses LS1, LS3. Specifically, the arrangement of the light emitting elements 2951 is adjusted in each light emitting element group 295 such that a product of the light emitting element pitch Pel and the pitch magnification of the lens LS corresponding to the light emitting element group 295 is substantially equal to a specified spot pitch Psp and a product of the light emitting element row pitch Pelr and the pitch magnification of the lens LS corresponding to the light emitting element group 295 is substantially equal to a specified spot row pitch Pspr.

The table titled with “Spot Position 4-1” in FIG. 87 shows the formation positions of the spots SP in the case where the arrangement of the light emitting elements 2951 is adjusted in accordance with the pitch magnification of the lens LS as described above. In other words, this table in FIG. 87 shows the positions of the spots SP in the spot group SG formed by each of the lenses LS1 to LS3. Thus, in the working example 10, the spot pitch Psp is 42.34 μm and the spot row pitch Pspr is 100 μM in each spot group SG. In other words, the spot pitch Psp and the spot row pitch Pspr are constant independently of the spot groups SG.

The table of FIG. 87 titled with “Spot Position 4-2” shows the formation positions of the spots SP in the spot groups SG formed by the lenses LS1, LS3 in the case where the light emitting elements 2951 are arranged as shown in “Element Position 4-1” of FIG. 87 in all the light emitting element groups 295. At this time, the formation positions of the spots SP in the spot group SG formed by the lens LS2 are as shown in “Spot Position 4-1”. From these tables, the spot pitch Psp of the spot groups SG formed by the lenses LS1, LS3 is 42.80 μm and different from the spot pitch of 42.34 μm of the spot group SG formed by the lenses LS2. The spot row pitch Pspr of the spot groups SG formed by the lenses LS1, LS3 is 101.1 μm and different from the spot row pitch of 100 μM of the spot group SG formed by the lens LS2. In other words, by identically arranging the light emitting elements 2951 in all the light emitting element groups 295, there occurs such an exposure failure that the spot pitch Psp and the spot row pitch Psgr differ depending on the spot groups SG.

In this way, in the working example 10, the arrangement of the plurality of light emitting elements 2951 is adjusted in each light emitting element group 295 in accordance with the pitch magnification of the lens LS corresponding to the light emitting element group 295 so that the spot pitch Psp becomes constant independently of the spot groups SG. Accordingly, even if the pitch magnification differs depending on the lenses LS due to the construction of the lens shapes (lens configurations), the lens thicknesses (lens configurations) and the lens positions of the lenses LS, the spot pitches Psp of the plurality of spots SP formed on the photosensitive drum surface (latent image carrier surface) are substantially constant independently of the spot groups SG. This is preferable since a satisfactory spot formation is possible.

In the above working examples 7 to 10, the invention is described using the line head 29 having three lens rows LSR arranged in the width direction LTD. However, the number of the lens rows is not limited to this and may be four or more. Accordingly, the case using the line head 29 having four lens rows are described (working examples 11 to 14).

### Working Example 11

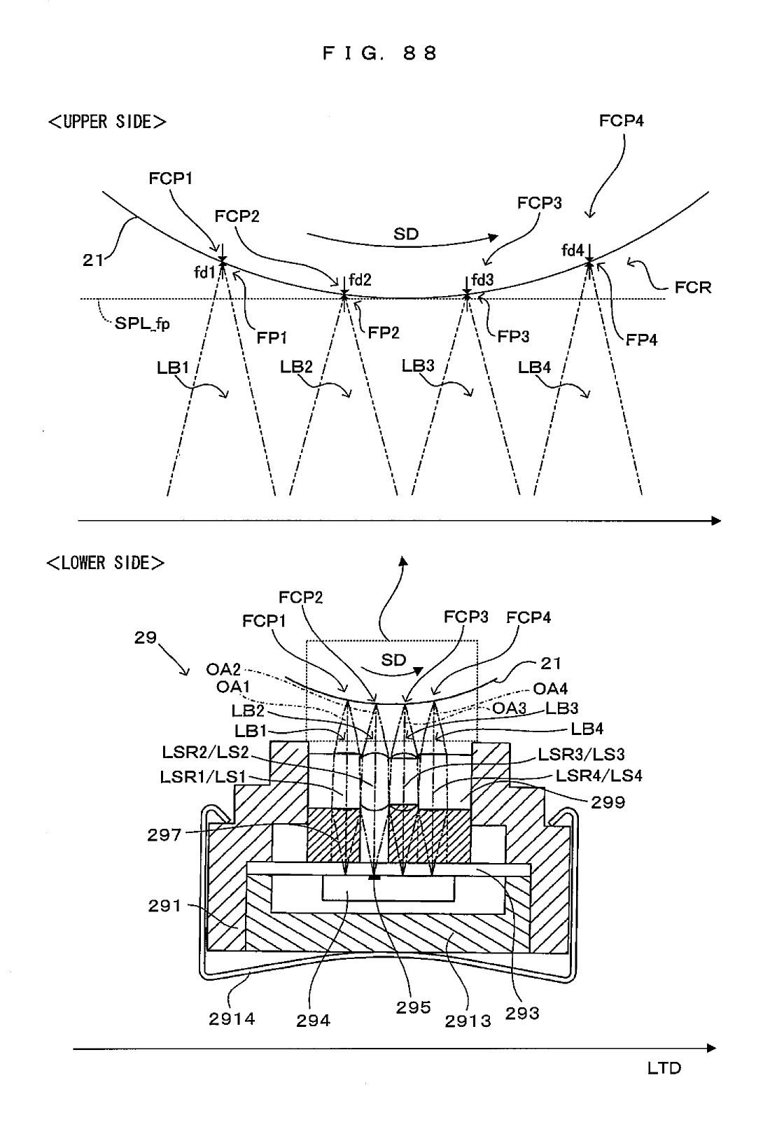

FIG. 88 is a sectional view along the sub scanning direction showing the relationship of arrangement of a lens array and a photosensitive drum according to the working example 11 of the invention. An upper side of FIG. 88 enlargedly shows a rectangular part enclosed by broken line in a lower side of FIG. 88. Lenses LS1 to LS4 in the lower side of FIG. 88 are lenses belonging to mutually different lens rows LSR1 to LSR4.

The relationship of arrangement of the lens array 299 and the photosensitive drum 21 in the working example 11 is the same as in the working example 2. Specifically, the four lens rows LSR1 to LSR4 are arranged at lens row pitches Plsr in the width direction LTD and are substantially symmetrically arranged in the width direction LTD with respect to a symmetry axis SA. Further, the lens rows LSR1 to LSR4 are arranged such that optical axes OA1 to OA4 of the lenses LS1 to LS4 belonging to the lens rows LSR1 to LSR4 are parallel to each other. The lens array 299 is arranged such that the symmetry axis SA passes a curvature center CC21 of the photosensitive drum 21 (that is, rotation axis of the photosensitive drum 21).

The lens rows LSR1 to LSR4 are all arranged to face the surface of the photosensitive drum 21. At this time, the respective lens rows LSR1 to LSR4 face facing positions FCP1 to FCP4 of the photosensitive drum surface (latent image carrier surface) mutually different in the sub scanning direction SD. Accordingly, focus positions FP1 to FP4 of light beams focused by the lenses LS1 to LS4 belonging to the different lens rows LSR1 to LSR4 mutually differ in the sub scanning direction SD.

Accordingly, if the lens configurations and the lens positions of all the lenses LS are the same as in the working example 2, spot diameter differences to such an extent as shown in the working example 2 occur. On the contrary, in the working example 11 of the invention, the focus positions FP1 to FP4 of the light beams by the lenses LS1 to LS4 are set at positions in conformity with the curvature shape of the surface of the photosensitive drum 21 (FIG. 88). The lens shapes of the lenses LS1 to LS4 are constructed to conform the focus positions FP1 to FP4 to the curvature shape in this way. This construction is specifically as follows.

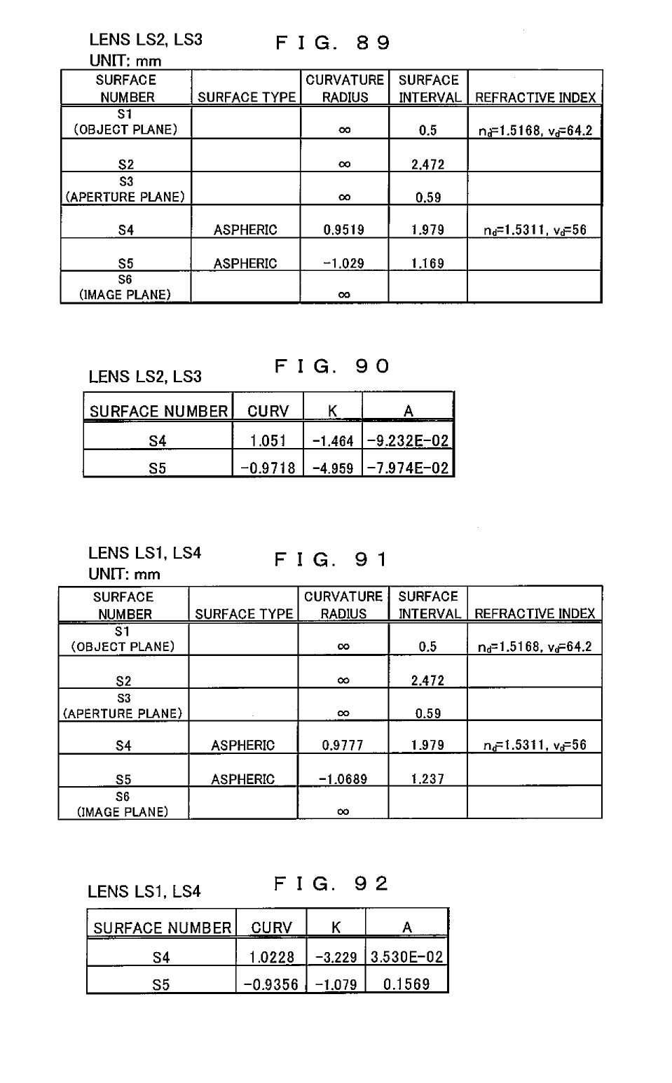

FIG. 89 shows the lens data of the lenses LS2, LS3, and FIG. 90 shows the aspherical surface coefficients of the lenses LS2, LS3. On the other hand, FIG. 91 shows the lens data of the lenses LS1, LS4, and FIG. 92 shows the aspherical surface coefficients of the lenses LS1, LS4. As can be understood from these data, the aspherical surface coefficient differs (that is, the lens shape differs) between the lenses LS2, LS3 and the lenses LS1, LS4. The specification of an optical system used in a simulation of the working example 11 is similar to the contents shown in FIG. 19 of the working example 1. Thus, the lenses LS1 and LS4 are the same and the lenses LS2 and LS3 are the same in the working example 11 of the invention. On the other hand, the lenses LS1, LS4 differ from the lenses LS2, LS3 in the lens shape.

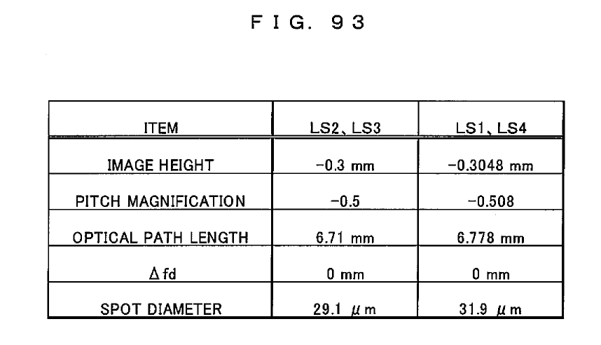

FIG. 93 shows a simulation result in the case where the lenses LS1 to LS4 are formed based on the data given by above FIG. 89 to FIG. 92. In this simulation, a lens row pitch Plsr, a light emitting element group row pitch Pegr, a photosensitive drum diameter and other conditions are the same as in the working example 2. Optical path lengths in FIG. 93 are those from the position of an object height of 0.6 mm (see FIG. 19) to the positions of image heights corresponding to the respective lenses LS1 to LS4 (according to FIG. 93, the image heights corresponding to the lenses LS2, LS3 are −0.3 mm and those corresponding to the lenses LS1, LS4 are −0.3048 mm).

Differences Δfd shown in FIG. 93 are differences between image-photosensitive member distances fd1 to fd4 corresponding to the lenses LS1 to LS4 and the image-photosensitive member distance fd2. In other words, the differences Δfd among the image-photosensitive member distances fd1 to fd4 are calculated based on the image-photosensitive member distance fd2. As shown in FIG. 93, the differences Δfd are 0 in the working example 11. In other words, the image-photosensitive member distances fd1 to fd4 are equal to each other. This is because the focus positions FP1 to FP4 of the light beams by the lenses LS1 to LS4 are adjusted to the positions in conformity with the curvature shape of the photosensitive drum 21 (substantially on the surface of the photosensitive drum 21 as shown in FIG. 88 in the working example 11) as shown in FIG. 88. As shown in a column “Spot Diameter” of FIG. 93, it can be understood that differences in the diameters of spots formed on the surface of the photosensitive drum 21 are suppressed by suppressing the differences of the image-photosensitive member distances fd1 to fd4. Specifically, the diameter of the spots formed by the lenses LS2, LS3 in the working example 11 is 29.1 μm, whereas the diameter of the spots formed by the lenses LS1, LS4 is 31.9 μm. Accordingly, a difference between the spot diameter by the lenses LS2, LS3 and the one by the lenses LS1, LS4 in the working example 11 is 2.8 μm (=31.9 μm-29.1 μm) and an improvement as compared to the spot diameter difference of 11.1 μm in the working example 2 can be understood. In other words, in the working example 11, the differences in the diameters of the spots formed by a plurality of lens rows LSR1 to LSR4 are further suppressed as compared to the working example 2.

In this way, in the working example 11, the lens shapes (lens configurations) of the lenses LS1 to LS4 belonging to the mutually different lens rows LSR are constructed such that the focus positions FP1 to FP4 of the light beams by the plurality of respective lenses LS1 to LS4 conform to the curvature shape of the surface of the photosensitive drum 21 (latent image carrier surface). Accordingly, an occurrence of such a problem that the distances between the focus positions and the latent image carrier surface (image-photosensitive member distances) differ depending on the lens rows LSR as described above can be suppressed. As a result, a satisfactory exposure can be advantageously realized by suppressing the differences in the spot diameters as shown in FIG. 93.

As shown by pitch magnifications of FIG. 93, the pitch magnification of the lenses LS2, LS3 and that of the lenses LS1, LS4 differ. Specifically, the pitch magnification of the lenses LS2, LS3 is −0.5, whereas that of the lenses LS1, LS4 is −0.508. The cause of such a difference in the pitch magnification among the lenses LS1 to LS4 results from the construction of the lens shapes of the respective lenses LS1 to LS4 to adjust as above. In other words, the pitch magnifications differ among the lenses LS1 to LS4 due to the construction of the lens shapes to suppress the occurrence of such an exposure failure that the diameters of the spots to be formed by the respective lenses LS1 to LS4 differ. Accordingly, there is a possibility of an occurrence of such an exposure failure that the spot pitches Psp differ due to the differences in the pitch magnifications of the lenses LS as described in the working example 7 also in an exposure operation in the line head 29 having four lens rows LSR as described above.

In order to cope with such a problem, in the working example 11, the arrangement of the plurality of light emitting elements 2951 are adjusted in each light emitting element group 295 in accordance with the pitch magnification of the lens LS corresponding to the light emitting element group 295 so that the spot pitch Psp becomes constant independently of the spot groups SG. Specifically, in each light emitting element group 295, the light emitting element pitch Pel and the light emitting element row pitch Pelr are adjusted in accordance with the pitch magnification of the lens LS corresponding to this light emitting element group 295 as described below.

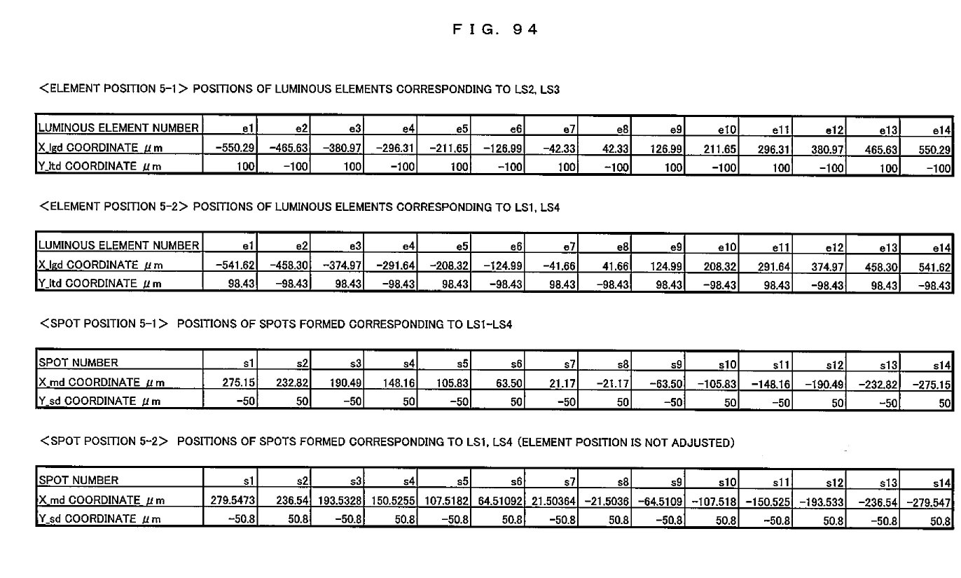

FIG. 94 is a group of tables showing the arrangement of the light emitting elements and the formation positions of the spots in the working example 11. In FIG. 94, the table titled with “Element Position 5-1” shows the positions of light emitting elements e1 to e14 in the light emitting element groups 295 corresponding to the lenses LS2, LS3, and the table titled with “Element Position 5-2” shows the positions of light emitting elements e1 to e14 in the light emitting element groups 295 corresponding to the lenses LS1, LS4. Further, in FIG. 94, the tables titled with “Spot Position 5-1” and “Spot Position 5-2” show the positions of spots s1 to s14 in the spot group SG formed on the photosensitive drum surface.

The light emitting element pitch Pel and the light emitting element row pitch Pelr are calculated from these tables shown in FIG. 94. In the light emitting element groups 295 corresponding to the lenses LS2, LS3, the light emitting element pitch Pel is 84.66 μm and the light emitting element row pitch Pelr is 200 μm. On the other hand, in the light emitting element groups 295 corresponding to the lenses LS1, LS4, the light emitting element pitch Pel is 83.32 μm and the light emitting element row pitch Pelr is 196.86 μm. Thus, in the working example 11, the light emitting element pitch Pel and the light emitting element row pitch Pelr of the light emitting element groups 295 corresponding to the lenses LS2, LS3 are larger than those of the light emitting element groups 295 corresponding to the lenses LS1, LS4.

Specifically, as shown in FIG. 93, the pitch magnification of the lenses LS2, LS3 is smaller in absolute value than the pitch magnification of the lenses LS1, LS4. Accordingly, if the light emitting element pitch Pel and the light emitting element row pitch Pelr are the same in all the light emitting element groups 295, the spot pitch Psp of the spot groups SG by the lenses LS2, LS3 becomes smaller than the spot pitch Psp of the spot groups SG by the lenses LS1, LS4 and the spot row pitch Pspr of the spot groups SG by the lenses LS2, LS3 becomes smaller than the spot row pitch Pspr of the spot groups SG by the lenses LS1, LS4. Therefore, the spot pitch Psp and the spot row pitch Pspr differ depending on the spot groups SG.

Accordingly, in the working example 11, the light emitting element pitch Pel and the light emitting element row pitch Pek of the light emitting element groups 295 corresponding to the lenses LS2, LS3 are made larger than those of the light emitting element groups 295 corresponding to the lenses LS1, LS4 based on the fact that the absolute value of the pitch magnification of the lenses LS2, LS3 is smaller than that of the pitch magnification of the lenses LS1, LS4. Specifically, the arrangement of the light emitting elements 2951 is adjusted in each light emitting element group 295 such that a product of the light emitting element pitch Pel and the pitch magnification of the lens LS corresponding to the light emitting element group 295 is substantially equal to a specified spot pitch Psp and a product of the light emitting element row pitch Pelr and the pitch magnification of the lens LS corresponding to the light emitting element group 295 is substantially equal to a specified spot row pitch Pspr.

The table titled with “Spot Position 5-1” in FIG. 94 shows the formation positions of the spots SP in the case where the arrangement of the light emitting elements 2951 is adjusted in accordance with the pitch magnification of the lens LS as described above. In other words, this table in FIG. 94 shows the positions of the spots SP in the spot group SG formed by each of the lenses LS1 to LS4. Thus, in the working example 11, the spot pitch Psp is 42.34 μm and the spot row pitch Pspr is 100 μm in each spot group SG. In other words, the spot pitch Psp and the spot row pitch Pspr are constant independently of the spot groups SG.

The table of FIG. 94 titled with “Spot Position 5-2” shows the formation positions of the spots SP in the spot groups SG formed by the lenses LS1, LS4 in the case where the light emitting elements 2951 are arranged as shown in “Element Position 5-1” of FIG. 94 in all the light emitting element groups 295. At this time, the formation positions of the spots SP in the spot groups SG formed by the lenses LS2, LS3 are as shown in “Spot Position 5-1”. From these tables, the spot pitch Psp of the spot groups SG formed by the lenses LS1, LS4 is 43.01 μl and different from the spot pitch of 42.34 μm of the spot groups SG formed by the lenses LS2, LS3. The spot row pitch Pspr of the spot groups SG formed by the lenses LS1, LS4 is 101.6 μm and different from the spot row pitch of 100 μm of the spot groups SG formed by the lenses LS2, LS3. In other words, by identically arranging the light emitting elements 2951 in all the light emitting element groups 295, there occurs such an exposure failure that the spot pitch Psp and the spot row pitch Psgr differ depending on the spot groups SG.

In this way, in the working example 11, the arrangement of the plurality of light emitting elements 2951 is adjusted in each light emitting element group 295 in accordance with the pitch magnification of the lens LS corresponding to the light emitting element group 295 so that the spot pitch Psp becomes constant independently of the spot groups SG. Accordingly, even if the pitch magnification differs depending on the lenses LS due to the construction of the lens shapes (lens configurations) of the lenses LS, the spot pitches Psp of the plurality of spots SP formed on the photosensitive drum surface (latent image carrier surface) are substantially constant independently of the spot groups SG. This is preferable since a satisfactory spot formation is possible.

In the working example 11, the focus positions FP1 to FP4 are set at the positions in conformity with the curvature shape of the surface of the photosensitive drum 21 by adjusting the lens shapes. However, the lens positions of the lenses LS may be constructed to adjust as above, for example, as shown in a working example 12 below.

### Working Example 12

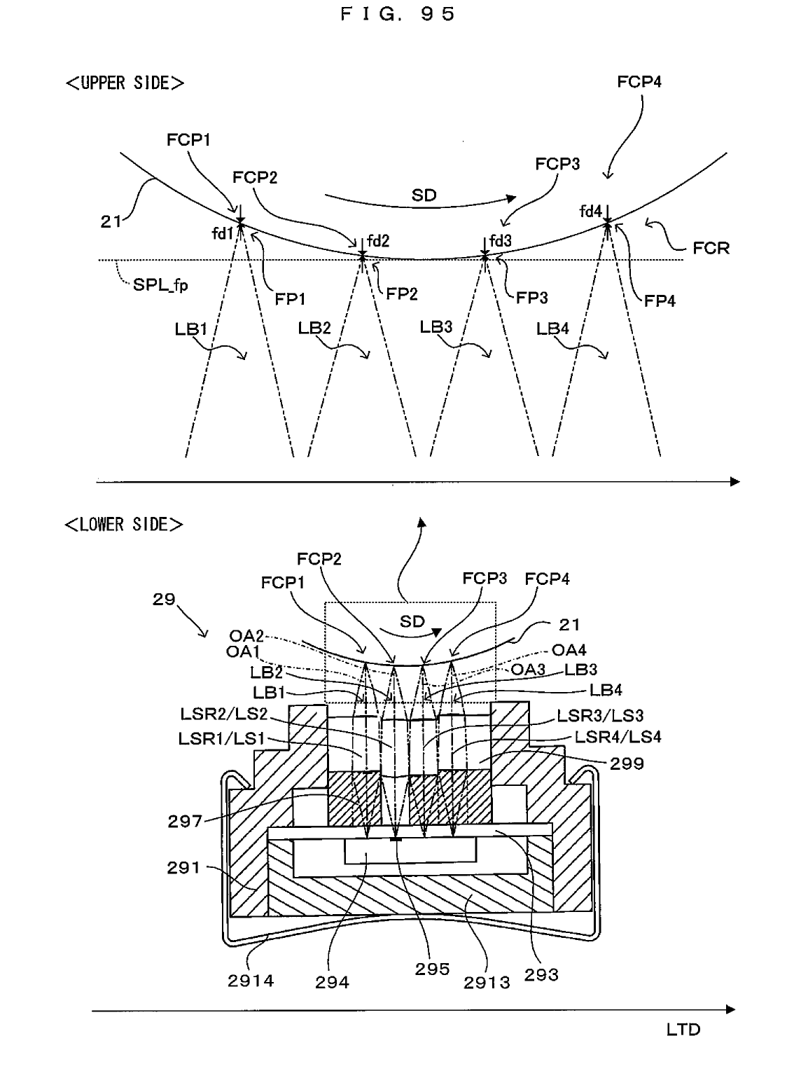

FIG. 95 is a sectional view along the sub scanning direction showing the relationship of arrangement of a lens array and a photosensitive drum according to the working example 12 of the invention. An upper side of FIG. 95 enlargedly shows a rectangular part enclosed by broken line in a lower side of FIG. 95. Lenses LS1 to LS4 in the lower side of FIG. 95 are lenses belonging to mutually different lens rows LSR1 to LSR4.

The relationship of arrangement of the lens array 299 and the photosensitive drum 21 in the working example 12 is the same as in the working example 2. Specifically, the respective lens rows LSR1 to LSR4 face facing positions FCP1 to FCP4 of the photosensitive drum surface (latent image carrier surface) mutually different in the sub scanning direction SD. Accordingly, focus positions FP1 to FP4 of light beams focused by the lenses LS1 to LS4 belonging to the different lens rows LSR1 to LSR4 mutually differ in the sub scanning direction SD. Thus, if the lens configurations and the lens positions of all the lenses LS are the same as in the working example 2, spot diameter differences to such an extent as shown in the working example 2 occur. On the contrary, in the working example 12 of the invention, the focus positions FP 1 to FP4 of the light beams by the lenses LS1 to LS4 are set at positions in conformity with the curvature shape of the surface of the photosensitive drum 21 (FIG. 95). The lens positions of the lenses LS1 to LS4 are constructed to conform the focus positions FP1 to FP4 to the curvature shape in this way. This construction is specifically as follows.

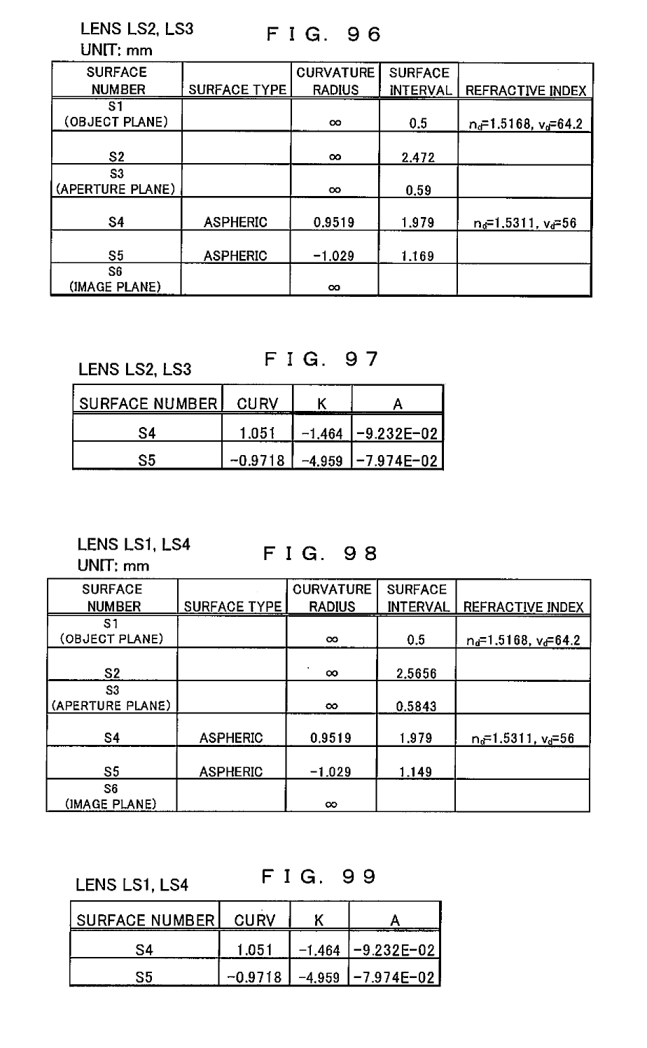

FIG. 96 shows the lens data of the lenses LS2, LS3, and FIG. 97 shows the aspherical surface coefficients of the lenses LS2, LS3. On the other hand, FIG. 98 shows the lens data of the lenses LS1, LS4, and FIG. 99 shows the aspherical surface coefficients of the lenses LS1, LS4. As can be understood from a difference in the sum of the surface intervals from the surface number S1 to the surface number S3 between FIG. 96 and FIG. 98, the lens positions differ between the lenses LS2, LS3 and the lenses LS1, LS4. The specification of an optical system used in a simulation of the working example 12 is similar to the contents shown in FIG. 19 of the working example 1. Thus, the lenses LS1 and LS4 are the same and the lenses LS2 and LS3 are the same in the working example 12 of the invention. On the other hand, the lenses LS1, LS4 differ from the lenses LS2, LS3 in the lens position.

FIG. 100 shows a simulation result in the case where the lenses LS1 to LS4 are formed based on the data given by above FIG. 96 to FIG. 99. In this simulation, a lens row pitch Plsr, a light emitting element group row pitch Pegr, a photosensitive drum diameter and other conditions are the same as in the working example 2. Optical path lengths in FIG. 100 are those from the position of an object height of 0.6 mm (see FIG. 19) to the positions of image heights corresponding to the respective lenses LS1 to LS4 (according to FIG. 100, the image heights corresponding to the lenses LS2, LS3 are −0.3 mm and those corresponding to the lenses LS1, LS4 are −0.2922 mm).

Differences Δfd shown in FIG. 100 are differences between image-photosensitive member distances fd1 to fd4 corresponding to the lenses LS1 to LS4 and the image-photosensitive member distance fd2. In other words, the differences Δfd among the image-photosensitive member distances fd1 to fd4 are calculated based on the image-photosensitive member distance fd2. As shown in FIG. 100, the differences Δfd are 0 in the working example 12. In other words, the image-photosensitive member distances fd1 to fd4 are equal to each other. This is because the focus positions FP1 to FP4 of the light beams by the lenses LS1 to LS4 are adjusted to the positions in conformity with the curvature shape of the photosensitive drum 21 (substantially on the surface of the photosensitive drum 21 as shown in FIG. 95 in the working example 12) as shown in FIG. 95. As shown in a column “Spot Diameter” of FIG. 100, it can be understood that differences in the diameters of spots formed on the surface of the photosensitive drum 21 are suppressed by suppressing the differences of the image-photosensitive member distances fd1 to fd4. Specifically, the diameter of the spots formed by the lenses LS2, LS3 in the working example 12 is 29.1 μm and the diameter of the spots formed by the lenses LS1, LS4 is 29.1 μm Accordingly, a difference between the spot diameter by the lenses LS2, LS3 and the one by the lenses LS1, LS4 in the working example 12 is 0 μm (=29.1 μm-29.1 μm) and a remarkable improvement as compared to the spot diameter difference of 11.1 μm in the working example 2 can be understood. In other words, in the working example 12, the differences in the diameters of the spots formed by a plurality of lens rows LSR1 to LSR4 are further suppressed as compared to the working example 2.

In this way, in the working example 12, the lens positions of the lenses LS1 to LS4 belonging to the mutually different lens rows LSR are constructed such that the focus positions FP1 to FP4 of the light beams by the plurality of respective lenses LS1 to LS4 conform to the curvature shape of the surface of the photosensitive drum 21 (latent image carrier surface). Accordingly, an occurrence of such a problem that the distances between the focus positions and the latent image carrier surface (image-photosensitive member distances) differ depending on the lens rows LSR as described above can be suppressed. As a result, a satisfactory exposure can be advantageously realized by suppressing the differences in the spot diameters as shown in FIG. 100.

As shown by pitch magnifications of FIG. 100, the pitch magnification of the lenses LS2, LS3 and that of the lenses LS1, LS4 differ. Specifically, the pitch magnification of the lenses LS2, LS3 is −0.5, whereas that of the lenses LS1, LS4 is −0.487. The cause of such a difference in the pitch magnification among the lenses LS1 to LS4 results from the construction of the lens positions of the respective lenses LS1 to LS4 to adjust as above. In other words, the pitch magnifications differ among the lenses LS1 to LS4 due to the construction of the lens positions to suppress the occurrence of such an exposure failure that the diameters of the spots to be formed by the respective lenses LS1 to LS4 differ. Accordingly, there is a possibility of an occurrence of such an exposure failure that the spot pitches Psp differ due to the differences in the pitch magnifications of the lenses LS as described in the working example 7.

In order to cope with such a problem, in the working example 12, the arrangement of the plurality of light emitting elements 2951 are adjusted in each light emitting element group 295 in accordance with the pitch magnification of the lens LS corresponding to the light emitting element group 295 so that the spot pitch Psp becomes constant independently of the spot groups SG. Specifically, in each light emitting element group 295, the light emitting element pitch Pel and the light emitting element row pitch Pelr are adjusted in accordance with the pitch magnification of the lens LS corresponding to this light emitting element group 295 as described below.

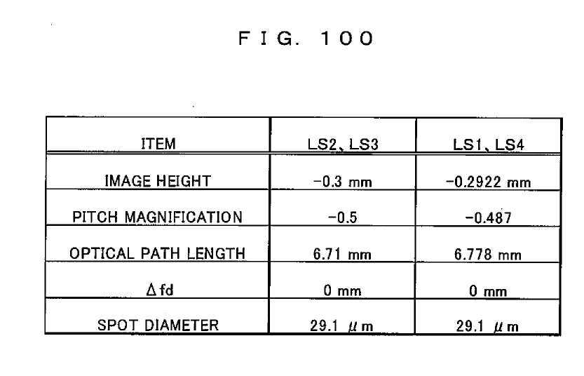

FIG. 101 is a group of tables showing the arrangement of the light emitting elements and the formation positions of the spots in the working example 12. In FIG. 101, the table titled with “Element Position 6-1” shows the positions of light emitting elements e1 to e14 in the light emitting element groups 295 corresponding to the lenses LS2, LS3, and the table titled with “Element Position 6-2” shows the positions of light emitting elements e1 to e14 in the light emitting element groups 295 corresponding to the lenses LS1, LS4. Further, the tables titled with “Spot Position 6-1” and “Spot Position 6-2” show the positions of spots s1 to s14 in the spot group SG formed on the photosensitive drum surface.

The light emitting element pitch Pel and the light emitting element row pitch Pelr are calculated from these tables shown in FIG. 101. In the light emitting element groups 295 corresponding to the lenses LS2, LS3, the light emitting element pitch Pel is 84.66 μm and the light emitting element row pitch Pelr is 200 μm. On the other hand, in the light emitting element groups 295 corresponding to the lenses LS1, LS4, the light emitting element pitch Pel is 86.72 μm and the light emitting element row pitch Pelr is 205.34 μm. Thus, in the working example 12, the light emitting element pitch Pel and the light emitting element row pitch Pelr of the light emitting element groups 295 corresponding to the lenses LS2, LS3 are smaller than those of the light emitting element groups 295 corresponding to the lenses LS1, LS4.

Specifically, as shown in FIG. 100, the pitch magnification of the lenses LS2, LS3 is larger in absolute value than the pitch magnification of the lenses LS1, LS4. Accordingly, if the light emitting element pitch Pel and the light emitting element row pitch Pelr are the same in all the light emitting element groups 295, the spot pitch Psp of the spot groups SG by the lenses LS2, LS3 becomes larger than the spot pitch Psp of the spot groups SG by the lenses LS1, LS4 and the spot row pitch Pspr of the spot groups SG by the lenses LS2, LS3 becomes larger than the spot row pitch Pspr of the spot groups SG by the lenses LS1, LS4. Therefore, the spot pitch Psp and the spot row pitch Pspr differ depending on the spot groups SG.

Accordingly, in the working example 12, the light emitting element pitch Pel and the light emitting element row pitch Pelr of the light emitting element groups 295 corresponding to the lenses LS2, LS3 are made smaller than those of the light emitting element groups 295 corresponding to the lenses LS1, LS4 based on the fact that the absolute value of the pitch magnification of the lenses LS2, LS3 is larger than that of the pitch magnification of the lenses LS1, LS4. Specifically, the arrangement of the light emitting elements 2951 is adjusted in each light emitting element group 295 such that a product of the light emitting element pitch Pel and the pitch magnification of the lens LS corresponding to the light emitting element group 295 is substantially equal to a specified spot pitch Psp and a product of the light emitting element row pitch Pelr and the pitch magnification of the lens LS corresponding to the light emitting element group 295 is substantially equal to a specified spot row pitch Pspr.

The table titled with “Spot Position 6-1” in FIG. 101 shows the formation positions of the spots SP in the case where the arrangement of the light emitting elements 2951 is adjusted in accordance with the pitch magnification of the lens LS as described above. In other words, this table in FIG. 101 shows the positions of the spots SP in the spot group SG formed by each of the lenses LS1 to LS4. Thus, in the working example 12, the spot pitch Psp is 42.34 μm and the spot row pitch Pspr is 100 μM in each spot group SG. In other words, the spot pitch Psp and the spot row pitch Pspr are constant independently of the spot groups SG.

The table of FIG. 101 titled with “Spot Position 6-2” shows the formation positions of the spots SP in the spot groups SG formed by the lenses LS1, LS4 in the case where the light emitting elements 2951 are arranged as shown in “Element Position 6-1” of FIG. 101 in all the light emitting element groups 295. At this time, the formation positions of the spots SP in the spot groups SG formed by the lenses LS2, LS3 are as shown in “Spot Position 6-1”. From these tables, the spot pitch Psp of the spot groups SG formed by the lenses LS1, LS4 is 41.22 μm and different from the spot pitch of 42.34 μm of the spot groups SG formed by the lenses LS2, LS3. The spot row pitch Pspr of the spot groups SG formed by the lenses LS1, LS4 is 97.4 μm and different from the spot row pitch of 100 μm of the spot groups SG formed by the lenses LS2, LS3. In other words, by identically arranging the light emitting elements 2951 in all the light emitting element groups 295, there occurs such an exposure failure that the spot pitch Psp and the spot row pitch Psgr differ depending on the spot groups SG.

In this way, in the working example 12, the arrangement of the plurality of light emitting elements 2951 is adjusted in each light emitting element group 295 in accordance with the pitch magnification of the lens LS corresponding to the light emitting element group 295 so that the spot pitch Psp becomes constant independently of the spot groups SG. Accordingly, even if the pitch magnification differs depending on the lenses LS due to the construction of the lens positions of the lenses LS, the spot pitches Psp of the plurality of spots SP formed on the photosensitive drum surface (latent image carrier surface) are substantially constant independently of the spot groups SG. This is preferable since a satisfactory spot formation is possible.

In the working example 12, the focus positions FP1 to FP4 are set at the positions in conformity with the curvature shape of the surface of the photosensitive drum 21 by adjusting the lens positions. However, the lens thicknesses (lens configurations) of the lenses LS may be constructed to adjust as above, for example, as shown in a working example 13 below.

### Working Example 13

FIG. 102 is a sectional view along the sub scanning direction showing the relationship of arrangement of a lens array and a photosensitive drum according to the working example 13 of the invention. An upper side of FIG. 102 enlargedly shows a rectangular part enclosed by broken line in a lower side of FIG. 102. Lenses LS1 to LS4 in the lower side of FIG. 102 are lenses belonging to mutually different lens rows LSR1 to LSR4.

The relationship of arrangement of the lens array 299 and the photosensitive drum 21 in the working example 13 is the same as in the working example 2. Specifically, the respective lens rows LSR1 to LSR4 face facing positions FCP1 to FCP4 of the photosensitive drum surface (latent image carrier surface) mutually different in the sub scanning direction SD. Accordingly, focus positions FP1 to FP4 of light beams focused by the lenses LS1 to LS4 belonging to the different lens rows LSR1 to LSR4 mutually differ in the sub scanning direction SD. Thus, if the lens configurations and the lens thicknesses (lens configurations) of all the lenses LS are the same as in the working example 2, spot diameter differences to such an extent as shown in the working example 2 occur. On the contrary, in the working example 13 of the invention, the focus positions FP1 to FP4 of the light beams by the lenses LS1 to LS4 are set at positions in conformity with the curvature shape of the surface of the photosensitive drum 21 (FIG. 102). The lens thicknesses (lens configurations) of the lenses LS1 to LS4 are constructed to conform the focus positions FP1 to FP4 to the curvature shape in this way. This construction is specifically as follows.

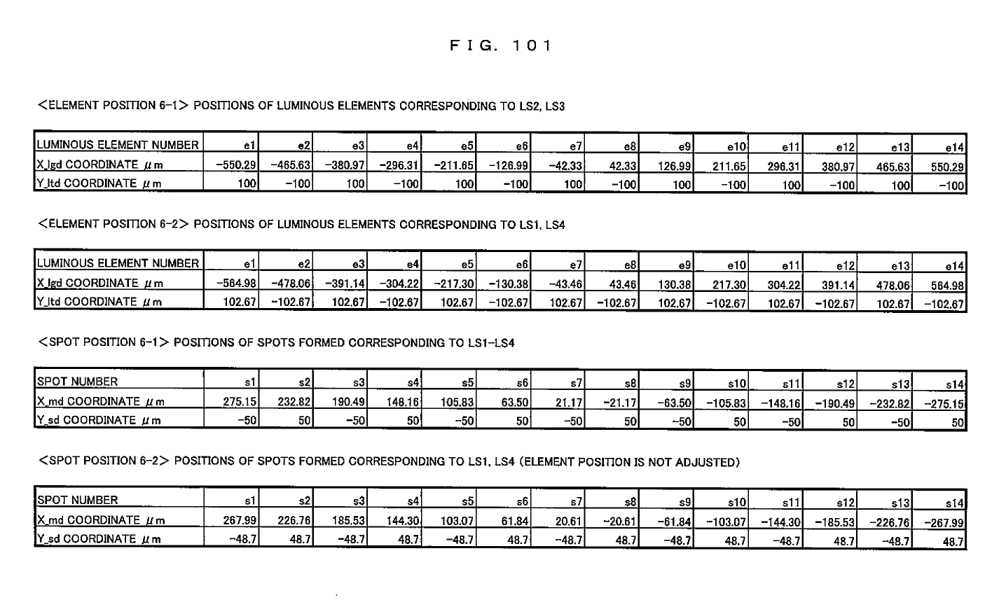

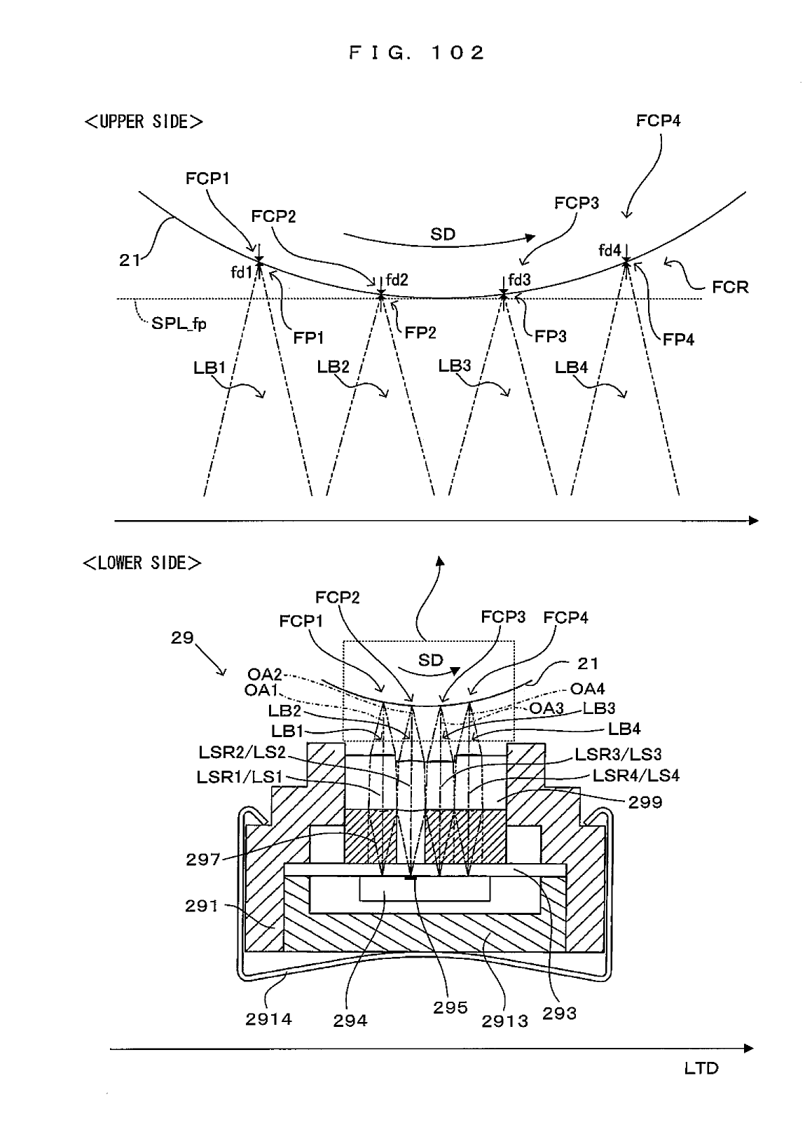

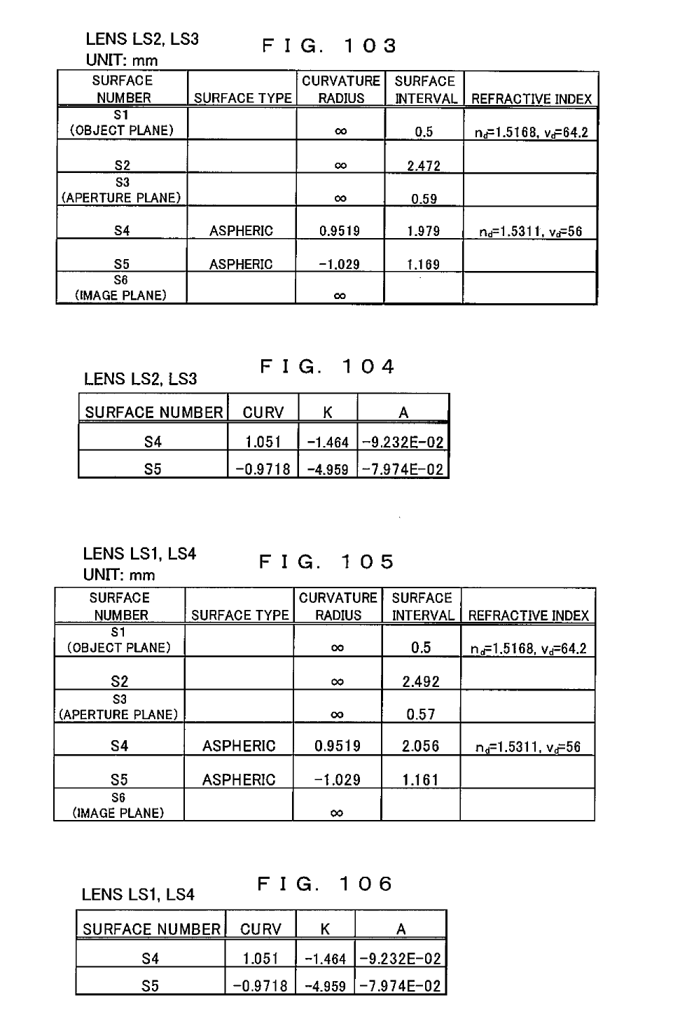

FIG. 103 shows the lens data of the lenses LS2, LS3, and FIG. 104 shows the aspherical surface coefficients of the lenses LS2, LS3. On the other hand, FIG. 105 shows the lens data of the lenses LS1, LS4, and FIG. 106 shows the aspherical surface coefficients of the lenses LS1, LS4. As can be understood from a difference in the surface interval of the surface number S4 between FIG. 103 and FIG. 105, the lens thicknesses differ between the lenses LS2, LS3 and the lenses LS1, LS4. The specification of an optical system used in a simulation of the working example 13 is similar to the contents shown in FIG. 19 of the working example 1. Thus, the lenses LS1 and LS4 are the same and the lenses LS2 and LS3 are the same in the working example 13 of the invention. On the other hand, the lenses LS1, LS4 differ from the lenses LS2, LS3 in the lens thickness.

FIG. 107 shows a simulation result in the case where the lenses LS1 to LS4 are formed based on the data given by above FIG. 103 to FIG. 106. In this simulation, a lens row pitch Plsr, a light emitting element group row pitch Pegr, a photosensitive drum diameter and other conditions are the same as in the working example 2. Optical path lengths in FIG. 107 are those from the position of an object height of 0.6 mm (see FIG. 19) to the positions of image heights corresponding to the respective lenses LS1 to LS4 (according to FIG. 107, the image heights corresponding to the lenses LS2, LS3 are −0.3 mm and those corresponding to the lenses LS1, LS4 are −0.3056 mm).

Differences Δfd shown in FIG. 107 are differences between image-photosensitive member distances fd1 to fd4 corresponding to the lenses LS1 to LS4 and the image-photosensitive member distance fd2. In other words, the differences Δfd among the image-photosensitive member distances fd1 to fd4 are calculated based on the image-photosensitive member distance fd2. As shown in FIG. 107, the differences Δfd are 0 in the working example 13. In other words, the image-photosensitive member distances fd1 to fd4 are equal to each other. This is because the focus positions FP1 to FP4 of the light beams by the lenses LS1 to LS4 are adjusted to the positions in conformity with the curvature shape of the photosensitive drum 21 (substantially on the surface of the photosensitive drum 21 as shown in FIG. 102 in the working example 13) as shown in FIG. 102. As shown in a column “Spot Diameter” of FIG. 107, it can be understood that differences in the diameters of spots formed on the surface of the photosensitive drum 21 are suppressed by suppressing the differences of the image-photosensitive member distances fd1 to fd4. Specifically, the diameter of the spots formed by the lenses LS2, LS3 in the working example 13 is 29.1 μm and the diameter of the spots formed by the lenses LS1, LS4 is 29.1 μm. Accordingly, a difference between the spot diameter by the lenses LS2, LS3 and the one by the lenses LS1, LS4 in the working example 13 is 0 μm (=29.1 μm-29.1 μm) and a remarkable improvement as compared to the spot diameter difference of 11.1 μm in the working example 2 can be understood. In other words, in the working example 13, the differences in the diameters of the spots formed by a plurality of lens rows LSR1 to LSR4 are further suppressed as compared to the working example 2.

In this way, in the working example 13, the lens thicknesses of the lenses LS1 to LS4 belonging to the mutually different lens rows LSR are constructed such that the focus positions FP1 to FP4 of the light beams by the plurality of respective lenses LS1 to LS4 conform to the curvature shape of the surface of the photosensitive drum 21 (latent image carrier surface). Accordingly, an occurrence of such a problem that the distances between the focus positions and the latent image carrier surface (image-photosensitive member distances) differ depending on the lens rows LSR as described above can be suppressed. As a result, a satisfactory exposure can be advantageously realized by suppressing the differences in the spot diameters as shown in FIG. 107.

As shown by pitch magnifications of FIG. 107, the pitch magnification of the lenses LS2, LS3 and that of the lenses LS1, LS4 differ. Specifically, the pitch magnification of the lenses LS2, LS3 is −0.5, whereas that of the lenses LS1, LS4 is −0.509. The cause of such a difference in the pitch magnification among the lenses LS1 to LS4 results from the construction of the lens thicknesses of the respective lenses LS1 to LS4 to adjust as above. In other words, the pitch magnifications differ among the lenses LS 1 to LS4 due to the construction of the lens thicknesses to suppress the occurrence of such an exposure failure that the diameters of the spots to be formed by the respective lenses LS1 to LS4 differ. Accordingly, there is a possibility of an occurrence of such an exposure failure that the spot pitches Psp differ due to the differences in the pitch magnifications of the lenses LS as described in the working example 7.

In order to cope with such a problem, in the working example 13, the arrangement of the plurality of light emitting elements 2951 are adjusted in each light emitting element group 295 in accordance with the pitch magnification of the lens LS corresponding to the light emitting element group 295 so that the spot pitch Psp becomes constant independently of the spot groups SG. Specifically, in each light emitting element group 295, the light emitting element pitch Pel and the light emitting element row pitch Pelr are adjusted in accordance with the pitch magnification of the lens LS corresponding to this light emitting element group 295 as described below.

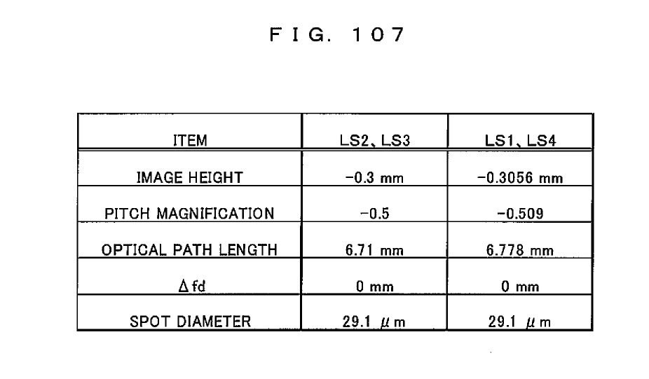

FIG. 108 is a group of tables showing the arrangement of the light emitting elements and the formation positions of the spots in the working example 13. In FIG. 108, the table titled with “Element Position 7-1” shows the positions of light emitting elements e1 to e14 in the light emitting element groups 295 corresponding to the lenses LS2, LS3, and the table titled with “Element Position 7-2” shows the positions of light emitting elements e1 to e14 in the light emitting element groups 295 corresponding to the lenses LS1, LS4. Further, the tables titled with “Spot Position 7-1” and “Spot Position 7-2” show the positions of spots s1 to s14 in the spot group SG formed on the photosensitive drum surface.

The light emitting element pitch Pel and the light emitting element row pitch Pelr are calculated from these tables shown in FIG. 108. In the light emitting element groups 295 corresponding to the lenses LS2, LS3, the light emitting element pitch Pel is 84.66 μm and the light emitting element row pitch Pelr is 200 μm. On the other hand, in the light emitting element groups 295 corresponding to the lenses LS1, LS4, the light emitting element pitch Pel is 83.16 μm and the light emitting element row pitch Pek is 196.46 μm. Thus, in the working example 13, the light emitting element pitch Pel and the light emitting element row pitch Pelr of the light emitting element groups 295 corresponding to the lenses LS2, LS3 are larger than those of the light emitting element groups 295 corresponding to the lenses LS1, LS4.

Specifically, as shown in FIG. 107, the pitch magnification of the lenses LS2, LS3 is smaller in absolute value than the pitch magnification of the lenses LS1, LS4. Accordingly, if the light emitting element pitch Pel and the light emitting element row pitch Pelr are the same in all the light emitting element groups 295, the spot pitch Psp of the spot groups SG by the lenses LS2, LS3 becomes smaller than the spot pitch Psp of the spot groups SG by the lenses LS1, LS4 and the spot row pitch Pspr of the spot groups SG by the lenses LS2, LS3 becomes smaller than the spot row pitch Pspr of the spot groups SG by the lenses LS1, LS4. Therefore, the spot pitch Psp and the spot row pitch Pspr differ depending on the spot groups SG.

Accordingly, in the working example 13, the light emitting element pitch Pel and the light emitting element row pitch Pelr of the light emitting element groups 295 corresponding to the lenses LS2, LS3 are made larger than those of the light emitting element groups 295 corresponding to the lenses LS1, LS4 based on the fact that the absolute value of the pitch magnification of the lenses LS2, LS3 is smaller than that of the pitch magnification of the lenses LS1, LS4. Specifically, the arrangement of the light emitting elements 2951 is adjusted in each light emitting element group 295 such that a product of the light emitting element pitch Pel and the pitch magnification of the lens LS corresponding to the light emitting element group 295 is substantially equal to a specified spot pitch Psp and a product of the light emitting element row pitch Pelr and the pitch magnification of the lens LS corresponding to the light emitting element group 295 is substantially equal to a specified spot row pitch Pspr.

The table titled with “Spot Position 7-1” in FIG. 108 shows the formation positions of the spots SP in the case where the arrangement of the light emitting elements 2951 is adjusted in accordance with the pitch magnification of the lens LS as described above. In other words, this table in FIG. 108 shows the positions of the spots SP in the spot group SG formed by each of the lenses LS1 to LS4. Thus, in the working example 13, the spot pitch Psp is 42.34 μm and the spot row pitch Pspr is 100 μm in each spot group SG. In other words, the spot pitch Psp and the spot row pitch Pspr are constant independently of the spot groups SG.

The table of FIG. 108 titled with “Spot Position 7-2” shows the formation positions of the spots SP in the spot groups SG formed by the lenses LS1, LS4 in the case where the light emitting elements 2951 are arranged as shown in “Element Position 7-1” of FIG. 108 in all the light emitting element groups 295. At this time, the formation positions of the spots SP in the spot groups SG formed by the lenses LS2, LS3 are as shown in “Spot Position 7-1”. From these tables, the spot pitch Psp of the spot groups SG formed by the lenses LS1, LS4 is 43.1 μm and different from the spot pitch of 42.34 μm of the spot groups SG formed by the lenses LS2, LS3. The spot row pitch Pspr of the spot groups SG formed by the lenses LS1, LS4 is 101.8 μm and different from the spot row pitch of 100 μm of the spot groups SG formed by the lenses LS2, LS3. In other words, by identically arranging the light emitting elements 2951 in all the light emitting element groups 295, there occurs such an exposure failure that the spot pitch Psp and the spot row pitch Psgr differ depending on the spot groups SG.

In this way, in the working example 13, the arrangement of the plurality of light emitting elements 2951 is adjusted in each light emitting element group 295 in accordance with the pitch magnification of the lens LS corresponding to the light emitting element group 295 so that the spot pitch Psp becomes constant independently of the spot groups SG.

Accordingly, even if the pitch magnification differs depending on the lenses LS due to the construction of the lens thicknesses (lens configurations) of the lenses LS, the spot pitches Psp of the plurality of spots SP formed on the photosensitive drum surface (latent image carrier surface) are substantially constant independently of the spot groups SG. This is preferable since a satisfactory spot formation is possible.

In the working example 13, the focus positions FP1 to FP4 are set at the positions in conformity with the curvature shape of the surface of the photosensitive drum 21 by adjusting the lens thicknesses. However, not only the lens thicknesses (lens configurations) of the lenses LS, but also the lens shapes (lens configurations) and the lens positions thereof may be constructed to adjust as above, for example, as shown in a working example 14 below.

### Working Example 14

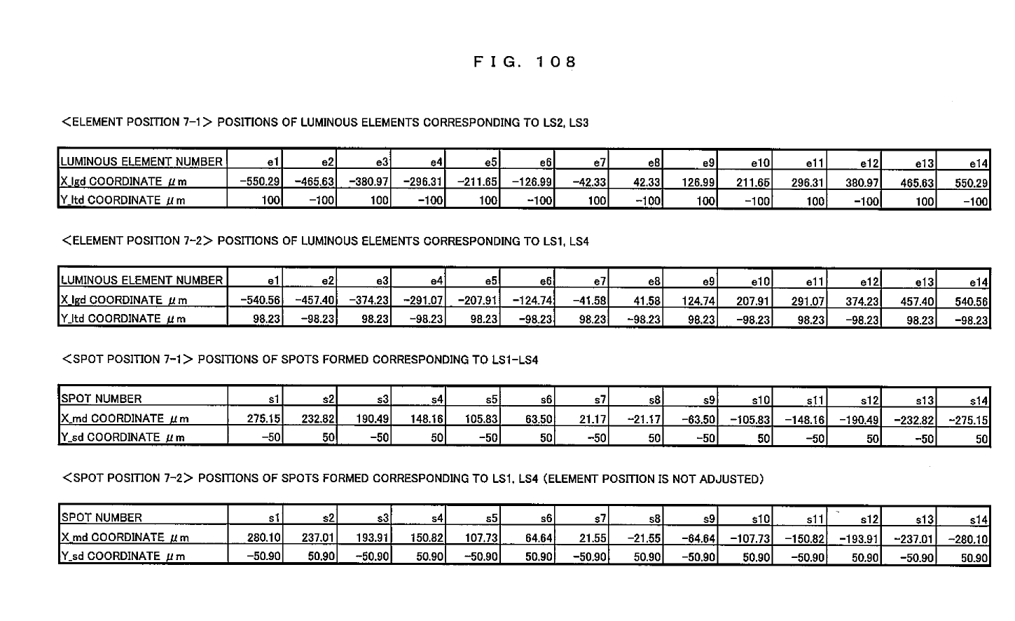

FIG. 109 is a sectional view along the sub scanning direction showing the relationship of arrangement of a lens array and a photosensitive drum according to the working example 14 of the invention. An upper side of FIG. 109 enlargedly shows a rectangular part enclosed by broken line in a lower side of FIG. 109. Lenses LS1 to LS4 in the lower side of FIG. 109 are lenses belonging to mutually different lens rows LSR1 to LSR4.

The relationship of arrangement of the lens array 299 and the photosensitive drum 21 in the working example 14 is the same as in the working example 2. Specifically, the respective lens rows LSR1 to LSR4 face facing positions FCP1 to FCP4 of the photosensitive drum surface (latent image carrier surface) mutually different in the sub scanning direction SD. Accordingly, focus positions FP1 to FP4 of light beams focused by the lenses LS1 to LS4 belonging to the different lens rows LSR1 to LSR4 mutually differ in the sub scanning direction SD. Accordingly, if the lens configurations and the lens positions of all the lenses LS are the same as in the working example 2, spot diameter differences to such an extent as shown in the working example 2 occur. On the contrary, in the working example 14 of the invention, the focus positions FP1 to FP4 of the light beams by the lenses LS1 to LS4 are set at positions in conformity with the curvature shape of the surface of the photosensitive drum 21 (FIG. 109). The lens shapes (lens configurations), the lens thicknesses (lens configurations) and the lens positions of the lenses LS1 to LS4 are constructed to conform the focus positions FP1 to FP4 to the curvature shape in this way. This construction is specifically as follows.

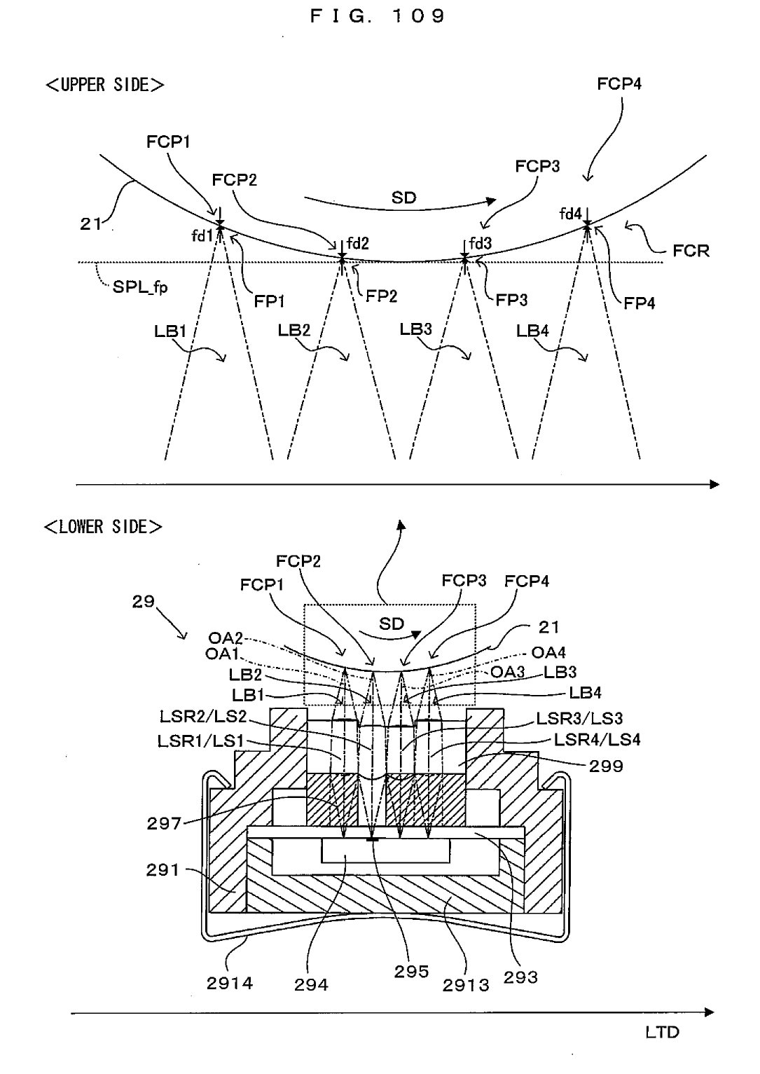

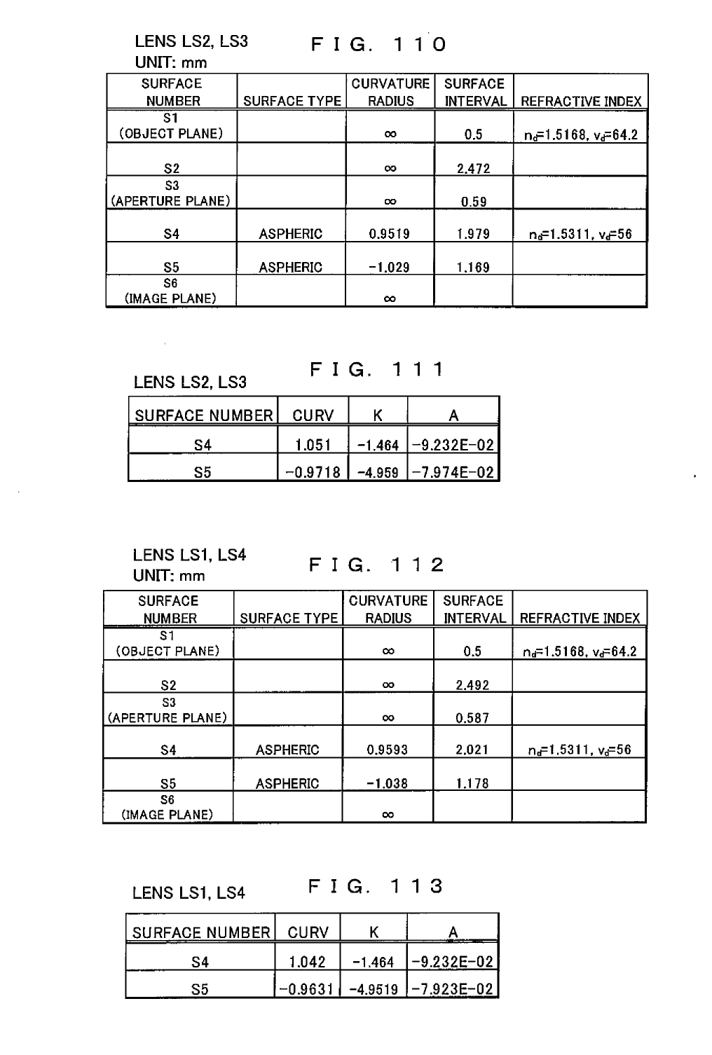

FIG. 110 shows the lens data of the lenses LS2, LS3, and FIG. 111 shows the aspherical surface coefficients of the lenses LS2, LS3. On the other hand, FIG. 112 shows the lens data of the lenses LS1, LS4, and FIG. 113 shows the aspherical surface coefficients of the lenses LS1, LS4. The aspherical surface coefficients of the second surfaces LSFs (that is, lens shapes) differ between the lenses LS2, LS3 and the lenses LS1, LS4. Further, as can be understood from a difference in the sum of the surface intervals from the surface number S1 to the surface number S3 between FIG. 110 and FIG. 112, the lens positions differ between the lenses LS2, LS3 and the lenses LS1, LS4 in the working example 14. Further, as can be seen from a difference in the surface interval of the surface number S4 between FIG. 110 and FIG. 112, the lens thicknesses differ between the lenses LS2, LS3 and the lenses LS1, LS4 in the working example 14. The specification of an optical system used in a simulation of the working example 14 is similar to the contents shown in FIG. 19 of the working example 1. Thus, the lenses LS1 and LS4 are the same and the lenses LS2 and LS3 are the same in the working example 14 of the invention. On the other hand, the lenses LS1, LS4 differ from the lenses LS2, LS3.

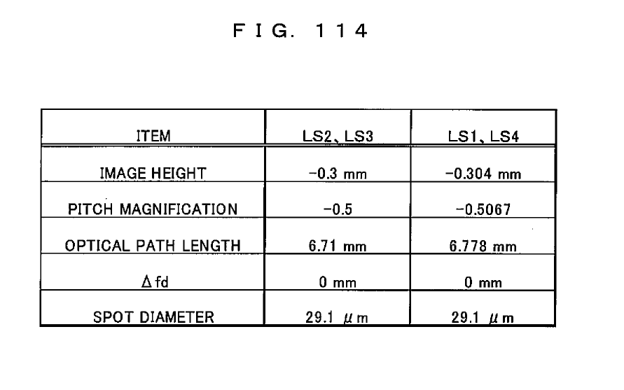

FIG. 114 shows a simulation result in the case where the lenses LS1 to LS4 are formed based on the data given by above FIG. 110 to FIG. 113. In this simulation, a lens row pitch Plsr, a light emitting element group row pitch Pegr, a photosensitive drum diameter and other conditions are the same as in the working example 2. Optical path lengths in FIG. 114 are those from the position of an object height of 0.6 mm (see FIG. 19) to the positions of image heights corresponding to the respective lenses LS1 to LS4 (according to FIG. 114, the image heights corresponding to the lenses LS2, LS3 are −0.3 mm and those corresponding to the lenses LS1, LS4 are −0.304 mm).

Differences Δfd shown in FIG. 114 are differences between image-photosensitive member distances fd1 to fd4 corresponding to the lenses LS1 to LS4 and the image-photosensitive member distance fd2. In other words, the differences Δfd among the image-photosensitive member distances fd1 to fd4 are calculated based on the image-photosensitive member distance fd2. As shown in FIG. 114, the differences Δfd are 0 in the working example 14. In other words, the image-photosensitive member distances fd1 to fd4 are equal to each other. This is because the focus positions FP1 to FP4 of the light beams by the lenses LS1 to LS4 are adjusted to the positions in conformity with the curvature shape of the photosensitive drum 21 (substantially on the surface of the photosensitive drum 21 as shown in FIG. 109 in the working example 14) as shown in FIG. 109. As shown in a column “Spot Diameter” of FIG. 114, it can be understood that differences in the diameters of spots formed on the surface of the photosensitive drum 21 are suppressed by suppressing the differences of the image-photosensitive member distances fd1 to fd4. Specifically, the diameter of the spots formed by the lenses LS2, LS3 in the working example 14 is 29.1 μm and the diameter of the spots formed by the lenses LS1, LS4 is 29.1 μm. Accordingly, a difference between the spot diameter by the lenses LS2, LS3 and the one by the lenses LS1, LS4 in the working example 14 is 0 μm (−29.1 μm-29.1 μm) and a remarkable improvement as compared to the spot diameter difference of 11.1 μm in the working example 2 can be understood. In other words, in the working example 14, the differences in the diameters of the spots formed by a plurality of lens rows LSR1 to LSR4 are further suppressed as compared to the working example 2.

In this way, in the working example 14, the lens shapes, the lens thicknesses and the lens positions of the lenses LS1 to LS4 belonging to the mutually different lens rows LSR are constructed such that the focus positions FP1 to FP4 of the light beams by the plurality of respective lenses LS1 to LS4 conform to the curvature shape of the surface of the photosensitive drum 21 (latent image carrier surface). Accordingly, an occurrence of such a problem that the distances between the focus positions and the latent image carrier surface (image-photosensitive member distances) differ depending on the lens rows LSR as described above can be suppressed. As a result, a satisfactory exposure can be advantageously realized by suppressing the differences in the spot diameters as shown in FIG. 114.

As shown by pitch magnifications of FIG. 114, the pitch magnification of the lenses LS2, LS3 and that of the lenses LS1, LS4 differ. Specifically, the pitch magnification of the lenses LS2, LS3 is −0.5, whereas that of the lenses LS1, LS4 is −0.5067. The cause of such a difference in the pitch magnification among the lenses LS1 to LS4 results from the construction of the lens shapes, the lens thicknesses and the lens positions of the respective lenses LS1 to LS4 to adjust as above. In other words, the pitch magnifications differ among the lenses LS 1 to LS4 due to the construction of the lens shapes, the lens thicknesses and the lens positions to suppress the occurrence of such an exposure failure that the diameters of the spots to be formed by the respective lenses LS1 to LS4 differ. Accordingly, there is a possibility of an occurrence of such an exposure failure that the spot pitches Psp differ due to the differences in the pitch magnifications of the lenses LS as described in the working example 7.

In order to cope with such a problem, in the working example 14, the arrangement of the plurality of light emitting elements 2951 are adjusted in each light emitting element group 295 in accordance with the pitch magnification of the lens LS corresponding to the light emitting element group 295 so that the spot pitch Psp becomes constant independently of the spot groups SG. Specifically, in each light emitting element group 295, the light emitting element pitch Pel and the light emitting element row pitch Pelr are adjusted in accordance with the pitch magnification of the lens LS corresponding to this light emitting element group 295 as described below.

FIG. 115 is a group of tables showing the arrangement of the light emitting elements and the formation positions of the spots in the working example 14. In FIG. 115, the table titled with “Element Position 8-1” shows the positions of light emitting elements e1 to e14 in the light emitting element groups 295 corresponding to the lenses LS2, LS3, and the table titled with “Element Position 8-2” shows the positions of light emitting elements e1 to e14 in the light emitting element groups 295 corresponding to the lenses LS1, LS4. Further, the tables titled with “Spot Position 8-1” and “Spot Position 8-2” show the positions of spots s1 to s14 in the spot group SG formed on the photosensitive drum surface.

The light emitting element pitch Pel and the light emitting element row pitch Pelr are calculated from these tables shown in FIG. 115. In the light emitting element groups 295 corresponding to the lenses LS2, LS3, the light emitting element pitch Pel is 84.66 μm and the light emitting element row pitch Pelr is 200 μm. On the other hand, in the light emitting element groups 295 corresponding to the lenses LS1, LS4, the light emitting element pitch Pel is 83.54 μm and the light emitting element row pitch Pelr is 197.36 μm. Thus, in the working example 14, the light emitting element pitch Pel and the light emitting element row pitch Pelr of the light emitting element groups 295 corresponding to the lenses LS2, LS3 are larger than those of the light emitting element groups 295 corresponding to the lenses LS1, LS4.

Specifically, as shown in FIG. 114, the pitch magnification of the lenses LS2, LS3 is smaller in absolute value than the pitch magnification of the lenses LS1, LS4. Accordingly, if the light emitting element pitch Pel and the light emitting element row pitch Pelr are the same in all the light emitting element groups 295, the spot pitch Psp of the spot groups SG by the lenses LS2, LS3 becomes smaller than the spot pitch Psp of the spot groups SG by the lenses LS1, LS4 and the spot row pitch Pspr of the spot groups SG by the lenses LS2, LS3 becomes smaller than the spot row pitch Pspr of the spot groups SG by the lenses LS1, LS4. Therefore, the spot pitch Psp and the spot row pitch Pspr differ depending on the spot groups SG.

Accordingly, in the working example 14, the light emitting element pitch Pel and the light emitting element row pitch Pelr of the light emitting element groups 295 corresponding to the lenses LS2, LS3 are made larger than those of the light emitting element groups 295 corresponding to the lenses LS1, LS4 based on the fact that the absolute value of the pitch magnification of the lenses LS2, LS3 is smaller than that of the pitch magnification of the lenses LS1, LS4. Specifically, the arrangement of the light emitting elements 2951 is adjusted in each light emitting element group 295 such that a product of the light emitting element pitch Pel and the pitch magnification of the lens LS corresponding to the light emitting element group 295 is substantially equal to a specified spot pitch Psp and a product of the light emitting element row pitch Pelr and the pitch magnification of the lens LS corresponding to the light emitting element group 295 is substantially equal to a specified spot row pitch Pspr.

The table titled with “Spot Position 8-1” in FIG. 115 shows the formation positions of the spots SP in the case where the arrangement of the light emitting elements 2951 is adjusted in accordance with the pitch magnification of the lens LS as described above. In other words, this table in FIG. 115 shows the positions of the spots SP in the spot group SG formed by each of the lenses LS1 to LS4. Thus, in the working example 14, the spot pitch Psp is 42.34 μm and the spot row pitch Pspr is 100 μm in each spot group SG. In other words, the spot pitch Psp and the spot row pitch Pspr are constant independently of the spot groups SG.

The table of FIG. 115 titled with “Spot Position 8-2” shows the formation positions of the spots SP in the spot groups SG formed by the lenses LS1, LS4 in the case where the light emitting elements 2951 are arranged as shown in “Element Position 8-1” of FIG. 115 in all the light emitting element groups 295. At this time, the formation positions of the spots SP in the spot groups SG formed by the lenses LS2, LS3 are as shown in “Spot Position 8-1”. From these tables, the spot pitch Psp of the spot groups SG formed by the lenses LS1, LS4 is 42.9 μm and different from the spot pitch of 42.34 μm of the spot groups SG formed by the lenses LS2, LS3. The spot row pitch Pspr of the spot groups SG formed by the lenses LS1, LS4 is 101.34 μm and different from the spot row pitch of 100 μm of the spot groups SG formed by the lenses LS2, LS3. In other words, by identically arranging the light emitting elements 2951 in all the light emitting element groups 295, there occurs such an exposure failure that the spot pitch Psp and the spot row pitch Psgr differ depending on the spot groups SG.

In this way, in the working example 14, the arrangement of the plurality of light emitting elements 2951 is adjusted in each light emitting element group 295 in accordance with the pitch magnification of the lens LS corresponding to the light emitting element group 295 so that the spot pitch Psp becomes constant independently of the spot groups SG. Accordingly, even if the pitch magnification differs depending on the lenses LS due to the construction of the lens shapes (lens configurations), the lens thicknesses (lens configurations) and the lens positions of the lenses LS, the spot pitches Psp of the plurality of spots SP formed on the photosensitive drum surface (latent image carrier surface) are substantially constant independently of the spot groups SG. This is preferable since a satisfactory spot formation is possible.

### Working Example 15

In the line head 29 using a plurality of lens rows LSR, a line latent image extending in the main scanning direction MD is formed by successively forming spots by the lens rows LSR from the one facing the upstream side in the sub scanning direction SD as described with reference to FIG. 14. However, there are cases where the spots SP formed by one lens row LSR change with time during a period from the formation of the spots SP by the one lens row LSR to that of the spots SP by the next lens row LSR. If such a change with time of the spots SP occurs, there have been cases where the spots SP formed on the photosensitive drum surface differ depending on the lens rows LSR.

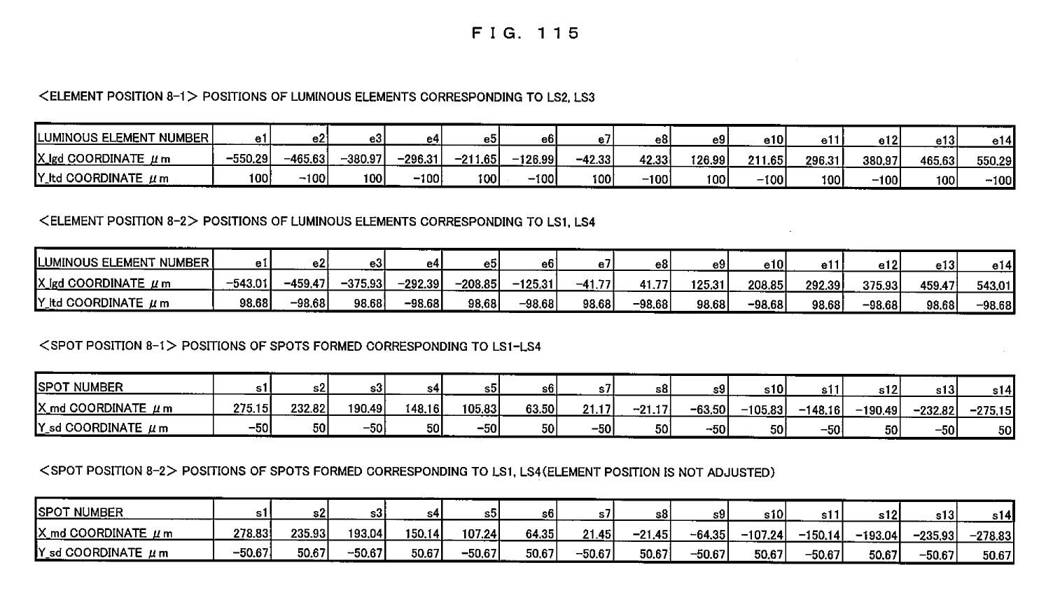

FIG. 116 is a graph showing a change with time of spots, in which a horizontal axis represents positions on the photosensitive drum surface and a vertical axis represents surface potentials of the photosensitive drum surface. In FIG. 116, a surface potential SV50 m is the surface potential of the spots upon the lapse of a period of 50 ms after the exposure, a surface potential SV70 m is the surface potential of the spots upon the lapse of a period of 70 ms after the exposure, and a surface potential SV100 m is the surface potential of the spots upon the lapse of a period of 100 ms after the exposure. As described above, if the uniformly charged photosensitive drum surface is exposed to spot light beams, electric charges in this exposed part are removed to reduce the surface potential, whereby the spots SP are formed. However, as shown in FIG. 116, an area where the surface potential is reduced (that is, area where the spots SP are formed) spread with time. As a result, the width of the spots SP increases from width WS50 m to WS100 m with time.

In the event of forming the spots SP, the spot diameters of these spots SP tend to increase with time in this way. Accordingly, there have been cases where the spots SP formed by the lens rows LSR facing the more upstream side in the sub scanning direction SD have a larger spot diameter as shown in FIG. 117 when the spots SP finally reach a developing position and, therefore, no satisfactory image formation can be realized. Here, FIG. 117 is a graph showing the spot diameters of the spots formed by the respective lens rows at the developing position. In FIG. 117 and a working example 15 shown below, the relationship of arrangement of the respective lens rows LSR1 to LSR3 and the photosensitive drum is the same as the one shown in FIGS. 21 and 22, and the lens rows LSR1 to LSR3 respectively face facing positions FCP1 to FCP3. Accordingly, in the working example 15, the more upstream the lens row LSR faces in the sub scanning direction SD, the smaller diameter the spots formed thereby have, so that the spot diameters of the respective spots SP are substantially equal upon arriving at the developing position. Lens data for realizing such a line head are shown and a simulation result based on this lens data is described below in order to facilitate the understanding of the invention.

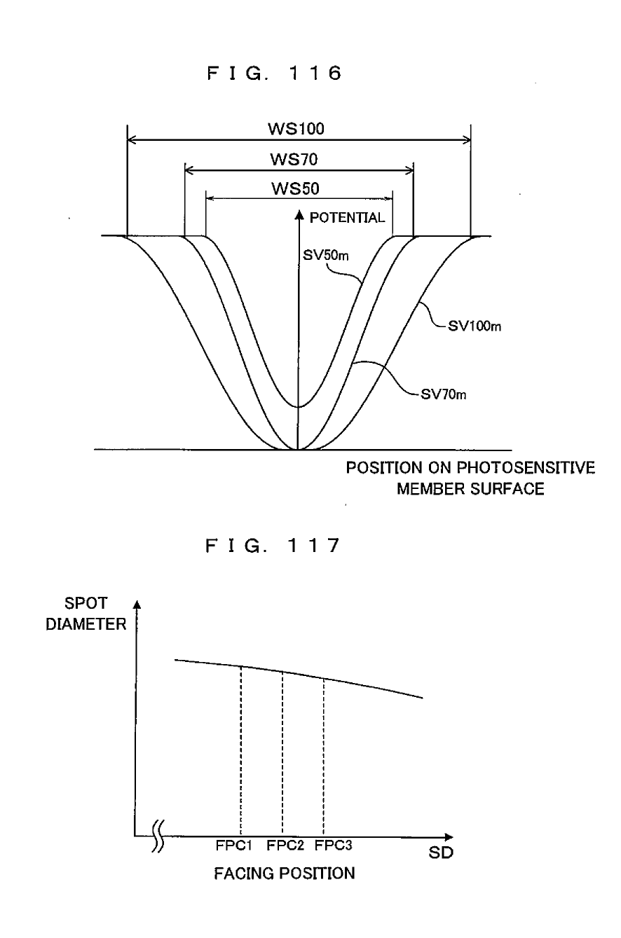

FIG. 118 shows the lens data of the lenses LS used in a simulation of the working example 15. Surface numbers S1 to S6 are as described with reference to FIGS. 9 and 10.

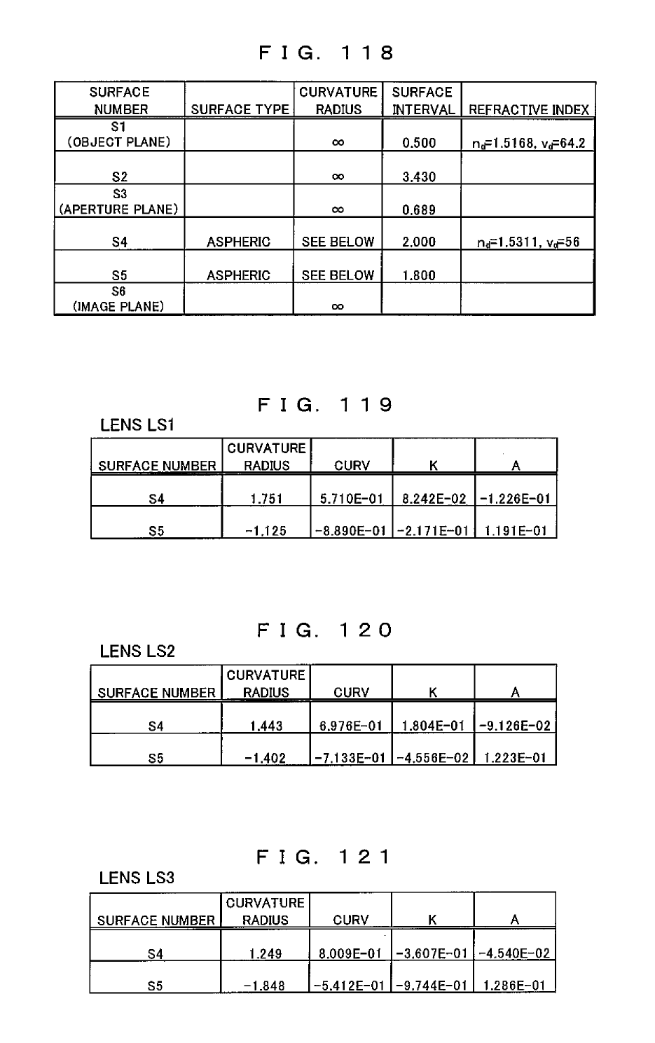

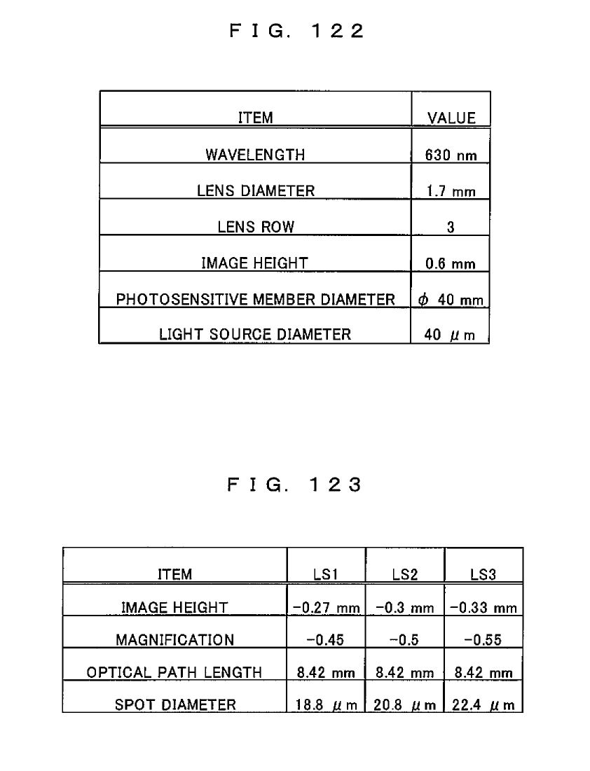

FIG. 119 shows the aspherical surface coefficients of aspherical surfaces S4, S5 of the lens LS1 of the lens row LSR1, FIG. 120 shows the aspherical surface coefficients of aspherical surfaces S4, S5 of the lens LS2 of the lens row LSR2, and FIG. 121 shows the aspherical surface coefficients of aspherical surfaces S4, S5 of the lens LS3 of the lens row LSR3.

FIG. 122 shows the specification of an optical system used in the simulation of the working example 15. Here, wavelength is that of light beams emitted from light emitting elements; a lens diameter is the diameter of emergence surfaces, that is, second surfaces LSFs, of the lenses LS; and a lens row number is the number of the lens rows LSR, that is, three in this working example. An object height of 0.6 mm in this specification means that the simulation was conducted on the condition that the light beam was emitted from a virtual light emitting element located at an object height of 0.6 mm. A photosensitive member diameter is the diameter of the photosensitive drum 21, and a light source diameter is the diameter of light emitting elements 2951.

FIG. 123 shows a simulation result in the case where the lenses LS1 to LS3 are formed based on the data given by above FIG. 118 to FIG. 122. In this simulation, a lens row pitch Plsr, a light emitting element group row pitch Pegr, a photosensitive drum diameter and other conditions are the same as in the working example 1. Optical path lengths in FIG. 123 are those from the position of an object height of 0.6 mm (see FIG. 122) to the positions of image heights corresponding to the respective lenses LS1 to LS3 (according to FIG. 123, the image height corresponding to the lens LS1 is −0.27 mm, the one corresponding to the lens LS2 is −0.3 mm and the one corresponding to the lens LS3 are −0.33 mm). The spot diameter in FIG. 123 is that of spots upon being exposed to light beams (in other words, just formed spots).

As shown in FIG. 123, in the working example 15, the more upward in the sub scanning direction SD the lens row LSR faces, the smaller magnification it has. Specifically, the magnification of the lens LS1 facing the most upstream facing position FCP1 is −0.45; the magnification of the lens LS2 facing the facing position FCP2 downstream of the facing position FCP1 is −0.5; and the magnification of the lens LS3 facing the most downstream facing position FCP3 is −0.55. As a result, the more upstream in the sub scanning direction SD the lens LS faces, the smaller spot diameter the spots formed thereby have. Specifically, the spot diameter of the spots formed by the lens LS1 facing the most upstream facing position FCP1 is 18.8 μm; the spot diameter of the spots formed by the lens LS2 facing the facing position FCP2 downstream of the facing position FCP1 is 20.8 μm; and the spot diameter of the spots formed by the lens LS3 facing the most downstream facing position FCP3 is 22.4 μm.

As described above, in the working example 15, the more upstream in the sub scanning direction SD the lens LS faces, the smaller spot diameter the spots formed thereby have. Thus, the spot diameters of the respective spots SP can lie within a specific range when the spots SP finally arrive at the developing position, thereby being able to suppress an exposure failure and an image formation failure result from the change with time of the spot diameters.

The working example 15 is preferable because, the more upstream in the sub scanning direction SD the lens LS faces, the smaller magnification the formed spots SP have. In other words, this enables the line head to be constructed such that the more upstream in the sub scanning direction SD the lens LS faces, the smaller spot diameters the formed spots SP have only by adjusting the magnification of the imaging optical system. Therefore, the exposure failure resulting from the change with time of the spot diameters can be easily suppressed.

As described above, various exposure failures occur due to the fact that the plurality of respective lens rows face positions mutually different in the sub scanning direction SD. Specifically, if the photosensitive member surface has a curvature, there have been cases where the image-photosensitive member distances fd differ among the lenses LS facing the different facing positions FCP to cause an exposure failure. Alternatively, there have been cases where, due to a change with time of the spots SP formed on the photosensitive member surface, the spots SP formed by the lens LS facing the more upward facing position FCP in the sub scanning direction SD have a larger spot diameter to cause an exposure failure. On the contrary, in the above working examples 3 to 15, the respective lenses LS are constructed in accordance with the differences of the facing positions FCP on the photosensitive member surface. Therefore, the line heads 29 shown in the working examples 3 to 15 can advantageously suppress an occurrence of the exposure failure resulting from the fact that the plurality of respective lens rows face positions mutually different in the sub scanning direction SD.

As described above, in the above embodiment, the main scanning direction MD corresponds to a “first direction” of the invention and the sub scanning direction SD to a “second direction” of the invention. Further, the photosensitive drum 21 corresponds to a “latent image carrier” of the invention. Further, the surface of the photosensitive drum 21 and the image plane IP correspond to a “latent image-forming surface” of the invention. Furthermore, the lenses LS, LS 1, LS2, LS3 and LS4 correspond to “imaging optical systems” of the invention and the lens array 299 to an “array” of the invention.

Example of a Method for Calculating a Focus Position

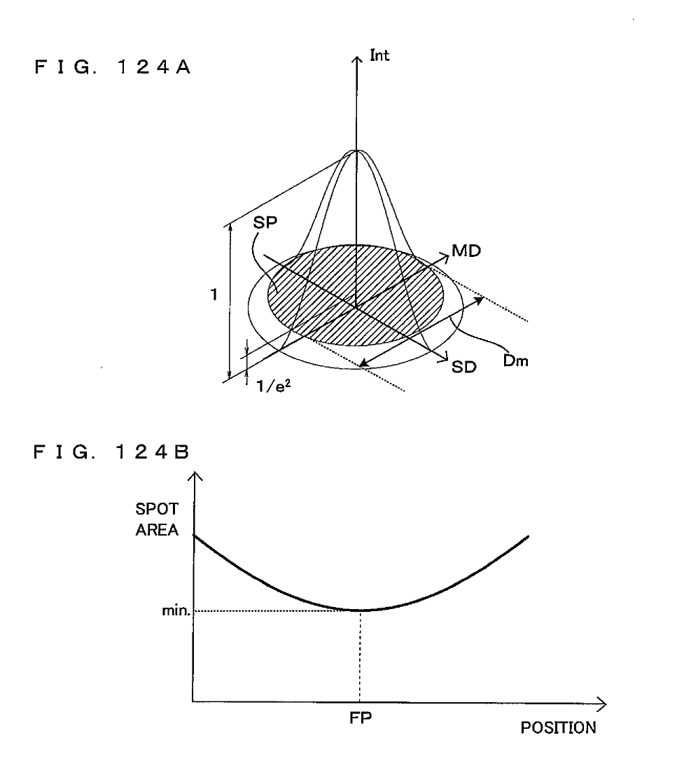

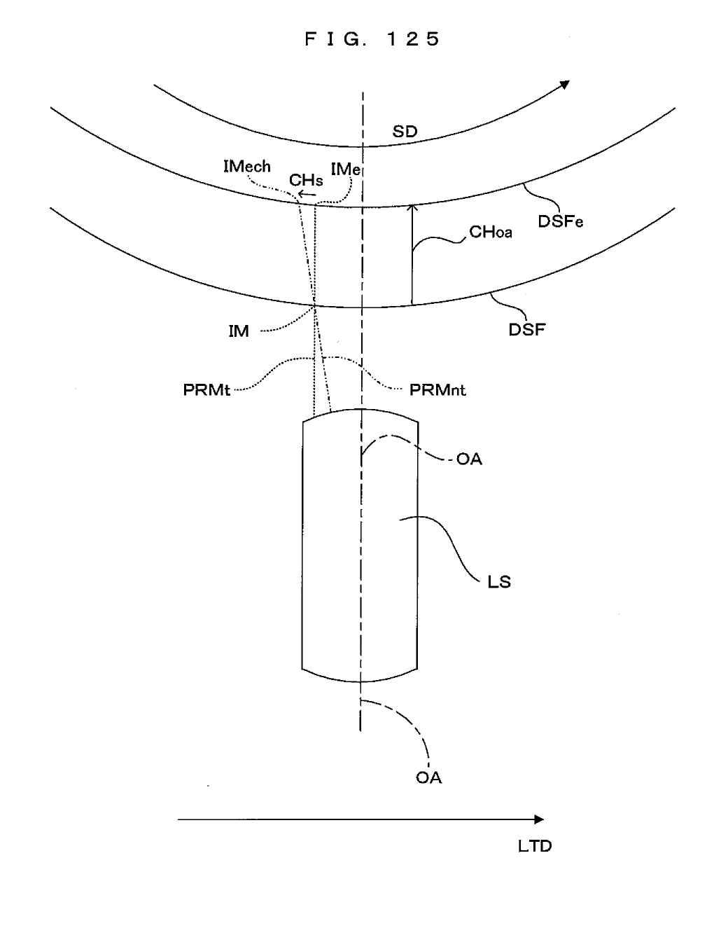

The focus position FP is described above to be the position and its vicinity where the light beam LB having passed through the lens LS forms an image with the smallest spot diameter. Here, an example of a method for calculating this focus position is introduced. FIGS. 124A and 124B are graphs showing the example of the method for calculating the focus position. In this example, the focus position is calculated from an area of a spot SP, which is defined as shown in FIG. 124A. Specifically, when the height of a peak of a light intensity Int of a light beam is assumed to be “1”, an area where the light intensity Int is “1/e²” is the spot SP. Here, “e” is the base of natural logarithm. A position where the area of the spot SP has a minimum value min can be calculated as the focus position PP. Alternatively, the focus position FP may be calculated as follows. Specifically, the position where the area of the spot SP is minimized is calculated as the focus position FP in the above method, whereas a position where a spot diameter Dm of the spot SP in the main scanning direction MD is minimized may be calculated as the focus position FP.

Others

The invention is not limited to the above embodiments and various changes other than those described above can be made to such an extent as not to depart from the gist of the invention. For example, although the imaging optical system is constituted by one lens LS in the above working examples 1 to 15, two lenses LS may constitute the imaging optical system.

In the above working examples 1 and 2, the lens rows LSR are arranged at the lens row pitches Plsr in the width direction LTD and are substantially symmetrically arranged in the width direction LTD with respect to the symmetry axis SA substantially normal to the width direction LTD in the section along the sub scanning direction. Further, the line head 29 is arranged such that the symmetry axis SA passes the curvature center CC21 of the surface shape of the photosensitive drum 21. However, it is not essential for the symmetry axis SA to pass the curvature center CC21 of the photosensitive drum 21. In short, by arranging the line head 29 such that the image-plane facing distance ld of the lens LS belonging to the lens row LSR other than the end lens rows LSR at the respective ends in the width direction LTD is shorter than those of the lenses LS belonging to the end lens rows LSR, the effect of the invention to suppress the difference ld_max of the image-plane facing distances ld can be fulfilled. However, such an arrangement of the line head 29 that the symmetry axis SA passes the curvature center CC21 of the surface shape of the photosensitive drum 21 is preferable in more effectively suppressing the image-plane facing distances ld as described above.

Further, in the above working examples 1 and 2, the lens rows LSR are arranged at the lens row pitches Plsr in the width direction LTD and are substantially symmetrically arranged in the width direction LTD with respect to the symmetry axis SA substantially normal to the width direction LTD in the section along the sub scanning direction. The line head 29 is arranged such that the image-plane facing distance ld of the lens LS belonging to the lens row LSR (middle lens row) closest to the symmetry axis SA is shorter than the image-plane facing distances ld of the lenses LS belonging to the respective lens rows LSR other than the middle lens row LSR. However, such a construction is not essential. In short, by arranging the line head 29 such that the image-plane facing distance ld of the lens LS belonging to the lens row LSR other than the end lens rows LSR at the respective ends in the width direction LTD is shorter than that of the lenses LS belonging to the end lens rows LSR, the difference ld_max of the image-plane facing distances ld can be suppressed. However, such an arrangement of the line head 29 that the image-plane facing distance ld of the lens LS belonging to the middle lens row is shorter than the image-plane facing distances id of the lenses LS belonging to the respective lens rows LSR other than the middle lens row LSR is preferable in more effectively suppressing the image-plane facing distances ld as described above.

In the above working examples 1 and 2, the cases of three or four lens rows LSR are described. However, the number of the lens rows LSR is not limited to these and the invention is applicable to the line head 29 having N lens rows, where N is an integer equal to or greater than 3.

In the working examples 3 to 14, the line head 29 is arranged relative to the photosensitive drum 21 as described with reference to FIGS. 22 and 28. Specifically, the line head 29 is arranged relative to the photosensitive drum 21 such that the symmetry axis SA of a plurality of lens rows LSR arranged side by side in the width direction LTD passes the curvature center CC21 of the photosensitive drum 21. However, the arrangement mode of the line head 29 relative to the photosensitive drum 21 is not limited to this. In short, the line head 29 may be arranged relative to the photosensitive drum 21 such that the symmetry axis SA passes a position deviated from the curvature center CC21 of the photosensitive drum 21. However, by arranging the line head 29 such that the symmetry axis SA passes the curvature center CC21 of the photosensitive drum 21, an effect of being able to simplify the lens design or manufacturing can be obtained. This is described below.

Specifically, in the case of arranging the line head 29 such that the symmetry axis SA passes the curvature center CC21 of the photosensitive drum 21, the image-plane facing distances ld of the two lenses LS symmetrical with each other with respect to the symmetry axis SA are substantially equal to each other. Specifically, in FIG. 22, the image-plane facing distances ld1, ld3 of the lenses LS1, LS3 are substantially equal. In FIG. 28, the image-plane facing distances ld1, ld4 of the lenses LS1, LS4 are substantially equal and the image-plane facing distances ld2, ld3 of the lenses LS2, LS3 are substantially equal.

Accordingly, as described above, the lens configurations and the lens positions of the two lenses LS symmetrical with each other with respect to the symmetry axis SA can be made substantially identical upon conforming the focus positions FP of the lenses LS to the curvature shape of the photosensitive drum surface. Specifically, in the working examples 3 and 4, the lens configurations and the lens positions of the lenses LS1, LS3 are made identical. In the working examples 5 and 6, the lens configurations and the lens positions of the lenses LS1, LS4 are made identical. In other words, the lens constructions and the lens positions of the two lenses LS symmetrical with each other with respect to the symmetry axis SA can be made common. Therefore, such an arrangement of the line head 29 that the symmetry axis SA passes the curvature center CC21 of the photosensitive drum 21 is preferable because the lens design or manufacturing can be simplified.

In light of simplifying the lens design or manufacturing, a plurality of lenses LS constituting the lens row LSR may have the same lens configuration in each of a plurality of lens rows LSR. Specifically, as described with reference to FIGS. 5, 6, 12 and other figures, the lens row LSR is formed by aligning a plurality of lenses LS in the longitudinal direction LGD. All the plurality of lenses forming the same lens rows LSR may have the same lens configuration. This is because the lens configurations and the lens positions of the plurality of lenses belonging to the same lens row can be made common and the lens design or manufacturing can be simplified.

In the above working examples 7 to 14, the light emitting element row pitches Pelr are adjusted in accordance with the pitch magnification of the lenses LS. However, the construction for changing the light emitting element row pitches Pelr in accordance with the pitch magnification of the lenses LS is not essential to the invention. This is because the line head 29 exposes the photosensitive drum surface being conveyed in the sub scanning direction SD as described with reference to FIG. 14. At this time, the line head 29 causes the respective light emitting elements 2951 to emit lights at timings in conformity with a movement of the photosensitive drum 21 in the sub scanning direction SD and focuses the light beams emitted from the light emitting elements 2951 at positions mutually different in the main scanning direction MD to form the spots SP aligned in the main scanning direction MD.

Specifically, the light emitting elements 2951 belonging to the different light emitting element rows 2951R emit lights at mutually different timings. As a result, a plurality of spots SP are aligned substantially along a straight line in the main scanning direction MD in each spot group SG. Thus, even if the spot row pitches Pspr of the spot groups SG formed with the photosensitive drum surface held stationary differ depending on the spot groups SG due to differences in the pitch magnifications of the corresponding lenses LS as shown in the above working examples, the linearity of the spots SP aligned in the main scanning direction MD can be realized by controlling the light emission timings of the light emitting elements 2951 in conformity with the conveyance of the photosensitive drum surface. However, by adjusting the light emitting element row pitches Pelr in accordance with the pitch magnifications of the corresponding lenses LS, the light emission timings of the light emitting elements 2951 can be controlled without considering the differences in the pitch magnifications of the lenses LS. Therefore, the construction for adjusting the light emitting element row pitches Pelr in accordance with the pitch magnifications of the lenses LS is preferable because the linearity of the spot groups formed on the photosensitive drum surface can be easily realized.

As described with reference to FIGS. 9 and 10, the aperture diaphragm DIA is disposed at the front focus of the lens LS and the image side of the lens LS is constructed to be telecentric in the above embodiment. However, it is not essential to the invention to telecentrically construct the image side of the lens LS. However, there are cases where the distance between the lens LS and the photosensitive drum surface changes due to the decentering of the photosensitive drum 21 and the like. Such a change might possibly induce displacements of the positions of the spots formed on the photosensitive drum surface in the sub scanning direction SD. On the other hand, the telecentrically constructed lens LS is preferable because an effect of suppressing such displacements of the spot positions in the sub scanning direction SD can be fulfilled and a satisfactory exposure can be realized. This is described in detail.

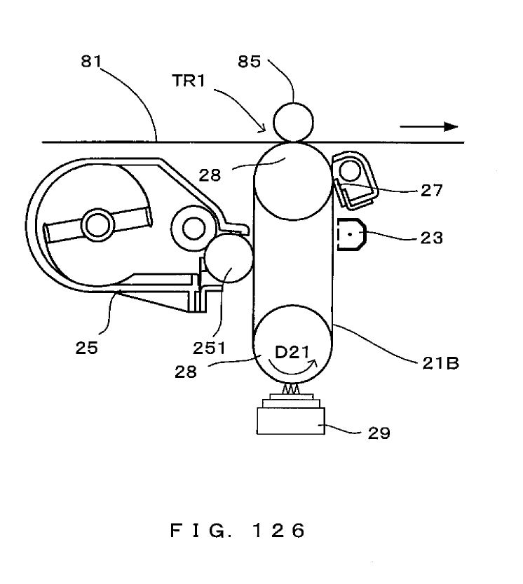

FIG. 125 is a sectional view along the sub scanning direction showing an effect in the case where an image side of a lens is constructed to be telecentric. A surface DSF represents the surface of the photosensitive drum 21 with no decentering. A surface DSFe is a surface of the photosensitive drum 21 displaced by a distance CHoa in a direction of an optical axis OA of a lens LS due to the decentering of the photosensitive drum 21. A chief ray PRMt is that of a light beam for forming a spot at a position IM on the photosensitive drum surface in the case where an image-side telecentric system is realized. On the other hand, a chief ray PRMnt is that of a light beam for forming a spot at the position IM on the photosensitive drum surface in the case where the image-side telecentric system is not realized. In other words, the positions of the chief rays PRMt and PRMnt on the surface of the photosensitive drum 21 are the same when the photosensitive drum 21 is not decentered.

Here is thought a case where the surface of the photosensitive drum 21 is displaced by the distance CHoa in the direction of the optical axis OA of the lens LS due to the decentering of the photosensitive drum 21. At this time, a spot is formed at a position IMe by the light beam having the chief ray PRMt. On the other hand, a spot is formed at a position IMech by the light beam having the chief ray PRMnt. As shown in FIG. 125, when the image-side telecentric system is realized, the chief ray PRMt of the light beam is parallel to the optical axis OA of the lens LS. Accordingly, even if the surface of the photosensitive drum 21 is displaced in the direction of the optical axis OA, the position of the spot to be formed is only displaced in the direction of the optical axis OA, but hardly displaced in the sub scanning direction SD. On the other hand, when the image-side telecentric system is not realized, the chief ray PRMnt of the light beam is not parallel to the optical axis OA of the lens LS. Accordingly, if the surface of the photosensitive drum 21 is displaced in the direction of the optical axis OA, the position of the spot to be formed is displaced by a distance CHs in the sub scanning direction SD. Thus, the telecentrically constructed lens LS is preferable because an effect of suppressing such a displacement of the spot position in the sub scanning direction SD can be fulfilled and a satisfactory exposure can be realized.

In the above embodiment, the photosensitive drum 21 is used as the latent image carrier However, the latent image carrier, to which the invention is applicable, is not limited to the photosensitive drum 21. In short, the invention is applicable to latent image carriers in general whose surface area facing the lens array 299 has a curvature in the section along the sub scanning direction.

FIG. 126 is a sectional view along the sub scanning direction showing an image forming apparatus including the line head according to the invention. This embodiment largely differs from the embodiment of FIG. 1 in the mode of the photosensitive member. Specifically, in this embodiment, a photosensitive belt 21B is used instead of the photosensitive drum 21. Since the other construction is the same as in the above embodiment, the same construction is identified by the same or equivalent reference numerals and is not described.

In this embodiment, the photosensitive belt 21B is mounted on two rollers 28 extending in the main scanning direction MD. This photosensitive belt 21B is turned in a specified direction of rotation D21 by an unillustrated drive motor. A charger 23, a line head 29, a developer 25 and a photosensitive member cleaner 27 are arranged along the direction of rotation D21 around this photosensitive belt 21B. A charging operation, a latent image forming operation and a toner developing operation are performed by these functional devices.

In this embodiment, the line head 29 is arranged to face a part of the photosensitive belt 21B mounted on the roller 28. The rollers 28 are cylindrical. Accordingly, the mounted part of the photosensitive belt 21B has a curvature shape. The line head 29 is arranged to face the mounted part for the following reason. Specifically, stretching surfaces of the photosensitive belt 21B flips relatively more than the mounted parts thereof on the rollers 28. Thus, by arranging the line head 29 to face the mounted part on the roller 28, which flips relatively less, out of the surface of the photosensitive belt 21B, the distance between the line head 29 and the photosensitive belt 21B can be stabilized.

However, the surface shape of the photosensitive belt 21B in the mounted part on the roller 28 has a curvature in the section along the sub scanning direction. Accordingly, there is a possibility of an occurrence of such an exposure failure as described above. Thus, in an image forming apparatus constructed as in FIG. 126, a satisfactory exposure can be advantageously realized by applying the invention to set the focus positions of the light beams to those in conformity with the curvature shape of the surface of the photosensitive belt 21B.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A line head, comprising:
a plurality of light emitting elements that are grouped into light emitting element groups, and
an array that includes a plurality of imaging optical systems provided with respect to each light emitting element group which focus light beams emitted from the light emitting element groups toward a latent image-forming surface being conveyed in a second direction normal to or substantially normal to a first direction, wherein
the plurality of imaging optical systems face positions on the latent image-forming surface mutually different in the second direction, and
the respective imaging optical systems are constructed in accordance with differences in facing positions on the latent image-forming surface in the second direction.

2. The line head according to claim 1, wherein
the respective imaging optical systems focus the light beams emitted from the plurality of light emitting element groups to form a plurality of spots on the latent image-forming surface, the plurality of spots constituting a spot group with respect to each imaging optical system,
the imaging optical systems successively focus the light beams from the one facing a position on the latent image-forming surface upstream in a conveying direction of the latent image-forming surface in conformity with the conveyance of the latent image-forming surface,
a spot diameter of the spots formed by the imaging optical system facing a position on the latent image-forming surface upstream in the conveying direction is equal to or smaller than that of the spots formed by the imaging optical system facing a position on the latent image-forming surface downstream in the conveying direction, and
the spot diameter of the spots formed by the imaging optical system facing a position on the latent image-forming surface most-upstream in the conveying direction is smaller than that of the spots formed by the imaging optical system facing a position on the latent image-forming surface most-downstream in the conveying direction.

3. The line head according to claim 2, wherein
a magnification of the imaging optical system facing a position on the latent image-forming surface upstream in the conveying direction is equal to or smaller than that of the imaging optical system facing a position on the latent image-forming surface downstream in the conveying direction, and
the magnification of the imaging optical system facing a position on the latent image-forming surface most-upstream in the conveying direction is smaller than that of the imaging optical system facing a position on the latent image-forming surface most-downstream in the conveying direction.

4. The line head according to claim 1, wherein
an area of the latent image-forming surface facing the array has a curvature in a section along the second direction,
each imaging optical system includes at least one lens, and
a lens configuration and/or a lens position relative to the light emitting element group of the lens of each imaging optical system are constructed such that a focus position of the imaging optical system conforms to a curvature shape of the latent image-forming surface.

5. The line head according to claim 4, wherein lens diameters of lens surfaces of the respective lenses facing toward the latent image-forming surface are equal to each other.

6. The line head according to claim 4, wherein
an arrangement of the light emitting elements in each light emitting element group is determined in accordance with a ratio of the lens corresponding to the light emitting element group such that the spot pitch becomes constant independently of the spot groups, the ratio being a ratio of a spot pitch in the spot group to a light emitting element pitch in the light emitting element group corresponding to the spot group.

7. The line head according to claim 1, wherein an aperture diaphragm is disposed between each imaging optical system and the light emitting element group corresponding to the imaging optical system to construct an image side of the imaging optical system telecentric.

8. An image forming apparatus, comprising:
a latent image carrier whose surface is conveyed in a second direction normal to or substantially normal to a first direction;
a line head that exposes the latent image carrier surface to form a latent image; and
a developer that develops the latent image,
wherein the line head includes:
a plurality of light emitting elements grouped into light emitting element groups; and
an array that includes a plurality of imaging optical systems provided with respect to each light emitting element group which focus light beams emitted from the light emitting element groups toward the latent image carrier surface,
wherein the plurality of imaging optical systems face positions on the latent image carrier surface mutually different in the second direction,
and wherein the respective imaging optical systems are constructed in accordance with differences in the facing positions on the latent image carrier surface in the second direction.

9. The image forming apparatus according to claim 8, wherein
the respective imaging optical systems focus the light beams emitted from the plurality of light emitting element groups to form a plurality of spots on the latent image carrier surface, the plurality of spots constituting a spot group with respect to each imaging optical system,
the imaging optical systems successively focus the light beams from the one facing a position on the latent image carrier surface upstream in a conveying direction of the latent image carrier surface in conformity with the conveyance of the latent image carrier surface,
a spot diameter of the spots formed by the imaging optical system facing a position on the latent image carrier surface upstream in the conveying direction is equal to or smaller than that of the spots formed by the imaging optical system facing a position on the latent image carrier surface downstream in the conveying direction, and
the spot diameter of the spots formed by the imaging optical system facing a position on the latent image carrier surface most-upstream in the conveying direction is smaller than that of the spots formed by the imaging optical system facing a position on the latent image carrier surface most-downstream in the conveying direction.
